(19) United States
(12) Patent Application Publication
(10) Pub. No.: US 2016/0083516 A1
(43) Pub. Date: Mar. 24, 2016

(54) CROSSLINKED POLY-DEPSIPEPTIDE COPOLYMERS AND METHODS OF MAKING THEREOF

(71) Applicants: The Board of Trustees of the Leland Stanford Junior University, Stanford, CA (US); Aalto University, Aalto (FI)

(72) Inventors: Laura Elomaa, Helsinki (FI); Yunzhi Yang, Redwood City, CA (US); Jukka Seppala, Espoo (FI)

(21) Appl. No.: 14/845,096

(22) Filed: Sep. 3, 2015

Related U.S. Application Data
(60) Provisional application No. 62/171,042, filed on Jun. 4, 2015.
(60) Provisional application No. 62/052,951, filed on Sep. 19, 2014.

(51) Int. Cl. C08G 69/48

(52) U.S. Cl. CPC C08G 69/48

(57) ABSTRACT

Aspects of the present disclosure include methods for preparing crosslinked polydepsipeptide copolymers by stereolithography (e.g., 3-D printing). In practicing methods according to certain embodiments, a crosslinkable copolymer containing a depsipeptide having one or more hydrolysable crosslinkers is photocrosslinked by stereolithography to produce a crosslinked polydepsipeptide copolymer. In certain embodiments, methods include contacting the crosslinkable poly(depsipeptide-co-ε-caprolactone) copolymer precursor with one or more bioactive agents and photocrosslinking by 3-D printing to produce a crosslinked poly(depsipeptide-co-ε-caprolactone) copolymer with incorporated bioactive agent. Crosslinkable polydepsipeptide copolymer precursors and crosslinked polydepsipeptide copolymers are also described.

### CROSS-REFERENCE TO RELATED APPLICATIONS

Pursuant to 35 U.S.C. §119 (e), this application claims priority to the filing date of U.S. Provisional Patent Application Ser. No. 62/171,042, filed Jun. 4, 2015, and U.S. Provisional Patent Application Ser. No. 62/052,951, filed Sep. 19, 2014; the disclosures of which are herein incorporated by reference.

### GOVERNMENT SUPPORT

This invention was made with Government support under contract W81XWH-10-1-0966 awarded by the Department of Defense and under contracts AR057837 and DE021468 awarded by the National Institutes of Health. The Government has certain rights in the invention.

### INTRODUCTION

Biocompatible polymers are used in many biomedical and pharmaceutical applications, in part because they are non-toxic and readily metabolized, as well as because of their porosity and pliable nature, which can mimic natural tissue and can facilitate the release of bioactive substances at a desired physiological site. Polymers that are biocompatible have also been used as tissue implants, tissue adhesives and orthopedic treatments such as bone grafts, meniscus and articular cartilage replacement as well as intervertebral disc nucleoplasty. Aliphatic polyesters are sometimes used because of their biocompatibility and sensitivity to hydrolytic degradation.

### SUMMARY

Aspects of the present disclosure include methods for preparing crosslinked polydepsipeptide copolymers by stereolithography (e.g., 3-D printing). In practicing methods according to certain embodiments, a crosslinkable copolymer containing a depsipeptide having one or more hydrolysable crosslinkers is photocrosslinked by stereolithography to produce a crosslinked polydepsipeptide copolymer. In some embodiments, the subject methods include preparing a crosslinked poly(depsipeptide-co-ε-caprolactone) copolymer by 3-D printing. In these embodiments, a crosslinkable poly(depsipeptide-co-ε-caprolactone) copolymer precursor having one or more hydrolysable crosslinkers is photocrosslinked by 3-D printing to produce a crosslinked poly(depsipeptide-co-ε-caprolactone) copolymer. In other embodiments, the subject methods include preparing a crosslinked poly(ethylene glycol-co-depsipeptide) copolymer by 3-D printing. In these embodiments, a crosslinkable poly(ethylene glycol-co-depsipeptide) copolymer precursor having one or more hydrolysable crosslinkers is photocrosslinked by 3-D printing to produce a crosslinked poly(ethylene glycol-co-depsipeptide) copolymer. In certain embodiments, methods include contacting the crosslinkable polydepsipeptide copolymer precursor with one or more bioactive agents and photocrosslinking by 3-D printing to produce a crosslinked polydepsipeptide copolymer with incorporated bioactive agent. Crosslinkable polydepsipeptide copolymer precursors and crosslinked polydepsipeptide copolymers are also described.

In embodiments, methods include contacting a morpholine-2,5-dione monomer with a second monomer under ring-opening polymerization conditions to produce a polydepsipeptide copolymer followed by contacting the polydepsipeptide copolymer with one or more crosslinkers to produce a crosslinkable polydepsipeptide copolymer precursor and photocrosslinking the crosslinkable polydepsipeptide copolymer precursor by 3-D printing to produce a crosslinked polydepsipeptide copolymer. In some embodiments, the second monomer is ε-caprolactone and methods include preparing a crosslinked poly(depsipeptide-co-ε-caprolactone) copolymer. In other embodiments, the second monomer is a polyethylene glycol monomer and methods include preparing a crosslinked poly(ethylene glycol-co-depsipeptide) copolymer. For example, the polyethylene glycol monomer may be a three-arm or four-arm polyethylene glycol macromer, such as a compound of formula:

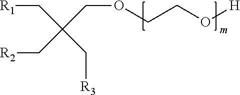

where R₁, R₂ and R₃ are each independently selected from hydrogen, alkyl, substituted alkyl, heteroalkyl and substituted heteroalkyl; and m is a positive integer from 1 to 1000.

In some instances, the morpholine-2,5-dione monomer is a compound of formula:

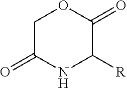

where R is selected from hydrogen, alkyl, substituted alkyl, aryl, substituted aryl, arylalkyl, substituted arylalkyl, heteroalkyl, substituted heteroalkyl, heteroaryl, substituted heteroaryl, heteroarylalkyl, and substituted heteroarylalkyl. For example, R may be a side chain of an amino acid residue selected from alanine, arginine, asparagine, aspartic acid, cysteine, glycine, glutamine, glutamic acid, histidine, isoleucine, leucine, lysine, methionine, phenylalanine, proline, serine, threonine, tryptophan, tyrosine and valine. In certain embodiments, R is methyl.

In some embodiments, methods include contacting a morpholine-2,5-dione monomer with a second monomer (e.g., an ε-caprolactone or a polyethylene glycol monomer) under ring-opening polymerization in the presence of a polymerization initiator, such as a multifunctional polyol or multifunctional polymer, such as a multi-arm polyethylene glycol. Multifunctional polyols may be a polyhydric alcohols such as glycerol, propylene glycol, neopentyl glycol, diethylene glycol, pentaerythritol, dipentaerythritol, sorbitol, ethylene glycol, trimethylolpropane, trimethylol ethane, 1,4-butanediol, di-trimethylol propane, 1,6-hexane diol and combinations thereof.

In some embodiments, the polydepsipeptide copolymer produced is a poly(depsipeptide-co-ε-caprolactone) copolymer of the formula:

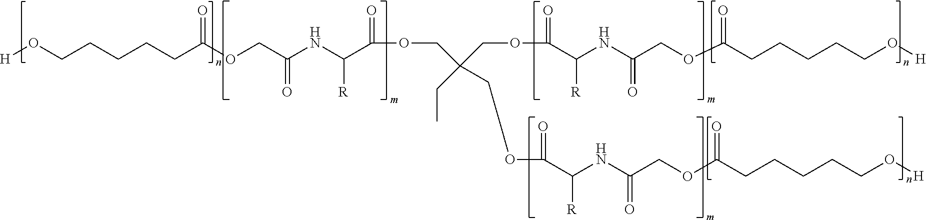

where each R is independently selected from hydrogen, alkyl, substituted alkyl, aryl, substituted aryl, arylalkyl, substituted arylalkyl, heteroalkyl, substituted heteroalkyl, heteroaryl, substituted heteroaryl, heteroarylalkyl, and substituted heteroarylalkyl; m is an integer from 1 to 1000 and n is an integer from 1 to 1000. For example, R may be a side chain of an amino acid residue selected from alanine, arginine, asparagine, aspartic acid, cysteine, glycine, glutamine, glutamic acid, histidine, isoleucine, leucine, lysine, methionine, phenylalanine, proline, serine, threonine, tryptophan, tyrosine and valine. In certain embodiments, R is methyl.

In other embodiments, the polydepsipeptide copolymer produced is a poly(ethylene glycol-co-depsipeptide) copolymer of the formula:

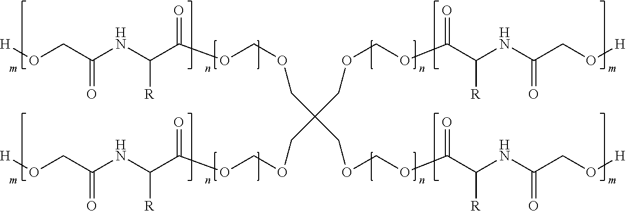

where each R is independently selected from hydrogen, alkyl, substituted alkyl, aryl, substituted aryl, arylalkyl, substituted arylalkyl, heteroalkyl, substituted heteroalkyl, heteroaryl, substituted heteroaryl, heteroarylalkyl, and substituted heteroarylalkyl; m is an integer from 1 to 1000; and n is an integer from 1 to 1000. For example, R may be a side chain of an amino acid residue selected from alanine, arginine, asparagine, aspartic acid, cysteine, glycine, glutamine, glutamic acid, histidine, isoleucine, leucine, lysine, methionine, phenylalanine, proline, serine, threonine, tryptophan, tyrosine and valine. In certain embodiments, R is methyl.

Crosslinkers according to embodiments are hydrolysable crosslinkers, such as hydrolysable acrylate crosslinkers. In some instances, the crosslinker is an acrylate, methacrylate, ethyl acrylate, butyl acrylate, butyl methacrylate, ethylene glycol diacrylate, ethylene glycol dimethacrylate, poly(ethylene glycol) diacrylate and poly(ethylene glycol) dimethacrylate. In certain instances, the crosslinker is a methacrylate crosslinker.

In one example, the crosslinkable poly(depsipeptide-co-ε-caprolactone) copolymer precursor may be a compound of the formula:

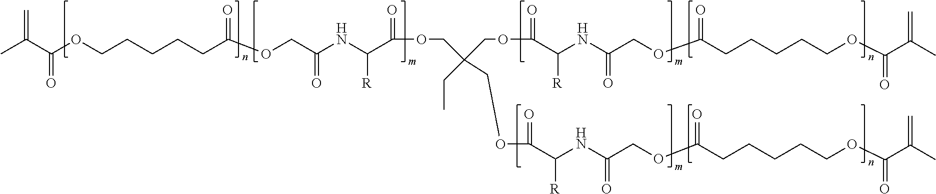

where R is selected from hydrogen, alkyl, substituted alkyl, aryl, substituted aryl, arylalkyl, substituted arylalkyl, heteroalkyl, substituted heteroalkyl, heteroaryl, substituted heteroaryl, heteroarylalkyl, and substituted heteroarylalkyl; m is an integer from 1 to 1000; and n is an integer from 1 to 1000. For example, each R is independently a side chain of an amino acid residue selected from alanine, arginine, asparagine, aspartic acid, cysteine, glycine, glutamine, glutamic acid, histidine, isoleucine, leucine, lysine, methionine, phenylalanine, proline, serine, threonine, tryptophan, tyrosine and valine. In certain embodiments, R is methyl.

In another example, the crosslinkable poly(ethylene glycol-co-depsipeptide) copolymer precursor may be a compound of the formula:

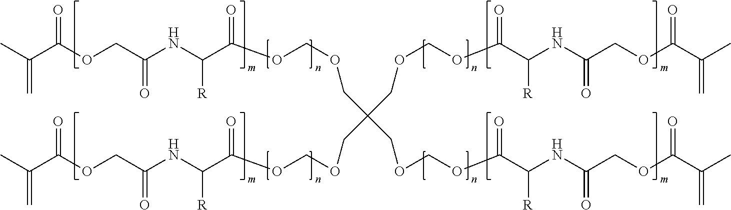

where each R is independently selected from hydrogen, alkyl, substituted alkyl, aryl, substituted aryl, arylalkyl, substituted arylalkyl, heteroalkyl, substituted heteroalkyl, heteroaryl, substituted heteroaryl, heteroarylalkyl, and substituted heteroarylalkyl; m is an integer from 1 to 1000; and n is an integer from 1 to 1000. For example, R may be a side chain of an amino acid residue selected from alanine, arginine, asparagine, aspartic acid, cysteine, glycine, glutamine, glutamic acid, histidine, isoleucine, leucine, lysine, methionine, phenylalanine, proline, serine, threonine, tryptophan, tyrosine and valine. In certain embodiments, R is methyl.

In embodiments of the present disclosure, the subject crosslinkable polydepsipeptide copolymer precursors are photocrosslinked by 3-D printing. In some embodiments, the crosslinkable polydepsipeptide precursor is photocrosslinked by 3-D printing with visible light for a duration of 30 seconds or less, such as for 15 seconds or less. In certain embodiments, the crosslinkable polydepsipeptide precursor is photocrosslinked by 3-D printing with visible light in the absence of solvent.

In some embodiments, the molar ratio of depsipeptide to second monomer (e.g., ε-caprolactone, polyethylene glycol monomer) in the crosslinkable polydepsipeptide copolymer precursor ranges from 1:1 to 1:100, such as 5:95 and including 10:90. In some instances, methods include photocrosslinking the crosslinkable polydepsipeptide precursor with 3-D printing in a manner sufficient to produce a crosslinked polydepsipeptide copolymer having a compressive modulus which ranges from 1 MPa to 35 MPa, such as from 5 MPa to 25 MPa. In other instances, methods include photocrosslinking the crosslinkable polydepsipeptide precursor with 3-D printing in a manner sufficient to produce a crosslinked polydepsipeptide copolymer having a swelling ratio which ranges between 1 and 35, such as ranging between 5 and 25. In yet other instances, methods include photocrosslinking the crosslinkable polydepsipeptide precursor with 3-D printing in a manner sufficient to produce a crosslinked polydepsipeptide copolymer having a crosslink density which ranges between 1×10⁻¹ to 1×10⁻¹² moles/cm³, such as 1×10⁻⁴ mol/cm³ to 1×10⁻⁵ mol/cm³, for example 9×10⁻⁴ mol/cm³. For example, the crosslinked polydepsipeptide copolymer may have pore sizes ranging from 0.1 micron to 1000 microns, such as from 0.1 microns to 5 microns.

In certain embodiments, crosslinked polydepsipeptide (e.g., poly(depsipeptide-co-ε-caprolactone, poly(ethylene glycol-co-depsipeptide)) copolymers of interest include one or more bioactive agents. In these embodiments, methods may include contacting the crosslinkable polydepsipeptide precursor with a bioactive agent to produce a crosslinkable polydepsipeptide-bioactive agent precursor composition and crosslinking the crosslinkable polydepsipeptide-bioactive agent precursor by 3-D printing to produce a crosslinked polydepsipeptide-bioactive agent copolymer. In other instances, methods include contacting the crosslinked polydepsipeptide copolymer with a bioactive agent to incorporate the bioactive agent into the crosslinked polydepsipeptide copolymer structure. Bioactive agents, according to certain embodiments, include one or more of an epidermal growth factor (EGF), hepatocyte growth factor (HGF), vascular endothelial growth factors (VEGF), fibroblast growth factors, platelet derived growth factors (PDGF), insulin-like growth factor, transforming growth factors (TGF), parathyroid hormone, parathyroid hormone related peptide, bone morphogenetic proteins, transcription factors, growth differentiation factor, recombinant human growth factors, cell attachment mediators, integrin binding sequences and cartilage-derived morphogenetic proteins.

In certain embodiments, bioactive agents include cell-containing bioactive agents, such as human or non-human endothelial cells, nerve cells, mesenchymal stem cells, pluripotent stem cells, embryonic stem cells, induced pluripotent stem cells, and other tissue cells such as bone, muscle, tendon, heart, liver, kidney, among other human and non-human tissues. In some embodiments, the bioactive agent includes human umbilical vein endothelial cells (HUVEC). In other embodiments, bioactive agents include cell-containing bioactive agents such as mesenchymal stem cells (MSC), such as human bone marrow mesenchymal stem cells (hMSC).

Aspects of the present disclose also include methods for using the subject crosslinked polydepsipeptide (e.g., poly(depsipeptide-co-ε-caprolactone), poly(ethylene glycol-co-depsipeptide) copolymers. In some embodiments, aspects include methods for delivering one or more bioactive agents to a subject by administering one or more of the crosslinked polydepsipeptide copolymers described herein to a target site. Accordingly, the subject crosslinked polydepsipeptide copolymers are substantially cytocompatible and degrade into non-toxic byproducts under physiological conditions.

### BRIEF DESCRIPTION OF THE FIGURES

FIG. 1A-1G show an example of ¹H NMR spectra for various steps in preparing crosslinked poly(depsipeptide-co-ε-caprolactone) copolymers according to certain embodiments. FIG. 1A depicts ¹H NMR spectra for N-chloroacetyl-L-alanine in D₂O.

FIG. 1B depicts ¹H NMR spectra for 3-methyl-morpholine-2,5-dione in D₂O. FIG. 1C depicts ¹H NMR spectra for PDP5 oligomer in CDCl₃. FIG. 1D depicts ¹H NMR spectra for methacrylated PDP5 macromer in CDCl₃. FIG. 1E depicts a comparison of ¹H NMR spectra for poly(ε-caprolactone) oligomer and macromer. FIG. 1F depicts a comparison of ¹H NMR spectra for poly(depsipeptide-co-ε-caprolactone) copolymers having 5/95 mol % depsipepitide:ε-caprolactone oligomer and macromer. FIG. 1G depicts a comparison of ¹H NMR spectra for poly(depsipeptide-co-ε-caprolactone) copolymers having 10/90 mol % depsipepitide:ε-caprolactone oligomer and macromer.

FIG. 2A-2D show example FTIR spectra transmittance curves attributed to peptide bonds of macromers according to certain embodiments.

FIG. 3 shows example glass transition temperatures of oligomers and the methacrylated macromers according to certain embodiments.

FIG. 4 shows example FTIR transmittance curves attributed to methacrylate double bonds before photocrosslinking a crosslinkable poly(depsipeptide-co-ε-caprolactone) copolymer precursor and after photocrosslinking to produce a crosslinked poly(depsipeptide-co-ε-caprolactone) copolymer according to certain embodiments.

FIG. 5 shows an example of mass loss over time by crosslinked poly(depsipeptide-co-ε-caprolactone) copolymers in phosphate buffer according to certain embodiments.

FIG. 6 shows example of metabolic activity of HUVECs cultured on the crosslinked poly(depsipeptide-co-ε-caprolactone) copolymers and a tissue culture polystyrene (TCPS) control according to certain embodiments.

FIGS. 7A-7B depict data with respect to tests of cytotoxicity of crosslinked poly(depsipeptide-co-ε-caprolactone) copolymers using mouse pluripotent C3H10T1/2 cells according to certain embodiments. FIG. 7A depicts cellular dsDNA content and FIG. 7B depicts ALP activity of C3H10T1/2 cells cultured on crosslinked poly(depsipeptide-co-ε-caprolactone) copolymers and a TCPS control.

FIG. 8A-8B are photographs of example crosslinked poly(depsipeptide-co-ε-caprolactone) copolymers prepared by 3-D printing according to certain embodiments. FIG. 8A shows a photograph of crosslinked poly(depsipeptide-co-ε-caprolactone) copolymers having 5/95 mol % depsipepitide:ε-caprolactone and 10/90 mol % depsipepitide:ε-caprolactone. An ε-caprolactone polymer prepared by 3-D printing is shown for comparison. FIG. 8B depicts an image of the top surface of a crosslinked poly(depsipeptide-co-ε-caprolactone) copolymer having 10/90 mol % depsipepitide:ε-caprolactone composition.

FIG. 9A-9E depict the characterization of mechanical properties of crosslinked poly(depsipeptide-co-ε-caprolactone) copolymers prepared by 3-D printing according to certain embodiments. FIG. 9A depicts the maximum load at the yield point. FIG. 9B shows a comparison of strain at yield point. FIG. 9C compares stiffness of different of crosslinked poly(depsipeptide-co-ε-caprolactone) copolymers and FIG. 9D compares compression modulus of crosslinked poly(depsipeptide-co-ε-caprolactone) copolymers. FIG. 9E shows the compressive strain and compressive stress of oligomers of caprolactone, poly(depsipeptide-co-ε-caprolactone) copolymer having 5/95 mol % depsipepitide:ε-caprolactone and poly(depsipeptide-co-ε-caprolactone) copolymer having 10/90 mol % depsipepitide:ε-caprolactone according to certain embodiments.

FIG. 10A-10B depict HUVECs on a crosslinked poly(depsipeptide-co-ε-caprolactone) copolymer having 10/90 mol % depsipepitide:ε-caprolactone composition scaffold after 7 days of cell culturing according to certain embodiments. Rhodamine phalloidin/DAPI staining shows F-actin (red) and cell nuclei (blue) of the cells.

FIG. 11 depicts gel permeation chromatographs of oligomers of caprolactone, poly(depsipeptide-co-ε-caprolactone) copolymer having 5/95 mol % depsipepitide:ε-caprolactone and poly(depsipeptide-co-ε-caprolactone) copolymer having 10/90 mol % depsipepitide:ε-caprolactone according to certain embodiments.

FIG. 12 depicts differential scanning calorimetry scans of oligomers and macromers of caprolactone, poly(depsipeptide-co-ε-caprolactone) copolymer having 5/95 mol % depsipepitide:ε-caprolactone and poly(depsipeptide-co-ε-caprolactone) copolymer having 10/90 mol % depsipepitide:ε-caprolactone according to certain embodiments.

FIG. 13A-13B depict preparing cell-laden crosslinked poly(ethylene glyocol-co-depsipeptide) copolymers according to certain embodiments. FIG. 13A depicts crosslinkable poly(ethylene glyocol-co-depsipeptide) copolymer precursors before crosslinking. FIG. 13B depicts the crosslinked poly(ethylene glyocol-co-depsipeptide) copolymer compounds after 3-D printing.

FIG. 14A-14C show an example of ¹H NMR spectra for various steps in preparing crosslinked poly(ethylene glyocol-co-depsipeptide) copolymers according to certain embodiments. FIG. 14A shows ¹H NMR spectra of the MMD monomer and PEG macroinitiator. FIG. 14B shows ¹H NMR spectra of poly(ethylene glyocol-co-depsipeptide) copolymers. FIG. 14C shows ¹H NMR spectra of crosslinkable poly(ethylene glyocol-co-depsipeptide) copolymer precursors before crosslinking.

FIG. 15 shows example FTIR spectra of the PECT macroinitiator and poly(ethylene glyocol-co-depsipeptide) copolymer according to certain embodiments.

FIG. 16 depicts the metabolic activity of HUVECs seeded on the photocrosslinked PEG, PEG-co-PDP, and PEG-co-PDP/RGDS hydrogels according to certain embodiments.

FIG. 17A-17B depicts a measure of in vitro mass loss and swelling degree of crosslinked poly(ethylene glyocol-co-depsipeptide) copolymers according to certain embodiments.

FIG. 18A-18D depict Young's modulus and storage and loss modulus of the crosslinked poly(ethylene glyocol-co-depsipeptide) copolymers according to certain embodiments. FIG. 18A-18B depict Young's modulus and storage and loss modulus immediately after preparation. FIG. 18C-18D depict Young's modulus and storage and loss modulus after 7 days in PBS.

FIG. 19A depicts metabolic activity of the encapsulated cells in the hydrogels within 10 d of cell culturing. FIG. 19B-19C depict fluorescence images of encapsulated HUVECs in crosslinked poly(ethylene glyocol-co-depsipeptide) copolymers fabricated 160 s hydrogels after 1 d and 7 d of cell culturing.

FIG. 20A-20C depict fluorescence images and a photograph of a ring-like crosslinked poly(ethylene glyocol-co-depsipeptide) copolymer construct. FIG. 20D depicts CAD models of bifurcate vascular tubes and crosslinked poly(ethylene glyocol-co-depsipeptide) copolymers visualized by cross-section and top view.

### DEFINITION OF SELECT CHEMICAL TERMINOLOGY

The nomenclature of certain compounds or substituents are used in their conventional sense, such as described in chemistry literature including but not limited to Loudon, Organic Chemistry, Fourth Edition, New York: Oxford University Press, 2002, pp. 360-361, 1084-1085; Smith and March, March's Advanced Organic Chemistry: Reactions, Mechanisms, and Structure, Fifth Edition, Wiley-Interscience, 2001.

As used herein, the term “alkyl” by itself or as part of another substituent refers to a saturated branched or straight-chain monovalent hydrocarbon radical derived by the removal of one hydrogen atom from a single carbon atom of a parent alkane. Typical alkyl groups include, but are not limited to, methyl; ethyl, propyls such as propan-1-yl or propan-2-yl; and butyls such as butan-1-yl, butan-2-yl, 2-methyl-propan-1-yl or 2-methyl-propan-2-yl. In some embodiments, an alkyl group comprises from 1 to 20 carbon atoms. In other embodiments, an alkyl group comprises from 1 to 10 carbon atoms. In still other embodiments, an alkyl group comprises from 1 to 6 carbon atoms, such as from 1 to 4 carbon atoms.

“Alkanyl” by itself or as part of another substituent refers to a saturated branched, straight-chain or cyclic alkyl radical derived by the removal of one hydrogen atom from a single carbon atom of an alkane. Typical alkanyl groups include, but are not limited to, methanyl; ethanyl; propanyls such as propan-1-yl, propan-2-yl (isopropyl), cyclopropan-1-yl, etc.; butanyls such as butan-1-yl, butan-2-yl (sec-butyl), 2-methyl-propan-1-yl (isobutyl), 2-methyl-propan-2-yl (t-butyl), cyclobutan-1-yl, etc.; and the like.

“Alkylene” refers to a branched or unbranched saturated hydrocarbon chain, usually having from 1 to 40 carbon atoms, more usually 1 to 10 carbon atoms and even more usually 1 to 6 carbon atoms. This term is exemplified by groups such as methylene (—CH₂—), ethylene (—CH₂CH₂—), the propylene isomers (e.g., —CH₂CH₂CH₂— and —CH(CH₃)CH₂—) and the like.

“Alkenyl” by itself or as part of another substituent refers to an unsaturated branched, straight-chain or cyclic alkyl radical having at least one carbon-carbon double bond derived by the removal of one hydrogen atom from a single carbon atom of an alkene. The group may be in either the cis or trans conformation about the double bond(s). Typical alkenyl groups include, but are not limited to, ethenyl; propenyls such as prop-1-en-1-yl, prop-1-en-2-yl, prop-2-en-1-yl (allyl), prop-2-en-2-yl, cycloprop-1-en-1-yl; cycloprop-2-en-1-yl; butenyls such as but-1-en-1-yl, but-1-en-2-yl, 2-methyl-prop-1-en-1-yl, but-2-en-1-yl, but-2-en-1-yl, but-2-en-2-yl, buta-1,3-dien-1-yl, buta-1,3-dien-2-yl, cyclobut-1-en-1-yl, cyclobut-1-en-3-yl, cyclobuta-1,3-dien-1-yl, etc.; and the like.

“Alkynyl” by itself or as part of another substituent refers to an unsaturated branched, straight-chain or cyclic alkyl radical having at least one carbon-carbon triple bond derived by the removal of one hydrogen atom from a single carbon atom of an alkyne. Typical alkynyl groups include, but are not limited to, ethynyl; propynyls such as prop-1-yn-1-yl, prop-2-yn-1-yl, etc.; butynyls such as but-1-yn-1-yl, but-1-yn-3-yl, but-3-yn-1-yl, etc.; and the like.

“Acyl” by itself or as part of another substituent refers to a radical —C(O)R³⁰, where R³⁰ is hydrogen, alkyl, cycloalkyl, cycloheteroalkyl, aryl, arylalkyl, heteroalkyl, heteroaryl, heteroarylalkyl as defined herein and substituted versions thereof. Representative examples include, but are not limited to formyl, acetyl, cyclohexylcarbonyl, cyclohexylmethylcarbonyl, benzoyl, benzylcarbonyl, piperonyl, succinyl, and malonyl, and the like.

The term “aminoacyl” refers to the group —C(O)NR²¹R²², wherein R²¹ and R²² independently are selected from the group consisting of hydrogen, alkyl, substituted alkyl, alkenyl, substituted alkenyl, alkynyl, substituted alkynyl, aryl, substituted aryl, cycloalkyl, substituted cycloalkyl, cycloalkenyl, substituted cycloalkenyl, heteroaryl, substituted heteroaryl, heterocyclic, and substituted heterocyclic and where R²¹ and R²² are optionally joined together with the nitrogen bound thereto to form a heterocyclic or substituted heterocyclic group, and wherein alkyl, substituted alkyl, alkenyl, substituted alkenyl, alkynyl, substituted alkynyl, cycloalkyl, substituted cycloalkyl, cycloalkenyl, substituted cycloalkenyl, aryl, substituted aryl, heteroaryl, substituted heteroaryl, heterocyclic, and substituted heterocyclic are as defined herein.

“Alkoxy” by itself or as part of another substituent refers to a radical —OR³¹ where R³¹ represents an alkyl or cycloalkyl group as defined herein. Representative examples include, but are not limited to, methoxy, ethoxy, propoxy, butoxy, cyclohexyloxy and the like.

“Alkoxycarbonyl” by itself or as part of another substituent refers to a radical —C(O)OR³¹ where R³¹ represents an alkyl or cycloalkyl group as defined herein. Representative examples include, but are not limited to, methoxycarbonyl, ethoxycarbonyl, propoxycarbonyl, butoxycarbonyl, cyclohexyloxycarbonyl and the like.

“Aryl” by itself or as part of another substituent refers to a monovalent aromatic hydrocarbon radical derived by the removal of one hydrogen atom from a single carbon atom of an aromatic ring system. Typical aryl groups include, but are not limited to, groups derived from aceanthrylene, acenaphthylene, acephenanthrylene, anthracene, azulene, benzene, chrysene, coronene, fluoranthene, fluorene, hexacene, hexaphene, hexalene, as-indacene, s-indacene, indane, indene, naphthalene, octacene, octaphene, octalene, ovalene, penta-2,4-diene, pentacene, pentalene, pentaphene, perylene, phenalene, phenanthrene, picene, pleiadene, pyrene, pyranthrene, rubicene, triphenylene, trinaphthalene and the like. In certain embodiments, an aryl group comprises from 6 to 20 carbon atoms. In certain embodiments, an aryl group comprises from 6 to 12 carbon atoms. Examples of an aryl group are phenyl and naphthyl.

“Arylalkyl” by itself or as part of another substituent refers to an acyclic alkyl radical in which one of the hydrogen atoms bonded to a carbon atom, typically a terminal or sp³ carbon atom, is replaced with an aryl group. Typical arylalkyl groups include, but are not limited to, benzyl, 2-phenylethan-1-yl, 2-phenylethen-1-yl, naphthylmethyl, 2-naphthylethan-1-yl, 2-naphthylethen-1-yl, naphthobenzyl, 2-naphthophenylethan-1-yl and the like. Where specific alkyl moieties are intended, the nomenclature arylalkanyl, arylalkenyl and/or arylalkynyl is used. In certain embodiments, an arylalkyl group is (C₇-C₃₀) arylalkyl, e.g., the alkanyl, alkenyl or alkynyl moiety of the arylalkyl group is (C₁-C₁₀) and the aryl moiety is (C₆-C₂₀). In certain embodiments, an arylalkyl group is (C₇-C₂₀) arylalkyl, e.g., the alkanyl, alkenyl or alkynyl moiety of the arylalkyl group is (C₁-C₈) and the aryl moiety is (C₆-C₁₂).

“Arylaryl” by itself or as part of another substituent, refers to a monovalent hydrocarbon group derived by the removal of one hydrogen atom from a single carbon atom of a ring system in which two or more identical or non-identical aromatic ring systems are joined directly together by a single bond, where the number of such direct ring junctions is one less than the number of aromatic ring systems involved. Typical arylaryl groups include, but are not limited to, biphenyl, triphenyl, phenyl-napthyl, binaphthyl, biphenyl-napthyl, and the like. When the number of carbon atoms in an arylaryl group are specified, the numbers refer to the carbon atoms comprising each aromatic ring. For example, (C₅-C₁₄) arylaryl is an arylaryl group in which each aromatic ring comprises from 5 to 14 carbons, e.g., biphenyl, triphenyl, binaphthyl, phenylnapthyl, etc. In certain embodiments, each aromatic ring system of an arylaryl group is independently a (C₅-C₁₄) aromatic. In certain embodiments, each aromatic ring system of an arylaryl group is independently a (C₅-C₁₀) aromatic. In certain embodiments, each aromatic ring system is identical, e.g., biphenyl, triphenyl, binaphthyl, trinaphthyl, etc.

“Cycloalkyl” by itself or as part of another substituent refers to a saturated or unsaturated cyclic alkyl radical. Where a specific level of saturation is intended, the nomenclature “cycloalkanyl” or “cycloalkenyl” is used. Typical cycloalkyl groups include, but are not limited to, groups derived from cyclopropane, cyclobutane, cyclopentane, cyclohexane and the like. In certain embodiments, the cycloalkyl group is (C₃-C₁₀) cycloalkyl. In certain embodiments, the cycloalkyl group is (C₃-C₇) cycloalkyl.

“Cycloheteroalkyl” or “heterocyclyl” by itself or as part of another substituent, refers to a saturated or unsaturated cyclic alkyl radical in which one or more carbon atoms (and any associated hydrogen atoms) are independently replaced with the same or different heteroatom. Typical heteroatoms to replace the carbon atom(s) include, but are not limited to, N, P, O, S, Si, etc. Where a specific level of saturation is intended, the nomenclature “cycloheteroalkanyl” or “cycloheteroalkenyl” is used. Typical cycloheteroalkyl groups include, but are not limited to, groups derived from epoxides, azirines, thiiranes, imidazolidine, morpholine, piperazine, piperidine, pyrazolidine, pyrrolidine, quinuclidine and the like.

“Heteroalkyl, Heteroalkanyl, Heteroalkenyl and Heteroalkynyl” by themselves or as part of another substituent refer to alkyl, alkanyl, alkenyl and alkynyl groups, respectively, in which one or more of the carbon atoms (and any associated hydrogen atoms) are independently replaced with the same or different heteroatomic groups. Typical heteroatomic groups which can be included in these groups include, but are not limited to, —O—, —S—, —S—S—, —O—S—, —NR³⁷R³⁸—, .═N—N═, —N═N—, —N═N—NR³⁹R⁴⁰, —PR⁴¹—, —P(O)₂—, —POR⁴²—, —O—P(O)₂—, —S—O—, —S—(O)—, —SO₂—, —SnR⁴³R⁴⁴— and the like, where R³⁷, R³⁸, R³⁹, R⁴⁰, R⁴¹, R⁴², R⁴³ and R⁴⁴ are independently hydrogen, alkyl, substituted alkyl, aryl, substituted aryl, arylalkyl, substituted arylalkyl, cycloalkyl, substituted cycloalkyl, cycloheteroalkyl, substituted cycloheteroalkyl, heteroalkyl, substituted heteroalkyl, heteroaryl, substituted heteroaryl, heteroarylalkyl or substituted heteroarylalkyl.

“Heteroaryl” by itself or as part of another substituent, refers to a monovalent heteroaromatic radical derived by the removal of one hydrogen atom from a single atom of a heteroaromatic ring system. Typical heteroaryl groups include, but are not limited to, groups derived from acridine, arsindole, carbazole, β-carboline, chromane, chromene, cinnoline, furan, imidazole, indazole, indole, indoline, indolizine, isobenzofuran, isochromene, isoindole, isoindoline, isoquinoline, isothiazole, isoxazole, naphthyridine, oxadiazole, oxazole, perimidine, phenanthridine, phenanthroline, phenazine, phthalazine, pteridine, purine, pyran, pyrazine, pyrazole, pyridazine, pyridine, pyrimidine, pyrrole, pyrrolizine, quinazoline, quinoline, quinolizine, quinoxaline, tetrazole, thiadiazole, thiazole, thiophene, triazole, xanthene, benzodioxole and the like. In certain embodiments, the heteroaryl group is from 5-20 membered heteroaryl. In certain embodiments, the heteroaryl group is from 5-10 membered heteroaryl. In certain embodiments, heteroaryl groups are those derived from thiophene, pyrrole, benzothiophene, benzofuran, indole, pyridine, quinoline, imidazole, oxazole and pyrazine.

“Heteroarylalkyl” by itself or as part of another substituent, refers to an acyclic alkyl radical in which one of the hydrogen atoms bonded to a carbon atom, typically a terminal or sp³ carbon atom, is replaced with a heteroaryl group. Where specific alkyl moieties are intended, the nomenclature heteroarylalkanyl, heteroarylalkenyl and/or heterorylalkynyl is used. In certain embodiments, the heteroarylalkyl group is a 6-30 membered heteroarylalkyl, e.g., the alkanyl, alkenyl or alkynyl moiety of the heteroarylalkyl is 1-10 membered and the heteroaryl moiety is a 5-20-membered heteroaryl. In certain embodiments, the heteroarylalkyl group is 6-20 membered heteroarylalkyl, e.g., the alkanyl, alkenyl or alkynyl moiety of the heteroarylalkyl is 1-8 membered and the heteroaryl moiety is a 5-12-membered heteroaryl.

“Aromatic Ring System” by itself or as part of another substituent, refers to an unsaturated cyclic or polycyclic ring system having a conjugated π electron system. Specifically included within the definition of “aromatic ring system” are fused ring systems in which one or more of the rings are aromatic and one or more of the rings are saturated or unsaturated, such as, for example, fluorene, indane, indene, phenalene, etc. Typical aromatic ring systems include, but are not limited to, aceanthrylene, acenaphthylene, acephenanthrylene, anthracene, azulene, benzene, chrysene, coronene, fluoranthene, fluorene, hexacene, hexaphene, hexalene, as-indacene, s-indacene, indane, indene, naphthalene, octacene, octaphene, octalene, ovalene, penta-2,4-diene, pentacene, pentalene, pentaphene, perylene, phenalene, phenanthrene, picene, pleiadene, pyrene, pyranthrene, rubicene, triphenylene, trinaphthalene and the like.

“Heteroaromatic Ring System” by itself or as part of another substituent, refers to an aromatic ring system in which one or more carbon atoms (and any associated hydrogen atoms) are independently replaced with the same or different heteroatom. Typical heteroatoms to replace the carbon atoms include, but are not limited to, N, P, O, S, Si, etc. Specifically included within the definition of “heteroaromatic ring systems” are fused ring systems in which one or more of the rings are aromatic and one or more of the rings are saturated or unsaturated, such as, for example, arsindole, benzodioxan, benzofuran, chromane, chromene, indole, indoline, xanthene, etc. Typical heteroaromatic ring systems include, but are not limited to, arsindole, carbazole, β-carboline, chromane, chromene, cinnoline, furan, imidazole, indazole, indole, indoline, indolizine, isobenzofuran, isochromene, isoindole, isoindoline, isoquinoline, isothiazole, isoxazole, naphthyridine, oxadiazole, oxazole, perimidine, phenanthridine, phenanthroline, phenazine, phthalazine, pteridine, purine, pyran, pyrazine, pyrazole, pyridazine, pyridine, pyrimidine, pyrrole, pyrrolizine, quinazoline, quinoline, quinolizine, quinoxaline, tetrazole, thiadiazole, thiazole, thiophene, triazole, xanthene and the like.

“Substituted” refers to a group in which one or more hydrogen atoms are independently replaced with the same or different substituent(s). Typical substituents include, but are not limited to, alkylenedioxy (such as methylenedioxy), -M, —R⁶⁰, —O⁻, ═O, —OR⁶⁰, —SR⁶⁰, —S⁻, ═S, —NR⁶⁰R⁶¹, ═NR⁶⁰, —CF₃, —CN, —OCN, —SCN, —NO, —NO₂, ═N₂, —N₃, —S(O)₂O⁻, —S(O)₂OH, —S(O)₂R⁶⁰, —OS(O)₂O⁻, —OS(O)₂R⁶⁰, —P(O)(O)₂, —P(O)(OR⁶⁰)(O⁻), —OP(O)(OR⁶⁰)(OR⁶¹), —C(O)R⁶⁰, —C(S)R⁶⁰, —C(O)OR⁶⁰, —C(O)NR⁶⁰R⁶¹, —C(O)O⁻, —C(S)R⁶⁰, —NR⁶²C(O)NR⁶⁰R⁶¹, —NR⁶²C(S)NR⁶⁰R⁶¹, —NR⁶²C(NR⁶³)NR⁶⁰R⁶¹ and —C(NR⁶²)NR⁶⁰R⁶¹ where M is halogen; R⁶⁰, R⁶¹, R⁶² and a R⁶³ are independently hydrogen, alkyl, substituted alkyl, alkoxy, substituted alkoxy, cycloalkyl, substituted cycloalkyl, cycloheteroalkyl, substituted cycloheteroalkyl, aryl, substituted aryl, heteroaryl or substituted heteroaryl, or optionally R⁶⁰ and R⁶¹ together with the nitrogen atom to which they are bonded form a cycloheteroalkyl or substituted cycloheteroalkyl ring; and R⁶⁴ and R⁶⁵ are independently hydrogen, alkyl, substituted alkyl, aryl, cycloalkyl, substituted cycloalkyl, cycloheteroalkyl, substituted cycloheteroalkyl, aryl, substituted aryl, heteroaryl or substituted heteroaryl, or optionally R⁶⁴ and R⁶⁵ together with the nitrogen atom to which they are bonded form a cycloheteroalkyl or substituted cycloheteroalkyl ring. In certain embodiments, substituents include -M, —R⁶⁰, ═O, —OR⁶⁰, —SR⁶⁰, —S⁻, ═S, —NR⁶⁰R⁶¹, ═NR⁶⁰, —CF₃, —CN, —OCN, —SCN, —NO, —NO₂, ═N₂, —N₃, —S(O)₂R⁶⁰, —OS(O)₂O⁻, —OS(O)₂R⁶⁰, —P(O)(O⁻)₂, —P(O)(OR⁶⁰)(O⁻), —OP(O)(OR⁶⁰)(OR⁶¹), —C(O)R⁶⁰, —C(S)R⁶⁰, —C(O)OR⁶⁰, —C(O)NR⁶⁰R⁶¹, —C(O)O⁻, —NR⁶²C(O)NR⁶⁰R⁶¹. In certain embodiments, substituents include -M, —R⁶⁰, ═O, —OR⁶⁰, —SR⁶⁰, —NR⁶⁰R⁶¹, —CF₃, —CN, —NO₂, —S(O)₂R⁶⁰, —P(O)(OR⁶⁰)(O⁻), —OP(O)(OR⁶⁰)(OR⁶¹), —C(O)R⁶⁰, —C(O)OR⁶⁰, —C(O)NR⁶⁰R⁶¹, —C(O)O⁻. In certain embodiments, substituents include -M, —R⁶⁰, ═O, —OR⁶⁰, —SR⁶⁰, —NR⁶⁰R⁶¹, —CF₃, —CN, —NO₂, —S(O)₂R⁶⁰, —OP(O)(OR⁶⁰)(OR⁶¹), —C(O)R⁶⁰, —C(O)OR⁶⁰, —C(O)O⁻, where R⁶⁰, R⁶¹ and R⁶² are as defined above. For example, a substituted group may bear a methylenedioxy substituent or one, two, or three substituents selected from a halogen atom, a (1-4C)alkyl group and a (1-4C)alkoxy group.

The compounds described herein can contain one or more chiral centers and/or double bonds and therefore, can exist as stereoisomers, such as double-bond isomers (i.e., geometric isomers), enantiomers or diastereomers. Accordingly, all possible enantiomers and stereoisomers of the compounds including the stereoisomerically pure form (e.g., geometrically pure, enantiomerically pure or diastereomerically pure) and enantiomeric and stereoisomeric mixtures are included in the description of the compounds herein. Enantiomeric and stereoisomeric mixtures can be resolved into their component enantiomers or stereoisomers using separation techniques or chiral synthesis techniques well known to the skilled artisan. The compounds can also exist in several tautomeric forms including the enol form, the keto form and mixtures thereof. Accordingly, the chemical structures depicted herein encompass all possible tautomeric forms of the illustrated compounds. The compounds described also include isotopically labeled compounds where one or more atoms have an atomic mass different from the atomic mass conventionally found in nature. Examples of isotopes that can be incorporated into the compounds disclosed herein include, but are not limited to, ²H, ³H, ¹¹C, ¹³C, ¹⁴C, ¹⁵N, ¹⁸O, ¹⁷O, etc. Compounds can exist in unsolvated forms as well as solvated forms, including hydrated forms. In general, compounds can be hydrated or solvated. Certain compounds can exist in multiple crystalline or amorphous forms. In general, all physical forms are equivalent for the uses contemplated herein and are intended to be within the scope of the present disclosure.

### DETAILED DESCRIPTION

Aspects of the present disclosure include methods for preparing crosslinked polydepsipeptide copolymers by stereolithography (e.g., 3-D printing). In practicing methods according to certain embodiments, a crosslinkable copolymer containing a depsipeptide having one or more hydrolysable crosslinkers is photocrosslinked by stereolithography to produce a crosslinked polydepsipeptide copolymer. In some embodiments, the subject methods include preparing a crosslinked poly(depsipeptide-co-ε-caprolactone) copolymer by 3-D printing. In these embodiments, a crosslinkable poly(depsipeptide-co-ε-caprolactone) copolymer precursor having one or more hydrolysable crosslinkers is photocrosslinked by 3-D printing to produce a crosslinked poly(depsipeptide-co-ε-caprolactone) copolymer. In other embodiments, the subject methods include preparing a crosslinked poly(ethylene glycol-co-depsipeptide) copolymer by 3-D printing. In these embodiments, a crosslinkable poly(ethylene glycol-co-depsipeptide) copolymer precursor having one or more hydrolysable crosslinkers is photocrosslinked by 3-D printing to produce a crosslinked poly(ethylene glycol-co-depsipeptide) copolymer. In certain embodiments, methods include contacting the crosslinkable polydepsipeptide copolymer precursor with one or more bioactive agents and photocrosslinking by 3-D printing to produce a polydepsipeptide copolymer with incorporated bioactive agent. Crosslinkable polydepsipeptide copolymer precursors and crosslinked polydepsipeptide copolymers are also described.

Before the present invention is described in greater detail, it is to be understood that this invention is not limited to particular embodiments described, as such may, of course, vary. It is also to be understood that the terminology used herein is for the purpose of describing particular embodiments only, and is not intended to be limiting, since the scope of the present invention will be limited only by the appended claims.

Where a range of values is provided, it is understood that each intervening value, to the tenth of the unit of the lower limit unless the context clearly dictates otherwise, between the upper and lower limit of that range and any other stated or intervening value in that stated range, is encompassed within the invention. The upper and lower limits of these smaller ranges may independently be included in the smaller ranges and are also encompassed within the invention, subject to any specifically excluded limit in the stated range. Where the stated range includes one or both of the limits, ranges excluding either or both of those included limits are also included in the invention.

Unless defined otherwise, all technical and scientific terms used herein have the same meaning as commonly understood by one of ordinary skill in the art to which this invention belongs. Although any methods and materials similar or equivalent to those described herein can also be used in the practice or testing of the present invention, representative illustrative methods and materials are now described.

All publications and patents cited in this specification are herein incorporated by reference as if each individual publication or patent were specifically and individually indicated to be incorporated by reference and are incorporated herein by reference to disclose and describe the methods and/or materials in connection with which the publications are cited. The citation of any publication is for its disclosure prior to the filing date and should not be construed as an admission that the present invention is not entitled to antedate such publication by virtue of prior invention. Further, the dates of publication provided may be different from the actual publication dates which may need to be independently confirmed.

It is noted that, as used herein and in the appended claims, the singular forms “a”, “an”, and “the” include plural referents unless the context clearly dictates otherwise. It is further noted that the claims may be drafted to exclude any optional element. As such, this statement is intended to serve as antecedent basis for use of such exclusive terminology as “solely,” “only” and the like in connection with the recitation of claim elements, or use of a “negative” limitation.

As will be apparent to those of skill in the art upon reading this disclosure, each of the individual embodiments described and illustrated herein has discrete components and features which may be readily separated from or combined with the features of any of the other several embodiments without departing from the scope or spirit of the present invention. Any recited method can be carried out in the order of events recited or in any other order which is logically possible.

As reviewed above, the present disclosure provides crosslinked polydepsipeptide copolymer compositions. In further describing embodiments of the invention, methods for preparing the subject crosslinked polydepsipeptide copolymers by 3-D printing are first reviewed in greater detail. Next, crosslinkable polydepsipeptide copolymer precursors such as poly(depsipeptide-co-ε-caprolactone) copolymer precursor compounds and poly(ethylene glycol-co-depsipeptide) are provided. Crosslinked copolymers containing a depsipeptide, including crosslinked poly(depsipeptide-co-ε-caprolactone) copolymers and crosslinked poly(ethylene glycol-co-depsipeptide) copolymers prepared by 3-D printing from the crosslinkable copolymer precursors are described. Methods for using the subject crosslinked copolymers are also described followed by a discussion of kits which include one or more or the subject photocrosslinked copolymer compounds.

### Methods for Preparing Crosslinked Polydepsipeptide Copolymers

As summarized above, aspects of the present disclosure include methods for preparing crosslinked polydepsipeptide copolymers. In certain embodiments, preparing crosslinked polydepsipeptide copolymers include contacting a morpholine-2,5-dione monomer with a second monomer (e.g., ε-caprolactone or a polyethylene glycol) under ring-opening polymerization conditions to produce a polymerized copolymer of the depsipeptide and second monomer, contacting the copolymer with one or more crosslinkers to produce a crosslinkable copolymer precursor and photocrosslinking the copolymer precursor by 3-D printing to produce a crosslinked copolymer. As described in greater detail below, the second monomer is, in some embodiments, ε-caprolactone and methods include preparing a crosslinked poly(depsipeptide-co-ε-caprolactone) copolymer. In other embodiments, the second monomer is a polyethylene glycol monomer and methods include preparing a crosslinked poly(ethylene glycol-co-depsipeptide) copolymer.

The term “3-D printing” is used herein in its conventional sense to refer to the additive manufacturing process of forming a three-dimensional object by sequentially laminating cured resin layers through repetition of a plurality of cycles of selectively applying light to a photocrosslinkable polymer resin to form a crosslinked polymer resin layer. As discussed in greater detail below, depending on the properties of the crosslinked copolymer desired, the repetition of three-dimensional laminated layers may include 2 or more repetitive cycles of applying light to a photocrosslinkable copolymer precursor composition, such as 5 or more cycles, such as 10 or more cycles, such as 25 or more cycles, such as 50 or more cycles, such as 100 or more cycles, such as 250 cycles, such as 500 or more cycles, such as 750 or more cycles and including 1000 or more repetitive cycles of applying light to a photocrosslinkable copolymer precursor composition. In some embodiments, 3-D printing protocols include stereolithography.

In some embodiments, the subject disclosure provides crosslinked copolymer hydrogels. The term “hydrogel” is used in its conventional sense to refer to a material that absorbs a solvent (e.g. water), undergoes swelling without measurable dissolution, and maintains three-dimensional networks capable of reversible deformation. “Swelling” as referred to herein is meant the isotropic expansion of the hydrogel structure as water molecules diffuse throughout the internal volume of the hydrogel. Although the subject crosslinked copolymer hydrogels may include hydrophobic and hydrophilic components, the hydrogel does not dissolve in water. As such, the properties of crosslinked copolymers of interest may be modulated as desired, by varying the amounts of each component, ratios of each component or the density of specific components, as described in greater detail below. The term hydrogel is used herein in its conventional sense and may include both desiccated and hydrated (e.g., solvent swollen) hydrogels.

As discussed above, methods for preparing a crosslinked polydepsipeptide copolymer include contacting a morpholine-2,5-dione monomer with a second monomer (e.g., an ε-caprolactone or polyethylene glycol monomer) under ring-opening polymerization conditions to produce a polydepsipeptide copolymer. In some instances, the morpholine-2,5-dione monomer is a compound of the formula:

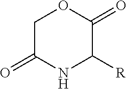

where R is selected from hydrogen, alkyl, substituted alkyl, aryl, substituted aryl, arylalkyl, substituted arylalkyl, heteroalkyl, substituted heteroalkyl, heteroaryl, substituted heteroaryl, heteroarylalkyl, and substituted heteroarylalkyl. For example, R may be a side chain of an amino acid residue selected from alanine, arginine, asparagine, aspartic acid, cysteine, glycine, glutamine, glutamic acid, histidine, isoleucine, leucine, lysine, methionine, phenylalanine, proline, serine, threonine, tryptophan, tyrosine and valine.

In embodiments, one or more different morpholine-2,5-dione monomers may be contacted with the second monomer (e.g., ε-caprolactone, polyethylene glycol monomer) under ring-opening polymerization conditions to produce the desired polydepsipeptide copolymer, such as two or more different morpholine-2,5-dione monomers, such as three or more, such as five or more, such as 10 or more and including 15 or more different morpholine-2,5-dione monomers may be contacted with the second monomer under ring-opening polymerization conditions to produce the polydepsipeptide copolymer. The morpholine-2,5-dione monomers may have a molecular weight which varies depending on the properties of the final crosslinked copolymer desired and may be 0.5 kDa or greater, such as 1 kDa or greater, such as 1.5 kDa or greater, such as 2.5 kDa or greater, such as 5 kDa or greater, such as 7.5 kDa or greater, such as 10 kDa or greater, such as 12.5 kDa or greater, such as 15 kDa or greater, such as 20 kDa or greater and including 25 kDa or greater.

In some embodiments, methods include contacting a morpholine-2,5-dione monomer with the second monomer (e.g., ε-caprolactone or polyethylene glycol monomer) under ring-opening polymerization conditions in the presence of a polymerization initiator, such as a multifunctional polyol or multifunctional polymer, such as a multi-arm polyethylene glycol. Multifunctional polyols of interest include, but are not limited to, polyhydric alcohols such as glycerol, propylene glycol, neopentyl glycol, diethylene glycol, pentaerythritol, dipentaerythritol, sorbitol, ethylene glycol, trimethylolpropane, trimethylol ethane, 1,4-butanediol, di-trimethylol propane, 1,6-hexane diol and combinations thereof.

In some embodiments, the second monomer is ε-caprolactone and the poly(depsipeptide-co-ε-caprolactone) copolymer produced by contacting one or more morpholine-2,5-dione monomers with ε-caprolactone under ring-opening polymerization conditions is a compound of formula:

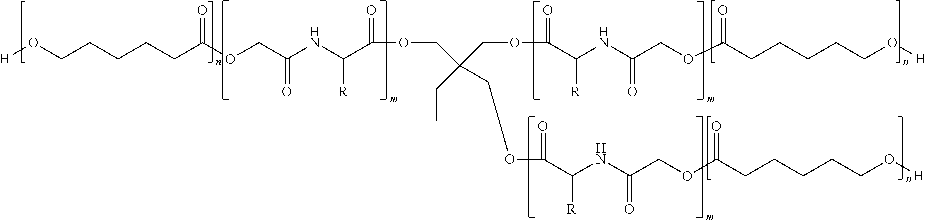

where each R is independently selected from hydrogen, alkyl, substituted alkyl, aryl, substituted aryl, arylalkyl, substituted arylalkyl, heteroalkyl, substituted heteroalkyl, heteroaryl, substituted heteroaryl, heteroarylalkyl, and substituted heteroarylalkyl; m is an integer from 1 to 1000 and n is an integer from 1 to 1000. For example, R may be a side chain of an amino acid residue selected from alanine, arginine, asparagine, aspartic acid, cysteine, glycine, glutamine, glutamic acid, histidine, isoleucine, leucine, lysine, methionine, phenylalanine, proline, serine, threonine, tryptophan, tyrosine and valine. In certain embodiments, R is methyl.

The poly(depsipeptide-co-ε-caprolactone) copolymer may be polymerized by any convenient ring-opening polymerization protocol, such as for example, by radical polymerization, photolysis, redox reaction, ionizing radiation, electrolysis or other suitable protocol. In certain embodiments, the poly(depsipeptide-co-ε-caprolactone) copolymer is prepared by contacting the morpholine-2,5-dione monomer with ε-caprolactone by reaction with tin(II) 2-ethylhexanoate and trimethylolpropane.

In some embodiments, the molar ratio of ε-caprolactone to morpholine-2,5-dione monomer in preparing the poly(depsipeptide-co-ε-caprolactone) copolymer may vary, in some embodiments ranging between 10:1 and 9.5:1; 9.5:1 and 9:1; 9:1 and 8.5:1; 8.5:1 and 8:1; 8:1 and 7.5:1; 7.5:1 and 7:1; 7:1 and 6.5:1; 6.5:1 and 6:1; 6:1 and 5.5:1; 5.5:1 and 5:1; 5:1 and 4.5:1; 4.5:1 and 4:1; 4:1 and 3.5:1; 3.5:1 and 3:1; 3:1 and 2.5:1; 2.5:1 and 2:1; 2:1 and 1.5:1; 1.5:1 and 1:1 or a range thereof. For example, the molar ratio of ε-caprolactone to the morpholine-2,5-dione monomer may range from 10:1 and 1:1, such as 8:1 and 1:1, such as 5:1 and 1:1, such as 4:1 and 1:1, and including from 2:1 and 1:1. In certain instances, the molar ratio of ε-caprolactone to the morpholine-2,5-dione monomer is 19:1. In other instances, the molar ratio of ε-caprolactone to the morpholine-2,5-dione monomer is 9:1.

In other embodiments, the molar ratio of morpholine-2,5-dione monomer to ε-caprolactone in preparing the poly(depsipeptide-co-ε-caprolactone) copolymer may vary, in some embodiments ranging between 10:1 and 9.5:1; 9.5:1 and 9:1; 9:1 and 8.5:1; 8.5:1 and 8:1; 8:1 and 7.5:1; 7.5:1 and 7:1; 7:1 and 6.5:1; 6.5:1 and 6:1; 6:1 and 5.5:1; 5.5:1 and 5:1; 5:1 and 4.5:1; 4.5:1 and 4:1; 4:1 and 3.5:1; 3.5:1 and 3:1; 3:1 and 2.5:1; 2.5:1 and 2:1; 2:1 and 1.5:1; 1.5:1 and 1:1 or a range thereof. For example, the molar ratio of morpholine-2,5-dione monomer to ε-caprolactone may range from 10:1 and 1:1, such as 8:1 and 1:1, such as 5:1 and 1:1, such as 4:1 and 1:1, and including from 2:1 and 1:1. In certain instances, the molar ratio of morpholine-2,5-dione monomer to ε-caprolactone is 19:1. In other instances, the molar ratio of morpholine-2,5-dione monomer to ε-caprolactone is 9:1.

Depending on the molar ratio of morpholine-2,5-dione monomer and ε-caprolactone, the poly(depsipeptide-co-ε-caprolactone) copolymer provided by the present disclosure may be 1 kDa or greater, such as 2 kDa or greater, such as 3 kDa or greater, such as 5 kDa or greater, such as 10 kDa or greater, such as 15 kDa or greater, such as 20 kDa or greater, such as 25 kDa or greater, such as 30 kDa or greater, such as 40 kDa or greater, such as 50 kDa or greater, such as 60 kDa or greater and including 75 kDa or greater.

In some embodiments, the second monomer is a polyethylene glycol monomer, such as a three or three-arm or four-arm polyethylene glycol macromer. For example, the polyethylene glycol macromer may be a compound of the formula:

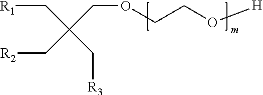

where R₁, R₂ and R₃ are each independently selected from hydrogen, alkyl, substituted alkyl, heteroalkyl and substituted heteroalkyl; and m is a positive integer from 1 to 1000. In certain instances, the poly(ethylene glycol-co-depsipeptide) copolymer produced by contacting one or more morpholine-2,5-dione monomers with the polyethylene glycol monomer under ring-opening polymerization conditions is a compound of formula:

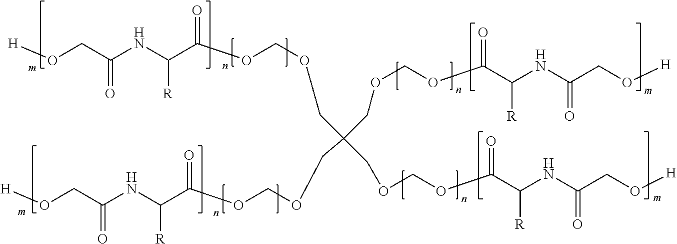

where each R is independently selected from hydrogen, alkyl, substituted alkyl, aryl, substituted aryl, arylalkyl, substituted arylalkyl, heteroalkyl, substituted heteroalkyl, heteroaryl, substituted heteroaryl, heteroarylalkyl, and substituted heteroarylalkyl; m is an integer from 1 to 1000 and n is an integer from 1 to 1000. For example, R may be a side chain of an amino acid residue selected from alanine, arginine, asparagine, aspartic acid, cysteine, glycine, glutamine, glutamic acid, histidine, isoleucine, leucine, lysine, methionine, phenylalanine, proline, serine, threonine, tryptophan, tyrosine and valine. In certain embodiments, R is methyl.

The poly(ethylene glycol-co-depsipeptide) copolymer may be polymerized by any convenient ring-opening polymerization protocol, such as for example, by radical polymerization, photolysis, redox reaction, ionizing radiation, electrolysis or other suitable protocol. In certain embodiments, the poly(ethylene glycol-co-depsipeptide) copolymer is prepared by contacting the morpholine-2,5-dione monomer with the polyethylene glycol monomer by reaction with tin(II) 2-ethylhexanoate and trimethylolpropane.

In some embodiments, the molar ratio of the polyethylene glycol component to morpholine-2,5-dione monomer in preparing the poly(ethylene glycol-co-depsipeptide) copolymers may vary, in some embodiments ranging between 10:1 and 9.5:1; 9.5:1 and 9:1; 9:1 and 8.5:1; 8.5:1 and 8:1; 8:1 and 7.5:1; 7.5:1 and 7:1; 7:1 and 6.5:1; 6.5:1 and 6:1; 6:1 and 5.5:1; 5.5:1 and 5:1; 5:1 and 4.5:1; 4.5:1 and 4:1; 4:1 and 3.5:1; 3.5:1 and 3:1; 3:1 and 2.5:1; 2.5:1 and 2:1; 2:1 and 1.5:1; 1.5:1 and 1:1 or a range thereof. For example, the molar ratio of the polyethylene glycol component to the morpholine-2,5-dione monomer may range from 10:1 and 1:1, such as 8:1 and 1:1, such as 5:1 and 1:1, such as 4:1 and 1:1, and including from 2:1 and 1:1. In certain instances, the molar ratio of the polyethylene glycol component to the morpholine-2,5-dione monomer is 19:1. In other instances, the molar ratio of the polyethylene glycol component to the morpholine-2,5-dione monomer is 9:1. In other embodiments, the molar ratio of morpholine-2,5-dione monomer to the polyethylene glycol component in preparing the poly(ethylene glycol-co-depsipeptide) copolymer may vary, in some embodiments ranging between 10:1 and 9.5:1; 9.5:1 and 9:1; 9:1 and 8.5:1; 8.5:1 and 8:1; 8:1 and 7.5:1; 7.5:1 and 7:1; 7:1 and 6.5:1; 6.5:1 and 6:1; 6:1 and 5.5:1; 5.5:1 and 5:1; 5:1 and 4.5:1; 4.5:1 and 4:1; 4:1 and 3.5:1; 3.5:1 and 3:1; 3:1 and 2.5:1; 2.5:1 and 2:1; 2:1 and 1.5:1; 1.5:1 and 1:1 or a range thereof. For example, the molar ratio of morpholine-2,5-dione monomer to the polyethylene glycol component may range from 10:1 and 1:1, such as 8:1 and 1:1, such as 5:1 and 1:1, such as 4:1 and 1:1, and including from 2:1 and 1:1. In certain instances, the molar ratio of morpholine-2,5-dione monomer to the polyethylene glycol component is 19:1. In other instances, the molar ratio of morpholine-2,5-dione monomer to the polyethylene glycol component is 9:1.

Depending on the molar ratio of morpholine-2,5-dione monomer and the polyethylene glycol component, poly(ethylene glycol-co-depsipeptide) copolymers provided by the present disclosure may be 1 kDa or greater, such as 2 kDa or greater, such as 3 kDa or greater, such as 5 kDa or greater, such as 10 kDa or greater, such as 15 kDa or greater, such as 20 kDa or greater, such as 25 kDa or greater, such as 30 kDa or greater, such as 40 kDa or greater, such as 50 kDa or greater, such as 60 kDa or greater and including 75 kDa or greater.

As summarized above, the polydepsipeptide copolymer is contacted with one or more crosslinkers to produce a crosslinkable copolymer precursor. In some embodiments, the subject crosslinkable copolymer precursors include one or more crosslinkers that are hydrolysable allowing for the production of crosslinks which can be degraded under physiological conditions (e.g., in vivo). In one example, the hydrolyzable crosslinker is an acrylate crosslinker. Acrylate crosslinkers may include, but is not limited to acrylate, methacrylate, ethyl acrylate, butyl acrylate, butyl methacrylate, ethylene glycol diacrylate, ethylene glycol dimethacrylate, poly(ethylene glycol) diacrylate and poly(ethylene glycol) dimethacrylate. In some instances, the acrylate crosslinker may be a methacrylate crosslinker.

In certain embodiments, the subject crosslinkable copolymer precursors include a crosslinker of the formula:

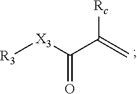

where:

R_{c} is selected from hydrogen, alkyl and substituted alkyl;

X₃ is selected from C, N and O; and

R₃ is the ε-caprolactone, polyethylene glycol or depsipeptide component.

In certain instances, the crosslinker is covalently bonded to a poly(depsipeptide-co-ε-caprolactone) copolymer and has the formula:

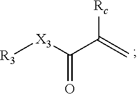

where:

R_{c} is selected from hydrogen, alkyl and substituted alkyl;

X₃ is selected from C, N and O; and

R₃ is the ε-caprolactone component.

In other instances, the crosslinker is covalently bonded to a poly(ethylene glycol-co-depsipeptide) copolymer and has the formula:

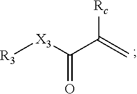

where:

R_{c} is selected from hydrogen, alkyl and substituted alkyl;

X₃ is selected from C, N and O; and

R₃ is the polyethylene glycol or depsipeptide component.

In one example, the crosslinker covalently bonded to the poly(depsipeptide-co-ε-caprolactone) copolymer has the formula:

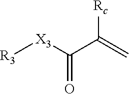

where:

R_{c} is methyl;

X₃ is O; and

R₃ is the ε-caprolactone component.

In another example, the crosslinker covalently bonded to the poly(polyethylene glycol-co-depsipeptide) copolymer has the formula:

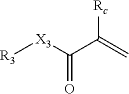

where:

R_{c} is methyl;

X₃ is O; and

R₃ is the depsipeptide component.

In some embodiments, the crosslinkable copolymer precursor is a crosslinkable poly(depsipeptide-co-ε-caprolactone) copolymer precursor of formula:

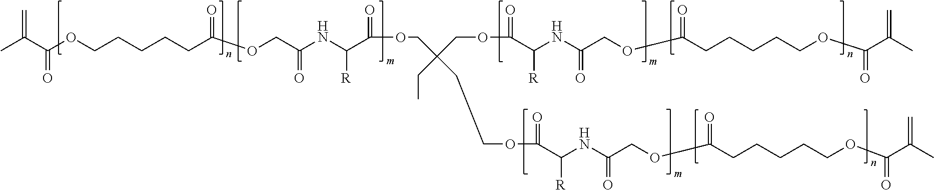

where R is selected from hydrogen, alkyl, substituted alkyl, aryl, substituted aryl, arylalkyl, substituted arylalkyl, heteroalkyl, substituted heteroalkyl, heteroaryl, substituted heteroaryl, heteroarylalkyl, and substituted heteroarylalkyl; m is an integer from 1 to 1000; and n is an integer from 1 to 1000. For example, each R is independently a side chain of an amino acid residue selected from alanine, arginine, asparagine, aspartic acid, cysteine, glycine, glutamine, glutamic acid, histidine, isoleucine, leucine, lysine, methionine, phenylalanine, proline, serine, threonine, tryptophan, tyrosine and valine. In certain embodiments, R is methyl.

In other embodiments, the crosslinkable copolymer precursor is a crosslinkable poly(ethylene glycol-co-depsipeptide) copolymer precursor of formula:

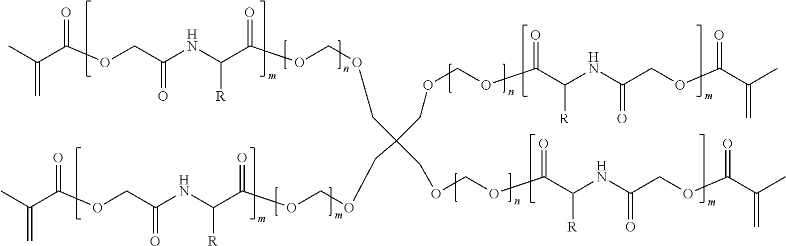

where R is selected from hydrogen, alkyl, substituted alkyl, aryl, substituted aryl, arylalkyl, substituted arylalkyl, heteroalkyl, substituted heteroalkyl, heteroaryl, substituted heteroaryl, heteroarylalkyl, and substituted heteroarylalkyl; m is an integer from 1 to 1000; and n is an integer from 1 to 1000. For example, each R is independently a side chain of an amino acid residue selected from alanine, arginine, asparagine, aspartic acid, cysteine, glycine, glutamine, glutamic acid, histidine, isoleucine, leucine, lysine, methionine, phenylalanine, proline, serine, threonine, tryptophan, tyrosine and valine. In certain embodiments, R is methyl.

The crosslinker may have a molecular weight which varies depending on the properties of the final crosslinked copolymer desired and may be 0.1 kDa or greater, such as 0.25 kDa or greater, such as 0.5 kDa or greater, such as 0.75 kDa or greater, such as 1 kDa or greater, such as 1.25 kDa or greater, such as 1.5 kDa or greater, such as 2 kDa or greater, such as 2.5 kDa or greater, such as 3 kDa or greater and including 5 kDa or greater. Likewise, the amount of crosslinker may vary. For instance, crosslinker may be present in an amount ranging from 0.05% to 35% w/w, such as 0.1% to 30% w/w, such as 0.5% to 25% w/w, such as 0.75% to 20% w/w, such as 1% to 15% w/w, such as 1.5% to 12.5% w/w and including 2% to 10% w/w.

After preparing the crosslinkable copolymer precursors (e.g., poly(depsipeptide-co-ε-caprolactone) or poly(ethylene glycol-co-depsipeptide), methods further include a second process of producing the final crosslinked copolymer from the crosslinkable copolymer precursor by 3-D printing.

In certain embodiments, the crosslinkable copolymer precursor is covalently bonded to an adhesion protein before crosslinking to produce the final crosslinked copolymer. In one example, adhesion proteins of interest include, but are not limited to, adhesion peptides configured to provide an integrin-specific attachment site on the crosslinked copolymer. For instance, the adhesion protein may include arginine, glycine, aspartic acid and serine residues, such as an adhesion protein having the formula:

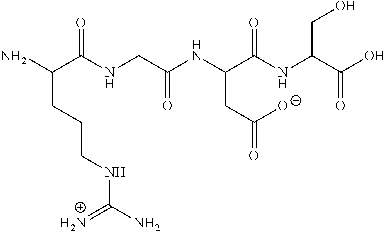 [SMILES: NC(=[NH2+])NCCCC(N)C(=O)NCC(=O)NC(CC(=O)[O-])C(=O)NC(CO)C(=O)O]

In certain embodiments, the adhesion protein is crosslinked to the crosslinkable copolymer precursor, such as through an acrylate crosslinker. For example, the adhesion protein may include a polyethylene glycol substituted acrylate group. In some instances, the adhesion protein has the formula:

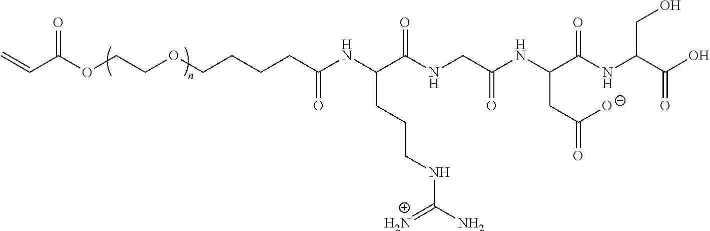

In some embodiments, the crosslinkable copolymer precursor is a crosslinkable poly(ethylene glycol-co-depsipeptide) copolymer covalently bonded to an adhesion protein of the compound:

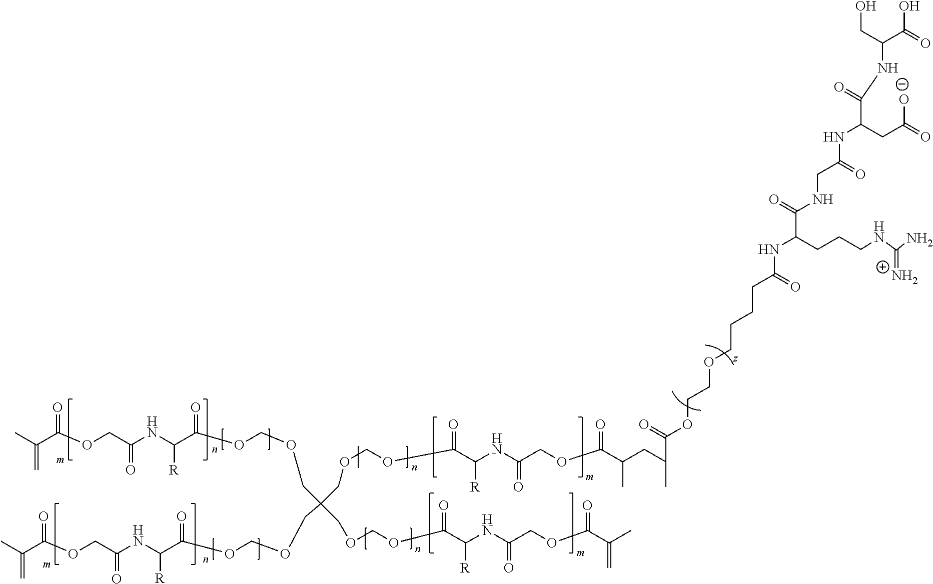

where R is selected from hydrogen, alkyl, substituted alkyl, aryl, substituted aryl, arylalkyl, substituted arylalkyl, heteroalkyl, substituted heteroalkyl, heteroaryl, substituted heteroaryl, heteroarylalkyl, and substituted heteroarylalkyl; m is an integer from 1 to 1000; n is an integer from 1 to 1000 and z is an integer from 1 to 1000. In some instances, z is from 10 to 110, such as 77. For example, each R is independently a side chain of an amino acid residue selected from alanine, arginine, asparagine, aspartic acid, cysteine, glycine, glutamine, glutamic acid, histidine, isoleucine, leucine, lysine, methionine, phenylalanine, proline, serine, threonine, tryptophan, tyrosine and valine. In certain embodiments, R is methyl.

As discussed above, 3-D printing is used herein in its conventional sense to refer to forming a three-dimensional scaffold by sequentially laminating layers of photocrosslinked copolymer through a plurality of repetitive cycles of selectively irradiating the photocrosslinkable copolymer precursors to form a three-dimensional porous crosslinked copolymer scaffold.

Depending on the properties of the three-dimensional porous crosslinked copolymer scaffold desired and type of crosslinkable polydepsipeptide copolymer precursor (e.g., poly(depsipeptide-co-ε-caprolactone), poly(ethylene glycol-co-depsipeptide), etc.), 3-D printing protocols of interest may include 2 or more repetitive cycles of irradiating the photocrosslinkable polymer precursor composition, such as 5 or more cycles, such as 10 or more cycles, such as 25 or more cycles, such as 50 or more cycles, such as 100 or more cycles, such as 250 cycles, such as 500 or more cycles, such as 750 or more cycles and including 1000 or more repetitive cycles of irradiating the photocrosslinkable polymer precursor composition.

The term “photocrosslinked” is used herein in is conventional sense to refer to employing electromagnetic radiation to initiate or catalyze reaction between crosslinkers to form a crosslinked copolymer composition. The radiation may be any suitable electromagnetic radiation, including by not limited to visible light radiation, ultraviolet radiation, α-type radiation, β-type, gamma radiation, electron beam radiation, and x-ray radiation. In some embodiments, radiation having a wavelength of between 200 to 800 nm (e.g., 400 to 600 nm) is used. Any convenient source of electromagnetic radiation may be employed so long as it is sufficient to provide adequate electromagnetic energy to achieve the desired crosslinking. For example, where irradiation is with visible light, visible light may be applied from a xenon arc lamp, solid state laser or other convenient source.

In some embodiments, 3-D printing protocols of interest include photocrosslinking the crosslinkable polydepsipeptide polymer precursor in the presence of a photo-initiator. The photo-initiator may be a compound which produces one or more radical species in response electromagnetic irradiation, such as for example, azobisisobutyronitrile (AIBN), benzoyl peroxide, 2,2-dimethoxy-2-phenylacetophenone (DMPA), 2-methyl-1-(4-methylthio)phenyl-2-morpholinyl-1-propanone, 2-benzyl-2-(dimethylamino)-4′-morpholinobutyrophenone, phenylbis(2,4,6-trimethylbenzoyl)phosphine oxide, 1-hydroxycyclohexyl phenyl ketone and 4-(2-hydroxyethoxy)phenyl-(2-hydroxy-2-propyl)ketone, among other photo-initiators. Suitable photosensitizers also include triplet sensitizers of the “hydrogen abstraction” type, such as for example benzophenone and substituted benzophenone and acetophenones such as benzyl dimethyl ketal, 4-acryloxybenzophenone (ABP), 1-hydroxy-cyclohexyl phenyl ketone, 2,2-diethoxyacetophenone and 2,2-dimethoxy-2-phenylaceto-phenone, substituted alpha-ketols such as 2-methyl-2-hydroxypropiophenone, benzoin ethers such as benzoin methyl ether and benzoin isopropyl ether, substituted benzoin ethers such as anisoin methyl ether, aromatic sulfonyl chlorides such as 2-naphthalene sulfonyl chloride, photoactive oximes such as 1-phenyl-1,2-propanedione-2-(O-ethoxy-carbonyl)-oxime, thioxanthones including alkyl- and halogen-substituted thioxanthonse such as 2-isopropylthioxanthone, 2-chlorothioxanthone, 2,4dimethyl thioxanone, 2,4dichlorothioxanone, and 2,4-diethyl thioxanone, and acyl phosphine oxides. In certain embodiments, the photoinitiator is lithium phenyl-2,4,6-trimethylbenzoylphosphinate.

In some instances, the photoinitiator is coupled to the crosslinkable polydepsipeptide copolymer precursor before irradiation with the electromagnetic radiation (i.e., before irradiating the crosslinkable polydepsipeptide copolymer precursor composition with UV light or visible light). For example, the photoinitiator may be covalently bonded to the crosslinkable polydepsipeptide copolymer precursor by reacting the photoinitiator with the crosslinking group (e.g., acrylate crosslinker). In certain embodiments, the photoinitiator is lithium phenyl-2,4,6-trimethylbenzoylphosphinate and methods include reacting lithium phenyl-2,4,6-trimethylbenzoylphosphinate with the crosslinkable polydepsipeptide copolymer precursor to covalently bond the photoinitiator through the crosslinker. In other words, the photoinitiator is crosslinked into the final crosslinked polydepsipeptide copolymer.

In some embodiments, photocrosslinking the photocrosslinkable polydepsipeptide copolymer precursor composition includes irradiating with visible light. The intensity of the visible light may vary depending on the desired crosslink density and type of photo-initiator employed and may be 10 mW/dm² or greater, such as 15 mW/dm² or greater, such as 25 mW/dm² or greater, such as 50 mW/dm² or greater, such as 100 mW/dm² or greater, such as 250 mW/dm² or greater, such as 500 mW/dm² or greater, such as 1000 mW/dm² or greater, such as 1500 mW/dm² or greater, such as 2000 mW/dm² or greater, such as 2500 mW/dm² or greater, such as 3000 mW/dm² or greater, such as 3500 mW/dm² or greater, such as 4000 mW/dm² or greater, such as 4500 mW/dm² or greater and including 5000 mW/dm² or greater.

Any suitable duration of irradiation may be employed depending on the intensity of radiation as well as the mechanical and physicochemical properties of the final crosslinked polydepsipeptide copolymer desired. For example, in some embodiments 3-D printing protocols of interest include irradiating the crosslinkable polydepsipeptide copolymer precursor with visible light having an intensity ranging between 1500 mW/dm² and 2000 mW/dm² for a duration which ranges from 1 seconds to 1000 seconds, such as 10 seconds to 900 seconds, such as 30 seconds to 800 seconds, such as 45 seconds to 750 seconds, such as 60 seconds to 600 seconds, such as 120 seconds to 450 seconds and including 200 seconds to 300 seconds. In other embodiments, 3-D printing protocols of interest include irradiating the crosslinkable polydepsipeptide copolymer precursor with visible light having an intensity ranging between 1500 mW/dm² and 2000 mW/dm² for a duration of 30 seconds or less, such as 25 seconds or less, such as 20 seconds or less and including irradiating with visible light for 15 seconds or less. In yet other embodiments, 3-D printing protocols of interest include irradiating the crosslinkable polydepsipeptide copolymer precursor with visible light having an intensity ranging between 1500 mW/dm² and 2000 mW/dm² for a duration of 30 seconds or more, such as 45 seconds or more, such as 60 seconds or more, such as 75 seconds or more, such as 100 seconds or more, such as 120 seconds or more, such as 150 seconds or more, such as 180 seconds or more, such as 210 seconds or more, such as 240 seconds or more, such as 270 seconds or more and including irradiating with visible light for 300 seconds or more. In certain embodiments, 3-D printing protocols of interest include irradiating the crosslinkable polydepsipeptide copolymer precursor with visible light having an intensity of 1600 mW/dm² for a duration of 30 seconds or less, such as 25 seconds or less, such as 20 seconds or less and including irradiating with visible light for 15 seconds or less, such as for 12 seconds. In certain instances longer durations of irradiation result in increased crosslinking densities of the subject crosslinked polydepsipeptide copolymers, while shorter durations of irradiation produce lower crosslinking densities. In some embodiments, where larger swelling ratios, higher compressive modulus, lower mechanical strength and shorter degradation durations are desired, crosslinkable polydepsipeptide copolymer precursors may be irradiated for a shorter period of time.

Physicochemical properties (e.g., swelling behavior), mechanical properties (e.g, compressive modulus), degradation rates as well as active agent release kinetics of the subject crosslinked polydepsipeptide (e.g., poly(depsipeptide-co-ε-caprolactone), poly(ethylene glycol-co-depsipeptide) copolymers can be modulated by varying the amount of crosslinks present. For example, the percentage of crosslinks can be varied between about 1% and about 50% by weight, and, such as from about 2% and about 45% by weight, such as from about 3% and 40% by weight, such as from 4% to 35% by weight and including from about 5% to 30% by weight. For instance, by increasing the percentage of crosslinks, the degradation rate of the subject crosslinked polydepsipeptide copolymer can be decreased. Similarly, the compressive modulus of the crosslinked polydepsipeptide copolymer can be increased by increasing the percentage of crosslinks. Still further, the swelling ratio of the subject crosslinked polydepsipeptide copolymer can be increased by decreasing the percentage of crosslinks. Accordingly, depending on the mechanical and physicochemical properties desired the subject crosslinked polydepsipeptide copolymers may have a crosslink density which ranges from 1×10⁻¹⁵ moles/cm³ to 1×10⁻³ moles/cm³, such as 1×10⁻¹⁴ moles/cm³ to 1×10⁻³ moles/cm³, such as 1×10⁻¹³ moles/cm³ to 1×10⁻³ moles/cm³, such as 1×10⁻¹² moles/cm³ to 1×10⁻³ moles/cm³, such as 1×10⁻¹¹ moles/cm³ to 1×10⁻³ moles/cm³, such as 1×10⁻¹⁶ moles/cm³ to 1×10⁻³ moles/cm³, such as 1×10⁻⁹ moles/cm³ to 1×10⁻³ moles/cm³, such as 1×10⁻⁸ moles/cm³ to 1×10⁻³ moles/cm³, such as 1×10⁻¹¹ moles/cm³ to 1×10⁻⁷ moles/cm³, and including 1×10⁻⁶ moles/cm³ to 1×10⁻³ moles/cm³. In certain embodiments, the crosslink density ranges from 1×10⁻⁴ mol/cm³ to 1×10⁻⁵ mol/cm³. For example, the crosslink density in certain instances is 9×10⁻⁴ mol/cm³.

In some embodiments, 3-D printing protocols for crosslinking the subject crosslinkable polydepsipeptide (e.g., poly(depsipeptide-co-ε-caprolactone), poly(ethylene glycol-co-depsipeptide) copolymer precursor compositions to form a three-dimensional scaffold by sequentially laminating layers of photocrosslinked polydepsipeptide copolymer may include, but are not limited to those described in Hutmacher, et al. (Biomaterials, 2000, 21:2549-2543); Yeong, et al. (Trends Biotechnol. 2004, 22:643-652); Leong, et al. (Biomaterials, 2003, 24:2363-2378) and Hutmacher, et al. (Trends Biotechnol. 2004, 22:354-362) as well as in U.S. Pat. Nos. 4,575,330; 5,130,064; 5,597,520; 5,609,812; 5,711,911; 5,762,856; 6,193,923 and 7,785,093, the disclosures of which are herein incorporated by reference.

In some embodiments, 3-D printing protocols of interest include irradiating the crosslinkable polydepsipeptide copolymer precursors with light (e.g., visible light) in a manner sufficient to produce a crosslinked polydepsipeptide (e.g., poly(depsipeptide-co-ε-caprolactone), poly(ethylene glycol-co-depsipeptide) copolymer having a compressive modulus which ranges from 1 MPa to 35 MPa. By “compressive modulus” is meant the capacity of the subject crosslinked copolymer to withstand axially directed pushing forces and is the value of uniaxial compressive stress reached when the material fails completely (e.g., crushed). In these embodiments, the compressive modulus of the subject crosslinked copolymers may range from 1 MPa to 35 MPa, such as from 2 MPa to 33 MPa, such as from 3 MPa to 30 MPa, such as from 4 MPa to 28 MPa, such as form 5 MPa to 25 MPa, such as from 6 MPa to 22 MPa, such as from 7 MPa to 20 MPa and including a compressive modulus ranging from 10 MPa to 20 MPa.

In other embodiments, 3-D printing protocols include irradiating the crosslinkable copolymer precursors with light in a manner sufficient to produce a crosslinked copolymer having a swelling ratio which ranges between 1 and 35. The physicochemical and mechanical properties as well as the active agent release kinetics of the subject crosslinked copolymers may vary depending on three-dimensional copolymer structure. In certain instances, the subject crosslinked copolymers absorb solvent (e.g. water) and undergo swelling under physiological conditions (e.g., in contact with blood or plasma). The term “swelling” as referred to herein is meant the expansion (isotropic or anisotropic) of the three-dimensional crosslinked copolymer structure as solvent (e.g., water) molecules diffuse throughout the internal volume. Depending on the structure of the crosslinked copolymers (e.g., ratio of depsipeptide to ε-caprolactone, ratio of depsipeptide to polyethylene glycol, crosslink density), the swelling ratio may vary. By “swelling ratio” is meant the ratio of crosslinked copolymer weight after absorption of solvent to the dry weight of the crosslinked copolymer, as determined by the formula:

Swelling ratio=(Wₛ−W_{d})/W_{d},

where Wₛ is the weight of the swollen crosslinked copolymer and W_{d} is the dry weight of the crosslinked copolymer. In some embodiments, the swelling ratio of the subject crosslinked copolymer ranges from 3 to 30, such as from 4 to 27, such as from 5 to 25, such as from 6 to 20, such as form 7 to 18, such as from 8 to 17, such as from 9 to 16 and including a swelling ratio ranging from 5 to 15.

In some embodiments, 3-D printing protocols of interest include irradiating the crosslinkable copolymer precursors with light in a manner sufficient to produce a crosslinked copolymer with pores having a size ranging from 0.1 microns to 1000 microns, such as 0.5 microns to 900 microns, such as 1 micron to 800 microns, such as 5 microns to 750 microns, such as 10 microns to 600 microns, such as 25 microns to 500 microns, such as 50 microns to 400 microns and including from 100 microns to 300 microns. For example, methods of the present disclosure may include photocrosslinking the copolymer precursors in a manner sufficient to produce a crosslinked copolymer with pores having a size ranging from 0.1 microns to 500 microns.

In certain embodiments, 3-D printing protocols of interest include photocrosslinking the crosslinkable copolymer precursors in the absence of solvent. The term “absence of solvent” is meant that the subject crosslinkable copolymer precursor composition contain little to no solvent during photocrosslinking by 3-D printing. Accordingly, in these embodiments 3-D printing protocols include photocrosslinking the crosslinkable copolymer precursor compositions having solvent in an amount of 1% w/w solvent or less, such as 0.5% w/w solvent or less, such as 0.25% w/w solvent or less, such as 0.1% w/w solvent or less, such as 0.05% w/w solvent or less, such as 0.01% w/w solvent or less and including 0.001% w/w solvent or less. In certain embodiments, 3-D printing protocols of interest include photocrosslinking a neat crosslinkable copolymer precursor composition.

In some embodiments, aspects of the present disclosure further include one or more bioactive agents incorporated (e.g., adsorbed or absorbed) into the subject crosslinked copolymers and where the crosslinked copolymer is configured to deliver one or more bioactive agent to a site of administration, such as by implanting the subject crosslinked copolymer, coating an implant with the crosslinked copolymer, ingesting the crosslinked copolymer (e.g., bone implant, vascular implant), etc.

Suitable bioactive agents according to certain embodiments may include but are not limited to proteins and protein fragments, integrin binding sequences interferon, interleukin, erythropoietin, granulocyte-colony stimulating factor (GCSF), stem cell factor (SCI:), leptin (OB protein), interferon (alpha, beta, gamma), antibiotics such as vancomycin, gentamicin ciprofloxacin, amoxycillin, lactobacillus, cefotaxime, levofloxacin, cefepime, mebendazole, ampicillin, lactobacillus, cloxacillin, norfloxacin, tinidazole, cefpodoxime, proxctil, azithromycin, gatifloxacin, roxithromycin, cephalosporin, anti-thrombogenics, aspirin, ticlopidine, sulfinpyrazone, heparin, warfarin, growth factors, differentiation factors, hepatocyte stimulating factor, plasmacytoma growth factor, glial derived neurotrophic factor (GDNF), neurotrophic factor 3 (NT3), fibroblast growth factor (FGF), transforming growth factor (TGF), platelet transforming growth factor, milk growth factor, endothelial growth factors, endothelial cell-derived growth factors (ECDGF), alpha-endothelial growth factors, beta-endothelial growth factor, neurotrophic growth factor, nerve growth factor (NGF), vascular endothelial growth factor (VEGF), 4-1 BB receptor (4-IBBR), TRAIL (TNF-related apoptosis inducing ligand), artemin (GFRalpha3-RET ligand), BCA-I (B cell-attracting chemokinel), B lymphocyte chemoattractant (BLC), B cell maturation protein (BCMA), brain-derived neurotrophic factor (BDNF), bone growth factor such as osteoprotegerin (OPG), bone-derived growth factor, thrombopoietin, megakaryocyte derived growth factor (MDGF), keratinocyte growth factor (KGF), platelet-derived growth factor (PDGF), ciliary neurotrophic factor (CNTF), neurotrophin 4 (NT4), granulocyte colony-stimulating factor (GCSF), macrophage colony-stimulating factor (mCSF), bone morphogenetic protein 2 (BMP2), BRAK, C-IO, Cardiotrophin 1 (CT1), CCR8, anti-inflammatory: paracetamol, salsalate, diflunisal, mefenamic acid, diclofenac, piroxicam, ketoprofen, dipyrone, acetylsalicylic acid, anti-cancer drugs such as aliteretinoin, altertamine, anastrozole, azathioprine, bicalutarnide, busulfan, capecitabine, carboplatin, cisplatin, cyclophosphamide, cytarabine, doxorubicin, epirubicin, etoposide, exemestane, vincristine, vinorelbine, hormones, thyroid stimulating hormone (TSH), sex hormone binding globulin (SHBG), prolactin, luteotropic hormone (LTH), lactogenic hormone, parathyroid hormone (PTH), melanin concentrating hormone (MCH), luteinizing hormone (LHb), growth hormone (HGH), follicle stimulating hormone (FSHb), haloperidol, indomethacin, doxorubicin, epirubicin, amphotericin B, Taxol, cyclophosphamide, cisplatin, methotrexate, pyrene, amphotericin B, anti-dyskinesia agents, Alzheimer vaccine, antiparkinson agents, ions, edetic acid, nutrients, glucocorticoids, heparin, anticoagulation agents, antivirus agents, anti-HIV agents, polyamine, histamine and derivatives thereof, cystineamine and derivatives thereof, diphenhydramine and derivatives, orphenadrine and derivatives, muscarinic antagonist, phenoxybenzamine and derivatives thereof, protein A, streptavidin, amino acid, beta-galactosidase, methylene blue, protein kinases, beta-amyloid, lipopolysaccharides, eukaryotic initiation factor-4G, tumor necrosis factor (TNF), tumor necrosis factor-binding protein (TNF-bp), interleukin-1 (to 18) receptor antagonist (IL-Ira), granulocyte macrophage colony stimulating factor (GM-CSF), novel erythropoiesis stimulating protein (NESP), thrombopoietin, tissue plasminogen activator (TPA), urokinase, streptokinase, kallikrein, insulin, steroid, acetaminophen, analgesics, antitumor preparations, anti-cancer preparations, anti-proliferative preparations or pro-apoptotic preparations, among other types of bioactive agents.

In certain embodiments, bioactive agents include cell-containing bioactive agents, such as human or non-human endothelial cells, nerve cells, mesenchymal stem cells, pluripotent stem cells, embryonic stem cells, induced pluripotent stem cells, and other tissue cells such as bone, muscle, tendon, heart, liver, kidney, among other human and non-human tissues. In some embodiments, the bioactive agent includes human umbilical vein endothelial cells (HUVEC). In other embodiments, bioactive agents include cell-containing bioactive agents such as mesenchymal stem cells (MSC), such as human bone marrow mesenchymal stem cells (hMSC).

In some embodiments, bioactive agents include small molecule active agents. For example, suitable small molecule active agents include, but are not limited to, antipyretics, analgesics, antiseptics, anti-depressants, mood stabilizers, hormone replacements, stimulants, tranquilizers, psychedelics, hypnotics, anaesthetics, antipsychotics, antidepressants (including tricyclic antidepressants, monoamine oxidase inhibitors, lithium salts, and selective serotonin reuptake inhibitors (SSRIs)), antiemetics, anticonvulsants/antiepileptics, anxiolytics, barbiturates, movement disorder (e.g., Parkinson's disease) drugs, hemostatics, stimulants (including amphetamines), benzodiazepines, cyclopyrrolones, dopamine antagonists, antihistamines, cholinergics, anticholinergics, emetics, cannabinoids, and 5-HT (serotonin) antagonists, or any combination, pharmaceutically acceptable salt or prodrug thereof.

In certain embodiments, the one or more absorbed bioactive agents is a compound selected from the group consisting of chemotactic agents, cell attachment mediators, integrin binding sequences, epidermal growth factor (EGF), hepatocyte growth factor (HGF), vascular endothelial growth factors (VEGF), fibroblast growth factors, platelet derived growth factors (PDGF), insulin-like growth factor, transforming growth factors (TGF), parathyroid hormone, parathyroid hormone related peptide, bone morphogenetic proteins (BMP), BMP-2, BMP-4, BMP-6, BMP-7, BMP-12, BMP-13, BMP-14, transcription factors, growth differentiation factor (GDF), GDF5, GDF6, GDF8, recombinant human growth factors, cartilage-derived morphogenetic proteins (CDMP), CDMP-1, CDMP-2 and CDMP-3.

One or more bioactive agents may be introduced into the subject crosslinked polydepsipeptide copolymers by any convenient in vitro or in vivo protocol. In some embodiments, the one or more bioactive agents may be added to a crosslinkable copolymer precursor composition and the crosslinkable copolymer precursor may be photocrosslinked by 3-D printing in the presence of the one or more bioactive agents, encapsulating the bioactive agent within the crosslinked copolymer. In other embodiments, the crosslinkable copolymer precursor may be first photocrosslinked by 3-D printing and the crosslinked copolymer is incubated in the presence of the one or more bioactive agents with or without a solvent for a predetermined amount of time, such as for 1 hour or more, 5 hours or more, 10 hours or more, 12 hours or more, 24 hours or more, 3 days or more and including 1 week or more, to allow the crosslinked copolymer to incorporate the one of more bioactive agents into the crosslinked matrix.

In some embodiments, methods include: 1) contacting the crosslinkable polydepsipeptide (e.g., poly(depsipeptide-co-ε-caprolactone), poly(ethylene glycol-co-depsipeptide) precursor with a bioactive agent to produce a crosslinkable polydepsipeptide copolymer precursor-bioactive agent composition and 2) photocrosslinking the crosslinkable polydepsipeptide copolymer precursor-bioactive agent by 3-D printing to produce a crosslinked polydepsipeptide copolymer-bioactive agent compound. In these embodiments, the bioactive agent is contacted with the crosslinkable precursor composition for a predetermined duration before subjecting the crosslinkable precursor to 3-D printing photocrosslinking conditions, such as for 1 hour or more, 5 hours or more, 10 hours or more, 12 hours or more, 24 hours or more, 3 days or more and including 1 week or more. After contacting the bioactive agent with the crosslinkable precursor composition, the crosslinkable polydepsipeptide copolymer precursor-bioactive agent composition is subjected to 3-D printing photocrosslinking conditions for a duration sufficient to produce a crosslinked copolymer-bioactive agent where the bioactive agent is crosslinked with the polydepsipeptide copolymer.

The extent of crosslinking to incorporate the bioactive agent into the crosslinked polydepsipeptide copolymer may vary depending on the bioactive agent and the amount of loaded bioactive agent desired. In certain embodiments, the bioactive agent is a cell-containing bioactive agent, such as human umbilical vein endothelial cells (HUVEC) and the crosslinked polydepsipeptide copolymer is crosslinked in a manner sufficient t incorporate the cell-containing bioactive agent into the crosslinked copolymer. In these embodiments, the crosslink density may be varied such that the crosslinked polydepsipeptide copolymer degrades at a rate sufficient to accommodate cell growth.

In certain instances, the degradation rate of the crosslinked polydepsipeptide copolymer is equivalent to 10% or more of the rate of cellular growth of the incorporated cell-containing bioactive agent, such as 20% or more, such as 50% or more, such as 75% or more, such as 90% or more and including being 99% or more of the rate of cellular growth of the incorporated cell-containing bioactive agent. In certain embodiments, the degradation rate of the crosslinked polydepsipeptide copolymer is equivalent to the cellular growth rate of the cell-containing bioactive agent that is incorporated into the crosslinked copolymer. For example, the crosslinked copolymer may be configured to degrade by 1% by weight or more per day, such as by 2% by weight or more per day, such as by 5% by weight or more per day, such as by 10% by weight or more per day, such as by 25% by weight or more per day and including degrading by 50% by weight or more per day. Degradation in certain embodiments includes degradation of the copolymer (i.e., depsipeptide-second monomer copolymer) backbone. In other embodiments, degradation includes degradation of the crosslinker (e.g., acrylate or methacrylate crosslinker).

In embodiments of the present disclosure, conditions for photocrosslinking the crosslinkable precursors by 3-D printing are cytocompatible. By “cytocompatible” is meant that crosslinking the crosslinkable polydepsipeptide precursors by 3-D printing has little to no negative or detrimental effects to the bioactive agent, such as bioactive agents including cells. In other words, photocrosslinking the crosslinkable precursors by 3-D printing results in 1% or less degradation or deactivation of the bioactive agent (such as cell death), such as 0.5% or less, such as 0.1% or less, such as 0.05% or less, such as 0.01% or less, such as 0.005% or less, such as 0.001% or less and including 0.0005% or less. In certain embodiments, photocrosslinking the crosslinkable precursors by 3-D printing has no effect on the bioactive agent.

In practicing methods of the present disclosure, the properties of the morpholine-2,5-dione monomer, ε-caprolactone, polyethylene glycol monomer (e.g., three or four armed polyethylene glycol macromer), crosslinker, copolymers of depsipeptide with second monomer (e.g., ε-caprolactone, polyethylene glycol macromer), crosslinkable copolymer precursors and the final crosslinked copolymers may be characterized at any phase. The term characterizing is used to refer to the analysis of one or more of the properties or components of the morpholine-2,5-dione monomer, ε-caprolactone, polyethylene glycol monomer (e.g., three or four armed polyethylene glycol macromer), crosslinker, copolymers of depsipeptide with second monomer (e.g., ε-caprolactone, polyethylene glycol macromer), crosslinkable copolymer precursors and the final crosslinked copolymers. Characterizing may include, but is not limited to, determining the composition (depsipeptide to the ε-caprolactone ratio, depsipeptide to polyethylene glycol monomer ratio, crosslink density), pH, physical properties (e.g., swelling ratio, compressive modulus, porosity), content assay (API), spectroscopic properties and impurity composition (trace metals, relating substances, etc.). Methods for analyzing compositions of the invention may include, but are not limited to the use of high performance liquid chromatography (HPLC), gas chromatography mass spectrometry, nuclear magnetic resonance spectroscopy (NMR), Fourier transform infrared spectroscopy (FT-IR), UV-vis spectroscopy, among other analytical protocols.

In some embodiments, methods include monitoring reaction of morpholine-2,5-dione monomer with ε-caprolactone or the polyethylene glycol monomer (e.g., three or four armed polyethylene glycol macromer) during ring-opening polymerization, preparing the crosslinkable copolymer precursors by reaction of the polydepsipeptide copolymers with crosslinker as well as monitoring crosslinking of the crosslinkable copolymers by 3-D printing. In some embodiments, monitoring includes collecting real-time data (e.g., NMR spectra, FT-IR spectra) such as by employing a detector to monitor each composition. In other embodiments, monitoring includes characterizing each composition at regular intervals, such as every 1 minute, every 5 minutes, every 10 minutes, every 30 minutes, every 60 minutes or some other interval. In yet other embodiments, methods include characterizing each composition as each step is completed.

In some embodiments, methods of the present disclosure also include assessing the properties of the characterized composition. By “assessing” is meant that a human (either alone or with the assistance of a computer, if using a computer-automated process initially set up under human direction), evaluates the determined composition and determines whether the composition is suitable or unsuitable to continue on to the next step of processing. If after assessing that the determined composition is suitable, each composition may proceed to the following step without any further adjustments. In other words, methods of these embodiments include a step of assessing the determined composition to identify any desired adjustments (e.g., morpholine-2,5-dione monomer to ε-caprolactone or polyethylene glycol monomer (e.g., three or four armed polyethylene glycol macromer) ratio, crosslink density, etc.).

In certain instances, methods include assessing that crosslinked copolymer has a less than desirable compressive strength. In these instances, methods may further include adjusting the depsipeptide content of the crosslinked copolymer, such as by increasing or decreasing the amount of morpholine-2,5-dione monomer used in preparing the copolymer. For example, in embodiments where a crosslinked copolymer having a greater compressive strength is desired, methods may include increasing the amount of morpholine-2,5-dione monomer when preparing the copolymer. In other embodiments where a crosslinked copolymer having a lower compressive strength is desired, methods may include reducing the amount of morpholine-2,5-dione monomer contacted with the second monomer (e.g., ε-caprolactone or polyethylene glycol macromer) when preparing the copolymer.

In certain instances, methods include assessing that crosslinked copolymer has a less than desirable rate of in vivo hydrolytic degradation. In these instances, methods may further include adjusting the depsipeptide content of the crosslinked copolymer, such as by increasing or decreasing the amount of morpholine-2,5-dione monomer used in preparing the copolymer. For example, to increase the rate of in vivo hydrolytic degradation of the subject crosslinked copolymers, methods may include increasing the amount of morpholine-2,5-dione monomer contacted with the second monomer (e.g., ε-caprolactone or polyethylene glycol macromer) when preparing the copolymer. In other embodiments, to decrease the rate of in vivo hydrolytic degradation of the subject crosslinked copolymers, methods may include reducing the amount of morpholine-2,5-dione monomer contacted with the second monomer (e.g., ε-caprolactone or polyethylene glycol macromer) when preparing the copolymer.

### Crosslinked Polydepsipeptide Copolymers

As summarized above, the subject invention provides three-dimensional crosslinked polydepsipeptide copolymer scaffolds produced by 3-D printing. The subject crosslinked copolymers include at least a depsipeptide (a hydrophilic component) and a second component (e.g., ε-caprolactone, polyethylene glycol component). In certain embodiments, the subject crosslinked polydepsipeptide copolymers are crosslinked copolymer hydrogels. As discussed above, the term “hydrogel” is used in its conventional sense to refer to a material that absorbs a solvent (e.g. water), undergoes swelling without measurable dissolution, and maintains three-dimensional networks capable of reversible deformation. “Swelling” as referred to herein is meant the isotropic expansion of the hydrogel structure as water molecules diffuse throughout the internal volume of the hydrogel. Although the subject crosslinked copolymer hydrogels may include hydrophobic and hydrophilic components, the hydrogel does not dissolve in water. As such, the properties of crosslinked copolymers of interest may be modulated as desired, by varying the amounts of each component, ratios of each component or the density of specific components, as described in greater detail below. The term hydrogel is used herein in its conventional sense and may include both desiccated and hydrated (e.g., solvent swollen) hydrogels.

The subject crosslinked copolymer of the invention include copolymers having a depsipeptide component and a second component (e.g., a polyester ring-opened ε-caprolactone component or a polyethylene glycol macromer component). As discussed above, the depsipeptide component is prepared under ring-opening polymerization conditions of a morpholine-2,5-dione monomer with a second monomer (e.g., ε-caprolactone, polyethylene glycol monomer). In some instances, the morpholine-2,5-dione monomer is a compound of formula:

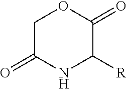

where R is selected from hydrogen, alkyl, substituted alkyl, aryl, substituted aryl, arylalkyl, substituted arylalkyl, heteroalkyl, substituted heteroalkyl, heteroaryl, substituted heteroaryl, heteroarylalkyl, and substituted heteroarylalkyl. For example, R may be a side chain of an amino acid residue selected from alanine, arginine, asparagine, aspartic acid, cysteine, glycine, glutamine, glutamic acid, histidine, isoleucine, leucine, lysine, methionine, phenylalanine, proline, serine, threonine, tryptophan, tyrosine and valine.

In embodiments, the depsipeptide component of the subject crosslinked copolymers may be prepared with one or more different morpholine-2,5-dione monomers, such as two or more different morpholine-2,5-dione monomers, such as three or more, such as five or more, such as 10 or more and including 15 or more different morpholine-2,5-dione monomers. The depsipeptide component may have a molecular weight which varies depending on the properties of the final crosslinked copolymer desired and may be 0.5 kDa or greater, such as 1 kDa or greater, such as 1.5 kDa or greater, such as 2.5 kDa or greater, such as 5 kDa or greater, such as 7.5 kDa or greater, such as 10 kDa or greater, such as 12.5 kDa or greater, such as 15 kDa or greater, such as 20 kDa or greater and including 25 kDa or greater. The depsipeptide component may be present in the subject crosslinked copolymers in an amount ranging from 1% to 99% w/w, such as 2% to 95% w/w, such as 5% to 90% w/w, such as 10% to 90% w/w, such as 15% to 85% w/w, such as 20% to 80% w/w, such as 25% to 75% w/w, such as 30% to 70% w/w and including 35% to 65% w/w. For example, the molar ratio of depsipeptide may range from 1 to 50 mol %, such as from 2 to 40 mol %, such as from 3 to 30 mol %, such as 4 to 20 mol % and including from 5 to 10 mol % depsipeptide.

In some embodiments, the subject crosslinked copolymers include a ring-opened ε-caprolactone component. The ε-caprolactone component in the subject crosslinked poly(depsipeptide-co-ε-caprolactone) copolymers may have a molecular weight which varies depending on the properties of the copolymer desired (e.g., hydrophilicity, mechanical properties, degradation rates, bioactive agent release kinetics), and may be 0.5 kDa or greater, such as 1 kDa or greater, such as 1.5 kDa or greater, such as 2.5 kDa or greater, such as 5 kDa or greater, such as 7.5 kDa or greater, such as 10 kDa or greater, such as 12.5 kDa or greater, such as 15 kDa or greater, such as 20 kDa or greater and including 25 kDa or greater. Likewise, the amount of the ε-caprolactone component may vary. For instance, the ε-caprolactone component may be present in the subject crosslinked copolymers in an amount ranging from 1% to 99% w/w, such as 2% to 95% w/w, such as 5% to 90% w/w, such as 10% to 90% w/w, such as 15% to 85% w/w, such as 20% to 80% w/w, such as 25% to 75% w/w, such as 30% to 70% w/w and including 35% to 65% w/w. In certain embodiments, the molar ratio of depsipeptide may range from 1 to 99 mol %, such as from 50 to 98 mol %, such as from 60 to 97 mol %, such as 70 to 96 mol % and including from 90 to 95 mol % ring-opened ε-caprolactone component.

In some embodiments, the second monomer (e.g., ε-caprolactone component polyethylene glycol macromer component) imparts hydrophobic or biocompatibility properties to the subject crosslinked copolymers while the depsipeptide component imparts hydrophilic properties. The biocompatibility, protein affinity and degradability of the depsipeptide component may be combined with controllable physical and mechanical properties of the second monomer (e.g, ε-caprolactone component, polyethylene glycol macromere component) to produce crosslinked copolymers having the desired balance of properties. By varying the ratio of the depsipeptide component to the second monomer component, crosslinked copolymers having desired physicochemical and active agent release kinetics may be attained. As illustrated in greater detail below, varying ratios of the depsipeptide component and ε-caprolactone or polyethylene glycol macromer components facilitate tunable biocompatibility, compressive modulus, swelling ratio, degradability, pore size and active agent release kinetics.

In some embodiments, the subject polydepsipeptide copolymers is a poly(depsipeptide-co-ε-caprolactone) copolymer produced by contacting one or more morpholine-2,5-dione monomers with ε-caprolactone under ring-opening polymerization conditions is a compound of formula:

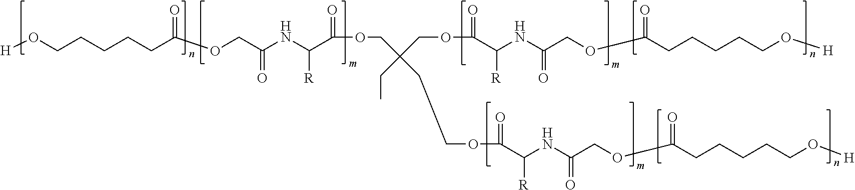

where each R is independently selected from hydrogen, alkyl, substituted alkyl, aryl, substituted aryl, arylalkyl, substituted arylalkyl, heteroalkyl, substituted heteroalkyl, heteroaryl, substituted heteroaryl, heteroarylalkyl, and substituted heteroarylalkyl; m is an integer from 1 to 1000 and n is an integer from 1 to 1000. For example, R may be a side chain of an amino acid residue selected from alanine, arginine, asparagine, aspartic acid, cysteine, glycine, glutamine, glutamic acid, histidine, isoleucine, leucine, lysine, methionine, phenylalanine, proline, serine, threonine, tryptophan, tyrosine and valine. In certain embodiments, R is methyl.

In some embodiments of the invention, the ratio of depsipeptide to ε-caprolactone in the subject crosslinked copolymers may vary, in some embodiments ranging between 10:1 and 9.5:1; 9.5:1 and 9:1; 9:1 and 8.5:1; 8.5:1 and 8:1; 8:1 and 7.5:1; 7.5:1 and 7:1; 7:1 and 6.5:1; 6.5:1 and 6:1; 6:1 and 5.5:1; 5.5:1 and 5:1; 5:1 and 4.5:1; 4.5:1 and 4:1; 4:1 and 3.5:1; 3.5:1 and 3:1; 3:1 and 2.5:1; 2.5:1 and 2:1; 2:1 and 1.5:1; 1.5:1 and 1:1 or a range thereof. For example, the mass ratio of the depsipeptide component to the ε-caprolactone component may range from 10:1 and 1:1, such as 8:1 and 1:1, such as 5:1 and 1:1, such as 4:1 and 1:1, and including from 2:1 and 1:1. In certain instances, the ratio of depsipeptide to ε-caprolactone is 1:1.

In other embodiments, the ratio of depsipeptide to ε-caprolactone in the subject crosslinked copolymers may vary, in some embodiments ranging between 1:1 and 1:1.5; 1:1.5 and 1:2; 1:2 and 1:2.5; 1:2.5 and 1:3; 1:3 and 1:3.5; 1:3.5 and 1:4; 1:4 and 1:4.5; 1:4.5 and 1:5; 1:5 and 1:5.5; 1:5.5 and 1:6; 1:6 and 1:6.5; 1:6.5 and 1:7; 1:7 and 1:7.5; 1:7.5 and 1:8; 1:8 and 1:8.5; 1:8.5 and 1:9; 1:9 and 1:9.5; 1:9.5 and 1:10 or a range thereof. For example, the ratio of chitosan to the polyester may range from 1:1 and 1:10, such as 1:1 and 1:8, such as 1:1 and 1:5, such as 1:1 and 1:4, and including from 1:1 and 1:2.

In some embodiments, the subject crosslinked copolymers include a polyethylene glycol component, such as a three or four-arm polyethylene glycol macromer. For example, the polyethylene glycol macromer may be a compound of the formula:

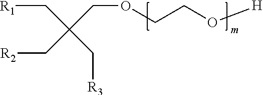

where R₁, R₂ and R₃ are each independently selected from hydrogen, alkyl, substituted alkyl, heteroalkyl and substituted heteroalkyl; and m is a positive integer from 1 to 1000. The polyethylene glycol macromer component in the subject crosslinked poly(ethylene glycol-co-depsipeptide) copolymers may have a molecular weight which varies depending on the properties of the copolymer desired (e.g., hydrophilicity, mechanical properties, degradation rates, bioactive agent release kinetics), and may be 0.5 kDa or greater, such as 1 kDa or greater, such as 1.5 kDa or greater, such as 2.5 kDa or greater, such as 5 kDa or greater, such as 7.5 kDa or greater, such as 10 kDa or greater, such as 12.5 kDa or greater, such as 15 kDa or greater, such as 20 kDa or greater and including 25 kDa or greater. Likewise, the amount of the polyethylene glycol macromer component may vary. For instance, the polyethylene glycol macromer component may be present in the subject crosslinked copolymers in an amount ranging from 1% to 99% w/w, such as 2% to 95% w/w, such as 5% to 90% w/w, such as 10% to 90% w/w, such as 15% to 85% w/w, such as 20% to 80% w/w, such as 25% to 75% w/w, such as 30% to 70% w/w and including 35% to 65% w/w. In certain embodiments, the molar ratio of depsipeptide may range from 1 to 99 mol %, such as from 50 to 98 mol %, such as from 60 to 97 mol %, such as 70 to 96 mol % and including from 90 to 95 mol % polyethylene glycol macromer component.

In certain instances, the poly(ethylene glycol-co-depsipeptide) copolymer produced by contacting one or more morpholine-2,5-dione monomers with the polyethylene glycol monomer under ring-opening polymerization conditions is a compound of formula:

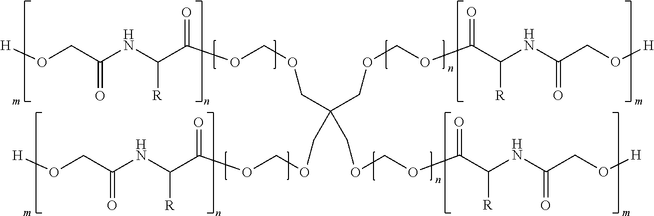

where each R is independently selected from hydrogen, alkyl, substituted alkyl, aryl, substituted aryl, arylalkyl, substituted arylalkyl, heteroalkyl, substituted heteroalkyl, heteroaryl, substituted heteroaryl, heteroarylalkyl, and substituted heteroarylalkyl; m is an integer from 1 to 1000 and n is an integer from 1 to 1000. For example, R may be a side chain of an amino acid residue selected from alanine, arginine, asparagine, aspartic acid, cysteine, glycine, glutamine, glutamic acid, histidine, isoleucine, leucine, lysine, methionine, phenylalanine, proline, serine, threonine, tryptophan, tyrosine and valine. In certain embodiments, R is methyl.

In some embodiments, the molar ratio of the polyethylene glycol component to morpholine-2,5-dione monomer in preparing the poly(ethylene glycol-co-depsipeptide) copolymers may vary, in some embodiments ranging between 10:1 and 9.5:1; 9.5:1 and 9:1; 9:1 and 8.5:1; 8.5:1 and 8:1; 8:1 and 7.5:1; 7.5:1 and 7:1; 7:1 and 6.5:1; 6.5:1 and 6:1; 6:1 and 5.5:1; 5.5:1 and 5:1; 5:1 and 4.5:1; 4.5:1 and 4:1; 4:1 and 3.5:1; 3.5:1 and 3:1; 3:1 and 2.5:1; 2.5:1 and 2:1; 2:1 and 1.5:1; 1.5:1 and 1:1 or a range thereof. For example, the molar ratio of the polyethylene glycol component to the morpholine-2,5-dione monomer may range from 10:1 and 1:1, such as 8:1 and 1:1, such as 5:1 and 1:1, such as 4:1 and 1:1, and including from 2:1 and 1:1. In certain instances, the molar ratio of the polyethylene glycol component to the morpholine-2,5-dione monomer is 19:1. In other instances, the molar ratio of the polyethylene glycol component to the morpholine-2,5-dione monomer is 9:1.

In other embodiments, the molar ratio of morpholine-2,5-dione monomer to the polyethylene glycol component in preparing the poly(ethylene glycol-co-depsipeptide) copolymer may vary, in some embodiments ranging between 10:1 and 9.5:1; 9.5:1 and 9:1; 9:1 and 8.5:1; 8.5:1 and 8:1; 8:1 and 7.5:1; 7.5:1 and 7:1; 7:1 and 6.5:1; 6.5:1 and 6:1; 6:1 and 5.5:1; 5.5:1 and 5:1; 5:1 and 4.5:1; 4.5:1 and 4:1; 4:1 and 3.5:1; 3.5:1 and 3:1; 3:1 and 2.5:1; 2.5:1 and 2:1; 2:1 and 1.5:1; 1.5:1 and 1:1 or a range thereof. For example, the molar ratio of morpholine-2,5-dione monomer to the polyethylene glycol component may range from 10:1 and 1:1, such as 8:1 and 1:1, such as 5:1 and 1:1, such as 4:1 and 1:1, and including from 2:1 and 1:1. In certain instances, the molar ratio of morpholine-2,5-dione monomer to the polyethylene glycol component is 19:1. In other instances, the molar ratio of morpholine-2,5-dione monomer to the polyethylene glycol component is 9:1.

Crosslinked copolymers provided by the present disclosure may be 1 kDa or greater, such as 2 kDa or greater, such as 3 kDa or greater, such as 5 kDa or greater, such as 10 kDa or greater, such as 15 kDa or greater, such as 20 kDa or greater, such as 25 kDa or greater, such as 30 kDa or greater, such as 40 kDa or greater, such as 50 kDa or greater, such as 60 kDa or greater and including 75 kDa or greater.

As reviewed above, the subject crosslinked copolymers include one or more crosslinkers. The term “crosslink” is used its conventional sense to refer to the physical (e.g., intermolecular interactions or entanglements, such as through hydrophobic interactions) or chemical (e.g., covalent bonding) interaction between backbone components of the subject crosslinked copolymers (e.g., depsipeptide component and ε-caprolactone component).

In certain embodiments, the type and degree of crosslinking modulates the three-dimensional copolymer scaffold structure, mechanical properties (e.g., compressive modulus), active agent release kinetics, swelling (i.e., solvent absorption) as well as degradation. In some embodiments, crosslinkers are hydrolysable. Hydrolysis of crosslinks under physiological conditions allows the three-dimensional copolymer scaffold prepared by 3-D printing to more readily biodegrade and can be used for in vivo protocols. Likewise, by crosslinking, the crosslinked copolymers can be adapted to be implantable, and can be in certain embodiments take the shape of a membrane, sponge, gel, solid scaffold, spun fiber, woven or unwoven mesh, nanoparticle, microparticle, or other configuration desired.

In some embodiments, the subject crosslinked copolymers include one or more crosslinks that are hydrolysable allowing for degradation under physiological conditions (e.g., in vivo). In one example, the hydrolyzable crosslinker is an acrylate crosslinker. Acrylate crosslinkers may include, but is not limited to acrylate, methacrylate, ethyl acrylate, butyl acrylate, butyl methacrylate, ethylene glycol diacrylate, ethylene glycol dimethacrylate, poly(ethylene glycol) diacrylate and poly(ethylene glycol) dimethacrylate. In some instances, the acrylate crosslinker may be a methacrylate crosslinker.

In some embodiments, the crosslinkable copolymer precursor is a crosslinkable poly(depsipeptide-co-ε-caprolactone) copolymer precursor of formula:

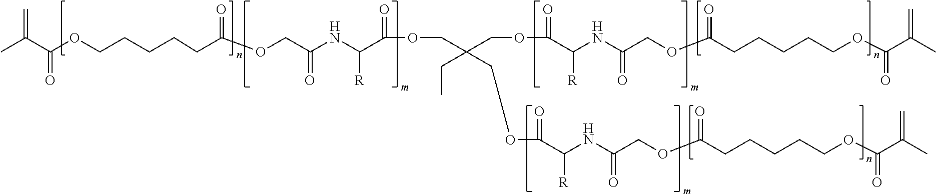

where R is selected from hydrogen, alkyl, substituted alkyl, aryl, substituted aryl, arylalkyl, substituted arylalkyl, heteroalkyl, substituted heteroalkyl, heteroaryl, substituted heteroaryl, heteroarylalkyl, and substituted heteroarylalkyl; m is an integer from 1 to 1000; and n is an integer from 1 to 1000. For example, each R is independently a side chain of an amino acid residue selected from alanine, arginine, asparagine, aspartic acid, cysteine, glycine, glutamine, glutamic acid, histidine, isoleucine, leucine, lysine, methionine, phenylalanine, proline, serine, threonine, tryptophan, tyrosine and valine. In certain embodiments, R is methyl.

In other embodiments, the crosslinkable copolymer precursor is a crosslinkable poly(ethylene glycol-co-depsipeptide) copolymer precursor of formula:

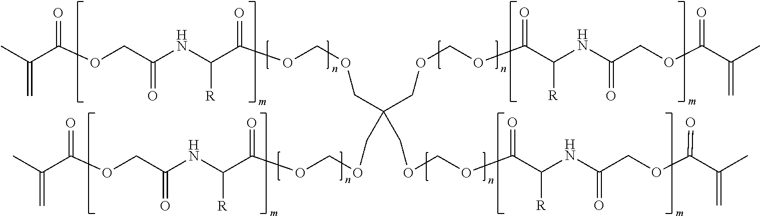

where R is selected from hydrogen, alkyl, substituted alkyl, aryl, substituted aryl, arylalkyl, substituted arylalkyl, heteroalkyl, substituted heteroalkyl, heteroaryl, substituted heteroaryl, heteroarylalkyl, and substituted heteroarylalkyl; m is an integer from 1 to 1000; and n is an integer from 1 to 1000. For example, each R is independently a side chain of an amino acid residue selected from alanine, arginine, asparagine, aspartic acid, cysteine, glycine, glutamine, glutamic acid, histidine, isoleucine, leucine, lysine, methionine, phenylalanine, proline, serine, threonine, tryptophan, tyrosine and valine. In certain embodiments, R is methyl.

As discussed above, the subject crosslinkable copolymer precursors produced by contacting the polydepsipeptide copolymer with a crosslinker are crosslinked by 3-D printing to produce a crosslinked polydepsipeptide copolymer. In some embodiments, crosslinked copolymers of interest include one or more hydrolyzable ester linkage. For example, the subject crosslinked copolymers may include a crosslink of the formula:

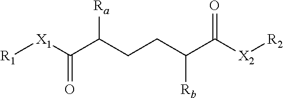

where:

Rₐ and R_{b} are each individually selected from hydrogen, alkyl and substituted alkyl, for example where Rₐ and R_{b} are each hydrogen; or Rₐ and R_{b} are each alkyl; or Rₐ and R_{b} are each methyl; or Rₐ is alkyl and R_{b} is hydrogen; or Rₐ is methyl and R_{b} is hydrogen.

X₁ and X₂ are each individually selected from C, N and O, for example where X₁ and X₂ are 0; and

R₁ and R₂ are each the depsipeptide or second monomer component (e.g., ε-caprolactone polyethylene glycol macromer component), for example where R₁ is depsipeptide and R₂ is the ε-caprolactone or polyethylene glycol macromer component; or R₁ is the ε-caprolactone or polyethylene glycol macromer component and R₂ is depsipeptide; or R₁ and R₂ are depsipeptide; or R₁ and R₂ are both the ε-caprolactone or polyethylene glycol macromer component.

In one example, the subject crosslinked copolymer hydrogels are crosslinked copolymers which include a crosslink of the formula:

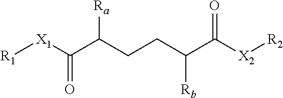

where Rₐ and R_{b} are each methyl;

X₁ and X₂ are 0;

R₁ is the ε-caprolactone or polyethylene glycol macromer component; and

R₂ is the ε-caprolactone or polyethylene glycol macromer component.

The crosslinker may have a molecular weight which varies depending on the properties of the final crosslinked copolymer desired and may be 0.1 kDa or greater, such as 0.25 kDa or greater, such as 0.5 kDa or greater, such as 0.75 kDa or greater, such as 1 kDa or greater, such as 1.25 kDa or greater, such as 1.5 kDa or greater, such as 2 kDa or greater, such as 2.5 kDa or greater, such as 3 kDa or greater and including 5 kDa or greater. Likewise, the amount of crosslinker may vary. For instance, crosslinker may be present in an amount ranging from 0.05% to 35% w/w, such as 0.1% to 30% w/w, such as 0.5% to 25% w/w, such as 0.75% to 20% w/w, such as 1% to 15% w/w, such as 1.5% to 12.5% w/w and including 2% to 10% w/w.

In certain embodiments, the crosslinkable copolymer precursor is covalently bonded to an adhesion protein. In one example, adhesion proteins of interest include, but are not limited to, adhesion peptides configured to provide an integrin-specific attachment site on the crosslinked copolymer. For instance, the adhesion protein may include arginine, glycine, aspartic acid and serine residues, such as an adhesion protein having the formula:

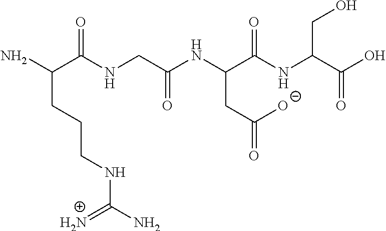 [SMILES: NC(=[NH2+])NCCCC(N)C(=O)NCC(=O)NC(CC(=O)[O-])C(=O)NC(CO)C(=O)O]

In certain embodiments, the adhesion protein is crosslinked to the crosslinkable copolymer precursor, such as through an acrylate crosslinker. For example, the adhesion protein may include a polyethylene glycol substituted acrylate group. In some instances, the adhesion protein has the formula:

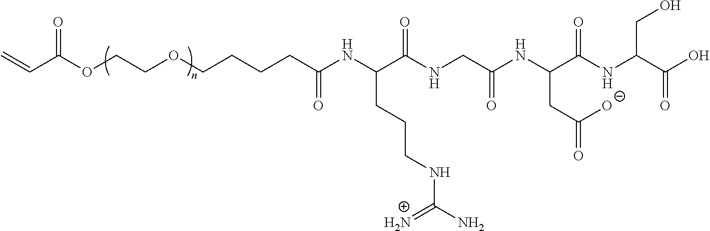

In some embodiments, the crosslinkable copolymer precursor is a crosslinkable poly(ethylene glycol-co-depsipeptide) copolymer covalently bonded to an adhesion protein of the compound:

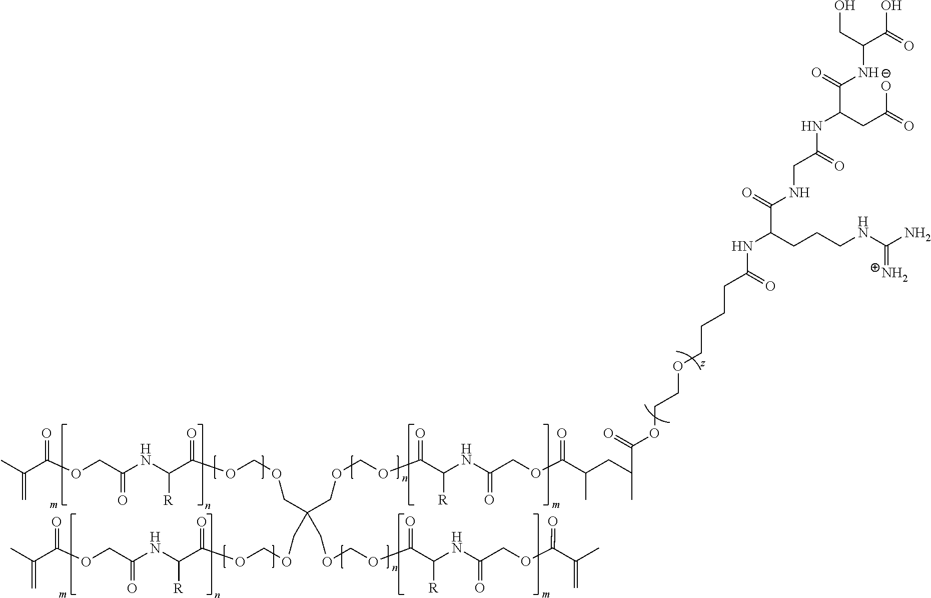

where R is selected from hydrogen, alkyl, substituted alkyl, aryl, substituted aryl, arylalkyl, substituted arylalkyl, heteroalkyl, substituted heteroalkyl, heteroaryl, substituted heteroaryl, heteroarylalkyl, and substituted heteroarylalkyl; m is an integer from 1 to 1000; n is an integer from 1 to 1000 and z is an integer from 1 to 1000. In some instances, z is from 10 to 110, such as 77. For example, each R is independently a side chain of an amino acid residue selected from alanine, arginine, asparagine, aspartic acid, cysteine, glycine, glutamine, glutamic acid, histidine, isoleucine, leucine, lysine, methionine, phenylalanine, proline, serine, threonine, tryptophan, tyrosine and valine. In certain embodiments, R is methyl.

Physicochemical properties (e.g., swelling behavior), mechanical properties (e.g, compressive modulus), degradation rates as well as active agent release kinetics of the subject crosslinked copolymers can be modulated by varying the amount of crosslinks present. For example, the percentage of crosslinks can be varied between about 1% and about 50% by weight, and, such as from about 2% and about 45% by weight, such as from about 3% and 40% by weight, such as from 4% to 35% by weight and including from about 5% to 30% by weight. For instance, by increasing the percentage of crosslinks, the degradation rate of the subject crosslinked copolymer can be decreased. Similarly, the compressive modulus of the subject crosslinked copolymer can be increased by increasing the percentage of crosslinks. Still further, the swelling ratio of the subject crosslinked copolymer can be increased by decreasing the percentage of crosslinks. Accordingly, depending on the mechanical and physicochemical properties desired the subject crosslinked copolymers may have a crosslink density which ranges from 1×10⁻¹⁵ moles/cm³ to 1×10⁻³ moles/cm³, such as 1×10⁻¹⁴ moles/cm³ to 1×10⁻³ moles/cm³, such as 1×10⁻¹³ moles/cm³ to 1×10⁻³ moles/cm³, such as 1×10⁻¹² moles/cm³ to 1×10⁻³ moles/cm³, such as 1×10⁻¹¹ moles/cm³ to 1×10⁻³ moles/cm³, such as 1×10⁻¹⁰ moles/cm³ to 1×10⁻³ moles/cm³, such as 1×10⁻⁹ moles/cm³ to 1×10⁻³ moles/cm³, such as 1×10⁻⁸ moles/cm³ to 1×10⁻³ moles/cm³, such as 1×10⁻¹¹ moles/cm³ to 1×10⁻⁷ moles/cm³, and including 1×10⁻⁶ moles/cm³ to 1×10⁻³ moles/cm³. In certain embodiments, the crosslink density ranges from 1×10⁻⁴ mol/cm³ to 1×10⁻⁵ mol/cm³. For example, the crosslink density in certain instances is 9×10⁻⁴ mol/cm³.

As noted above, the physicochemical and mechanical properties as well as the active agent release kinetics may vary depending on crosslinked structure. In certain instances, the subject crosslinked copolymers absorb solvent (e.g. water) and undergo swelling under physiological conditions (e.g., in contact with blood or plasma), where in certain embodiments, the swelling ratio of the subject crosslinked copolymers range from 3 to 30, such as from 4 to 27, such as from 5 to 25, such as from 6 to 20, such as form 7 to 18, such as from 8 to 17, such as from 9 to 16 and including a swelling ratio ranging from 5 to 15. Likewise, the compressive modulus of the subject crosslinked copolymers may vary depending on the composition (e.g., depsipeptide content, ε-caprolactone or polyethylene glycol macromer content) as well as 3-D printing crosslinking conditions (e.g., light intensity, duration, etc.) In some embodiments, the compressive modulus of the subject crosslinked copolymers range from 1 MPa to 35 MPa, such as from 2 MPa to 33 MPa, such as from 3 MPa to 30 MPa, such as from 4 MPa to 28 MPa, such as form 5 MPa to 25 MPa, such as from 6 MPa to 22 MPa, such as from 7 MPa to 20 MPa and including a compressive modulus ranging from 10 MPa to 20 MPa.

The pore sizes of the subject crosslinked copolymers may also vary. In some embodiments, the pore sizes of crosslinked copolymers of interest ranges from 0.1 microns to 1000 microns, such as 0.5 microns to 900 microns, such as 1 micron to 800 microns, such as 5 microns to 750 microns, such as 10 microns to 600 microns, such as 25 microns to 500 microns, such as 50 microns to 400 microns and including from 100 microns to 300 microns.

In some embodiments, the subject crosslinked copolymers are biodegradable (i.e., degrade to produce innocuous constituents) and the rate of degradation under physiological conditions may vary depending on the structure and composition (e.g., depsipeptide content, ε-caprolactone content polyethylene glycol macromer component, presence of bioactive agent). In some instances, the subject crosslinked copolymers are structurally designed to degrade under physiological conditions (e.g., in vivo) over a predetermined duration, such as for example 0.5 days or longer, such as 1 day or longer, such as 2 days or longer, such as 5 days or longer, such as 7 days or longer, such as 10 days or longer, such as 14 days or longer, such as 21 days or longer, such as 28 days or longer, such as 70 days or longer and including 100 days or longer.

In other embodiments, crosslinked copolymers of interest are configured to degrade when exposed to physiological conditions at a predetermined rate, such as at a substantially zero-order degradation rate, such as at a substantially first order degradation rate and including at a substantially second-order degradation rate. In certain embodiments, the subject crosslinked copolymers are configured (e.g., possess a crosslink density) that degrades at a rate sufficient to accommodate cell growth, such as the cells of a cell-containing bioactive agent. In certain instances, the subject crosslinked copolymers are configured to degrade under physiological conditions at a rate that is equivalent to 10% or more of the rate of cellular growth of cells (e.g., cell-containing bioactive agent) incorporated therein, such as at a rate that is 20% or more, such as 50% or more, such as 75% or more, such as 90% or more and including degrading at a rate that is equivalent to 99% or more of the rate of cellular growth of cells incorporated therein. In certain embodiments, the degradation rate of the subject crosslinked copolymers is equivalent to the cellular growth rate of cells incorporated into the subject crosslinked copolymers.

In some embodiments, aspects of the present disclosure further include one or more bioactive agents adsorbed or absorbed within the subject crosslinked copolymers or in the crosslinkable copolymer precursors. In one embodiment, the present disclosure provides crosslinkable copolymer precursors having one or more bioactive agents. In another embodiment, the present disclosure provides crosslinked copolymers incorporating one or more bioactive agents.

As discussed above, suitable bioactive agents according to embodiments of the invention may include but are not limited to interferon, integrin binding sequences interleukin, erythropoietin, granulocyte-colony stimulating factor (GCSF), stem cell factor (SCI), leptin (OB protein), interferon (alpha, beta, gamma), antibiotics such as vancomycin, gentamicin ciprofloxacin, amoxycillin, lactobacillus, cefotaxime, levofloxacin, cefepime, mebendazole, ampicillin, lactobacillus, cloxacillin, norfloxacin, tinidazole, cefpodoxime, proxctil, azithromycin, gatifloxacin, roxithromycin, cephalosporin, anti-thrombogenics, aspirin, ticlopidine, sulfinpyrazone, heparin, warfarin, growth factors, differentiation factors, hepatocyte stimulating factor, plasmacytoma growth factor, glial derived neurotrophic factor (GDNF), neurotrophic factor 3 (NT3), fibroblast growth factor (FGF), transforming growth factor (TGF), platelet transforming growth factor, milk growth factor, endothelial growth factors, endothelial cell-derived growth factors (ECDGF), alpha-endothelial growth factors, beta-endothelial growth factor, neurotrophic growth factor, nerve growth factor (NGF), vascular endothelial growth factor (VEGF), 4-1 BB receptor (4-IBBR), TRAIL (TNF-related apoptosis inducing ligand), artemin (GFRalpha3-RET ligand), BCA-I (B cell-attracting chemokinel), B lymphocyte chemoattractant (BLC), B cell maturation protein (BCMA), brain-derived neurotrophic factor (BDNF), bone growth factor such as osteoprotegerin (OPG), bone-derived growth factor, thrombopoietin, megakaryocyte derived growth factor (MDGF), keratinocyte growth factor (KGF), platelet-derived growth factor (PDGF), ciliary neurotrophic factor (CNTF), neurotrophin 4 (NT4), granulocyte colony-stimulating factor (GCSF), macrophage colony-stimulating factor (mCSF), bone morphogenetic protein 2 (BMP2), BRAK, C-IO, Cardiotrophin 1 (CT1), CCR8, anti-inflammatory: paracetamol, salsalate, diflunisal, mefenamic acid, diclofenac, piroxicam, ketoprofen, dipyrone, acetylsalicylic acid, anti-cancer drugs such as aliteretinoin, altertamine, anastrozole, azathioprine, bicalutarnide, busulfan, capecitabine, carboplatin, cisplatin, cyclophosphamide, cytarabine, doxorubicin, epirubicin, etoposide, exemestane, vincristine, vinorelbine, hormones, thyroid stimulating hormone (TSH), sex hormone binding globulin (SHBG), prolactin, luteotropic hormone (LTH), lactogenic hormone, parathyroid hormone (PTH), melanin concentrating hormone (MCH), luteinizing hormone (LHb), growth hormone (HGH), follicle stimulating hormone (FSHb), haloperidol, indomethacin, doxorubicin, epirubicin, amphotericin B, Taxol, cyclophosphamide, cisplatin, methotrexate, pyrene, amphotericin B, anti-dyskinesia agents, Alzheimer vaccine, antiparkinson agents, ions, edetic acid, nutrients, glucocorticoids, heparin, anticoagulation agents, antivirus agents, anti-HIV agents, polyamine, histamine and derivatives thereof, cystineamine and derivatives thereof, diphenhydramine and derivatives, orphenadrine and derivatives, muscarinic antagonist, phenoxybenzamine and derivatives thereof, protein A, streptavidin, amino acid, beta-galactosidase, methylene blue, protein kinases, beta-amyloid, lipopolysaccharides, eukaryotic initiation factor-4G, tumor necrosis factor (TNF), tumor necrosis factor-binding protein (TNF-bp), interleukin-1 (to 18) receptor antagonist (IL-Ira), granulocyte macrophage colony stimulating factor (GM-CSF), novel erythropoiesis stimulating protein (NESP), thrombopoietin, tissue plasminogen activator (TPA), urokinase, streptokinase, kallikrein, insulin, steroid, acetaminophen, analgesics, antitumor preparations, anti-cancer preparations, anti-proliferative preparations or pro-apoptotic preparations, among other types of bioactive agents.

In some embodiments, bioactive agents include small molecule active agents. For example, suitable small molecule active agents include, but are not limited to, antipyretics, analgesics, antiseptics, anti-depressants, mood stabilizers, hormone replacements, stimulants, tranquilizers, psychedelics, hypnotics, anaesthetics, antipsychotics, antidepressants (including tricyclic antidepressants, monoamine oxidase inhibitors, lithium salts, and selective serotonin reuptake inhibitors (SSRIs)), antiemetics, anticonvulsants/antiepileptics, anxiolytics, barbiturates, movement disorder (e.g., Parkinson's disease) drugs, hemostatics, stimulants (including amphetamines), benzodiazepines, cyclopyrrolones, dopamine antagonists, antihistamines, cholinergics, anticholinergics, emetics, cannabinoids, and 5-HT (serotonin) antagonists, or any combination, pharmaceutically acceptable salt or prodrug thereof.

In certain embodiments, the one or more absorbed bioactive agents is a compound selected from the group consisting of chemotactic agents, cell attachment mediators, integrin binding sequences, epidermal growth factor (EGF), hepatocyte growth factor (HGF), vascular endothelial growth factors (VEGF), fibroblast growth factors, platelet derived growth factors (PDGF), insulin-like growth factor, transforming growth factors (TGF), human amniotic mesenchymal stem cells (hAMSCs), human bone marrow mesenchymal stem cells (hMSC), parathyroid hormone, parathyroid hormone related peptide, bone morphogenetic proteins (BMP), BMP-2, BMP-4, BMP-6, BMP-7, BMP-12, BMP-13, BMP-14, transcription factors, growth differentiation factor (GDF), GDF5, GDF6, GDF8, recombinant human growth factors, cartilage-derived morphogenetic proteins (CDMP), CDMP-1, CDMP-2 and CDMP-3. In certain instances, the subject hydrophilic-hydrophobic crosslinked copolymer hydrogels include bone morphogenetic protein 2 (BMP-2). In still other instances, the subject hydrogels include human amniotic mesenchymal stem cells (hAMSCs). In certain embodiments, the bioactive agent is not heparin-binding endothelial growth factor (HB-EGF)

In certain embodiments, bioactive agents include cell-containing bioactive agents, such as human or non-human endothelial cells, nerve cells, mesenchymal stem cells, pluripotent stem cells, embryonic stem cells, induced pluripotent stem cells, and other tissue cells such as bone, muscle, tendon, heart, liver, kidney, among other human and non-human tissues. In some embodiments, the bioactive agent includes human umbilical vein endothelial cells (HUVEC). In other embodiments, bioactive agents include cell-containing bioactive agents such as mesenchymal stem cells (MSC), such as human bone marrow mesenchymal stem cells (hMSC). The amount of bioactive agent incorporated into the crosslinked copolymer or crosslinkable copolymer precursor varies, such as 0.0001 μg or greater, such as 0.001 μg or greater, such as 0.01 μg or greater, such as 0.1 μg or greater, such as 1 μg or greater, such as 10 μg or greater, such as 25 μg or greater, such as 50 μg or greater, such as 100 μg or greater such as 500 μg or greater, such as 1000 μg or greater such as 5000 μg or greater and including 10,000 μg or greater. Where the bioactive agent is incorporated as a liquid, the concentration of bioactive agent may be 0.0001 μg/mL or greater, such as 0.001 μg/mL or greater, such as 0.01 μg/mL or greater, such as 0.1 μg/mL or greater, such as 0.5 μg/mL or greater, such as 1 μg/mL or greater, such as 2 μg/mL or greater, such as 5 μg/mL or greater, such as 10 μg/mL or greater, such as 25 μg/mL or greater, such as 50 μg/mL or greater, such as 100 μg/mL or greater such as 500 μg/mL or greater, such as 1000 μg/mL or greater such as 5000 μg/mL or greater and including 10,000 μg/mL or greater.

Depending on the three-dimensional structure the crosslinked copolymer scaffold prepared by 3-D printing (as discussed above), release of the one or more bioactive agents from the crosslinked copolymer matrix may be configured to vary as desired. For example, crosslinked copolymers of the present disclosure may be configured to provide a sustained release or pulsatile release of the one or more bioactive agents.

By “sustained release” is meant that the crosslinked copolymer is structured (e.g., depsipeptide to second monomer ratio, crosslink density) to provide for constant and continuous delivery of one or more bioactive agents over the entire time crosslinked copolymer is maintained in contact with the site of administration (e.g., bone implant), such as over the course of 1 day or longer, such as 2 days or longer, such as 5 days or longer, such as 10 days or longer, such as 15 days or longer, such as 30 days or longer and including 100 days or longer. For example, in certain instances the three-dimensional crosslinked poly(depsipeptide-ε-caprolactone) copolymer scaffolds prepared by 3-D printing may be configured to provide for sustained release of a biological macromolecule for a period of 7 days or longer, such as for 14 days or longer, such as 21 days or longer and including for 28 days or longer.

In other instances, crosslinked copolymers of interest are configured to provide a pulsatile release of one or more bioactive agents. By “pulsatile release” is meant that the crosslinked copolymer is configured to release one or more bioactive agents into the site of administration incrementally (e.g., at discrete times), such as every 1 hour, such as every 2 hours, such as every 5 hours, such as every 12 hours, such as every 24 hours, such as every 36 hours, such as every 48 hours, such as every 72 hours, such as every 96 hours, such as every 120 hours, such as every 144 hours and including every 168 hours.

In other instances, the subject crosslinked copolymers are configured to deliver one or more bioactive agents after certain percentages of the three-dimensional scaffold has been degraded. For example, an amount of the one or more bioactive agents may be delivered after every 10% of the crosslinks have degraded, such as after every 15% of the crosslinks of have degraded, such as after every 20% of the crosslinks have degraded, such as after every 25% of the crosslinks have degraded, such as after every 30% of the crosslinks have degraded and including after every 33% of the crosslinks have degraded.

In yet other instances, the subject crosslinked copolymers may be configured to release a large amount of the one or more bioactive agents immediately upon contact with the site of administration (such as to provide an acute reduction in pain), such as for example 50% or more, such as 60% or more, such as 70% or more and including 90% or more of the one or more bioactive agents are released immediately upon contact with the site of administration. In yet other instances crosslinked copolymers of interest may be configured to release one or more bioactive agents at a predetermined rate, such as at a substantially zero-order release rate, such as at a substantially first-order release rate or at a substantially second-order release rate.

In certain embodiments, crosslinked copolymers of the present invention are configured to provide a release profile of the bioactive agents, where the release profile includes:

a first period where the bioactive agent is released from the crosslinked copolymer at a first predetermined rate; and

a second period where the bioactive agent is released from the crosslinked copolymer at a second predetermined rate.

For example, in these embodiments, the first period may be a duration ranging from 0.5 hours to 72 hours from the initiation of administration, such as from 1 hour to 60 hours, such as from 2 hours to 48 hours, such as from 3 hours to 36 hours, such as from 4 hours to 30 hours and including from 5 hours to 24 hours from the time of administration. The second period may be a duration ranging from 0.5 hours to 336 hours from the administration time of the copolymer hydrogel, such as from 1 hour to 312 hours, such as from 2 hours to 288 hours, such as from 3 hours to 264 hours, such as from 4 hours to 240 hours, such as from 5 hours to 216 hours and including from 6 hours to 192 hours from the initiation of administration.

The rate of release during each respective period during the release profile may vary depending on how the crosslinked copolymer is structured (e.g., depsipeptide to second monomer ratio (e.g., ε-caprolactone, polyethylene glycol macromer), crosslink density, bioactive agent amount). In some embodiments, the first predetermined rate may be a substantially zero-order release rate. In other embodiments the first predetermined rate may be a substantially first-order release rate. In yet other embodiments the first predetermined rate may be a second-order release rate. Similarly, the second predetermined rate may be a substantially zero-order release rate, a substantially first-order release rate or a substantially second-order release rate.

In certain embodiments, the release profile includes a first period having a substantially first order release rate followed by a second period having a substantially zero order release rate. In other embodiments, the release profile includes a first period having a substantially second order release rate followed by a second period having a substantially first order release rate. In yet other embodiments, the release profile includes a first period having a substantially second order release rate followed by a second period having a substantially zero order release rate.

In these embodiments, the amount of the bioactive agent released during each respective period may vary. In some instances, the crosslinked copolymer is configured to release between 10% and 75% of the total amount of bioactive agent during the first period, such as between 15% and 70% of the total amount of bioactive agent, such as between 20% and 60% of the total amount of bioactive agent, such as between 25% and 50% of the total amount of bioactive agent and including between 30% and 35% of the total bioactive agent during the first period. In these instances, the crosslinked poly(depsipeptide-ε-caprolactone) copolymers may be configured to release between 10% and 75% of the total amount of bioactive agent during the second period, such as between 15% and 70% of the total amount of bioactive agent, such as between 20% and 60% of the total amount of bioactive agent, such as between 25% and 50% of the total amount of bioactive agent and including between 30% and 35% of the total bioactive agent during the second period.

Where more than one bioactive agent is delivered, the amount (i.e., mass) of each of bioactive agent may vary, ranging from 0.001 mg to 1000 mg, such as 0.01 mg to 500 mg, such as 0.1 mg to 250 mg, such as 0.5 mg to 100 mg, such as 1 mg to 50 mg, including 1 mg to 10 mg. As such, in compositions of the invention, the mass ratio of the first bioactive agent to other (i.e., second or more) bioactive agent may vary, and in some instances may range between 1:1 and 1:2.5; 1:2.5 and 1:5; 1:5 and 1:10; 1:10 and 1:25; 1:25 and 1:50; 1:50 and 1:100; 1:100 and 1:150; 1:150 and 1:200; 1:200 and 1:250; 1:250 and 1:500; 1:500 and 1:1000, or a range thereof. For example, the mass ratio of the first bioactive agent to other (i.e., second or more) bioactive agents may range between 1:1 and 1:10; 1:5 and 1:25; 1:10 and 1:50; 1:25 and 1:100; 1:50 and 1:500; or 1:100 and 1:1000.

Depending on the site of application and physiology of the subject, the amount of bioactive agent incorporated into the subject crosslinked copolymer for administration to the subject may vary. In some instances, the amount of bioactive agent may range from 0.001 mg to 500 mg, such as 0.005 mg to 400 mg, such as 0.01 to 300 mg, such as 0.1 to 200 mg, such as 1 to 100 mg, such as 2 to 90 mg, such as 3 to 80 mg, such as 4 to 70 mg and including 5 mg to 50 mg. Alternatively, the amount of bioactive agent may be a concentration (where the bioactive agent is present in a solvent), where the concentration may range, such as about 0.001-1000 μM, such as about 0.005-500 μM, such as about 0.01-100 μM, such as about 0.5-50 μM and including 1 to 25 mM. As such, depending on the potency of the bioactive agent as well as the desired effect, the concentration of bioactive agents delivered by the subject crosslinked poly(depsipeptide-ε-caprolactone) copolymers may range, from 0.01 μM to 500 μM, such as 0.1 μM to 250 μM, such as 0.1 μM to 100 μM, such as 0.1 μM to 75 μM, such as 0.1 μM to 50 μM, such as 0.1 μM to 25 μM, such as 0.1 μM to 10 μM, and including 0.1 μM to 1 μM.

In some embodiments, crosslinked copolymers of interest may be configured to deliver a predetermined dosage of bioactive agent. The term “predetermined dosage” is meant the desired amount of bioactive agent to be delivered. For example, the subject crosslinked copolymers may have a composition (e.g., three-dimensional structure, crosslink density, specific ratio of depsipeptide to second monomer (e.g., ε-caprolactone, polyethylene glycol macromer)) that is configured to deliver a predetermined bioactive agent dosage of 5 μg/hr or greater, such as 10 μg/hr or greater, such as 20 μg/hr or greater, such as 25 μg/hr or greater, such as 30 μg/hr or greater, such as 35 μg/hr or greater, such as 45 μg/hr or greater, such as 50 μg/hr or greater and including 60 μg/hr or greater. In certain embodiments, the subject crosslinked copolymers may be configured to deliver a predetermined bioactive agent dosage ranging from 20 to 75 μg/hr, such as 21 to 70 μg/hr, such as 22 to 65 μg/hr, such as 23 to 60 μg/hr, such as 24 to 55 μg/hr, such as 25 to 50 μg/hr and including 28 to 48 μg/hr.

For example, depending on the size of the crosslinked copolymer, the peak flux of bioactive agent delivered may vary, such as 0.5 μg/cm²/hr or greater, such as 0.6 μg/cm²/hr or greater, such as 0.65 μg/cm²/hr or greater, such as 0.75 μg/cm²/hr, such as 0.9 μg/cm²/hr, such as 1.0 μg/cm²/hr or greater, such as 1.5 μg/cm²/hr or greater, such as 1.75 μg/cm²/hr or greater and including peak flux of 2.0 μg/cm²/hr or greater.

Crosslinked copolymers of interest may also be configured to deliver bioactive agent at a substantially linear rate over a predetermined dosage interval (e.g., 4 weeks or longer). By “substantially linearly” is meant that the cumulative amount of bioactive agent released increases at a substantially constant rate (i.e., defined by first-order kinetics). As such, the change in rate of cumulatively delivered bioactive agent increases or decreases by 10% or less at any given time, such as 8% or less, such as 7% or less, such as 6% or less, such as 5% or less, such as 3% or less, such as 2.5% or less, such as 2% or less, and including 1% or less.

In other embodiments, crosslinked polycopolymers of interest may be configured to deliver an average cumulative amount of bioactive agent of 5 μg/cm² or greater over an extended period of time. By “cumulative amount” is meant the total quantity of bioactive agent delivered by the crosslinked copolymer. In these embodiments, crosslinked copolymers may be configured to deliver an average cumulative amount of bioactive agent may be 25 μg/cm² or greater, such as 50 μg/cm² or greater, such as 75 μg/cm² or greater over a 4 week delivery interval, such as 100 μg/cm² or greater, such as 125 μg/cm² or greater, such as 150 μg/cm² or greater and including 200 μg/cm² over a predetermined delivery interval.

In yet other embodiments, the subject crosslinked copolymers are configured to deliver a target dosage of bioactive agent, such as for example as characterized by total bioactive agent exposure or by average daily bioactive agent exposure. The term “target dosage” is meant the amount of bioactive agent which is delivered to the subject and may vary depending on the physicochemical properties (e.g., swelling behavior, crosslink density), mechanical properties (e.g, compressive modulus) and degradation rates of the crosslinked copolymer as well as the site of application. For example, the target dosage of bioactive agent may be 0.01 mg/day or greater, such as 0.04 mg/day or greater, such as 0.5 mg/day or greater over a 4 week dosage interval, such as 1.0 mg/day or greater, such as 2 mg/day or greater, such as 5 mg/day or greater and including 10 mg/day over a 4 week dosage interval.

Therefore, the dosage of bioactive agent delivered using the subject crosslinked copolymers of interest may vary, ranging from about 0.01 mg/kg to 500 mg/kg per day, such as from 0.01 mg/kg to 400 mg/kg per day, such as 0.01 mg/kg to 200 mg/kg per day, such as 0.1 mg/kg to 100 mg/kg per day, such as 0.01 mg/kg to 10 mg/kg per day, such as 0.01 mg/kg to 2 mg/kg per day, including 0.02 mg/kg to 2 mg/kg per day. In other embodiments, the dosage may range from 0.01 to 100 mg/kg four times per day (QID), such as 0.01 to 50 mg/kg QID, such as 0.01 mg/kg to 10 mg/kg QID, such as 0.01 mg/kg to 2 mg/kg QID, such as 0.01 to 0.2 mg/kg QID, depending on the dosage protocol as desired. In other embodiments, the dosage may range from 0.01 mg/kg to 50 mg/kg three times per day (TID), such as 0.01 mg/kg to 10 mg/kg TID, such as 0.01 mg/kg to 2 mg/kg TID, and including as 0.01 mg/kg to 0.2 mg/kg TID. In yet other embodiments, the dosage may range from 0.01 mg/kg to 100 mg/kg two times per day (BID), such as 0.01 mg/kg to 10 mg/kg BID, such as 0.01 mg/kg to 2 mg/kg BID, including 0.01 mg/kg to 0.2 mg/kg BID.

In some embodiments, the subject crosslinked copolymers are configured for implantation in a subject. Crosslinked copolymers of interest can be planar or take a three-dimensional shape. For example, the crosslinked copolymer may be conical, triangular, in the shape of a half circle, square, rectangle or other suitable shape as desired. The size of the subject crosslinked copolymers may vary as desired. In some instances, where the crosslinked copolymers are planar, the surface area may range from 0.1 to 5 cm², such as 0.5 to 5 cm², such as 1.0 to 5 cm², such as 1.5 to 4.5 cm², such as 2.0 to 4 cm², such as 2.5 to 3.5 cm², and including 2 to 3 cm². In other instances, where the crosslinked copolymers are three-dimensional, the size may range from 0.1 to 5 cm³, such as 0.5 to 5 cm³, such as 1.0 to 5 cm³, such as 1.5 to 4.5 cm³, such as 2.0 to 4 cm³, such as 2.5 to 3.5 cm³, and including 2 to 3 cm³.

### Methods for Using Crosslinked Polydepsipeptide Copolymers to Deliver One or More Bioactive Agents

As summarized above, aspects of the invention also include methods for using the subject crosslinked copolymers to deliver one or more bioactive agents to a subject. Accordingly, crosslinked copolymer compositions having one or more bioactive agents may be administered to a subject at a target location in a manner sufficient to deliver the bioactive agent to the subject. Crosslinked copolymer compositions may be applied to any target location as desired, such as for example, implanting into or on the surface of bone, beneath the skin, into or on the surface of muscle tissue, into or on the surface of a joint, in a skeletal cavity, into or on the surface of one or more teeth, as well topically, like for example on the skin of the arms, legs, buttocks, abdomen, back, neck, scrotum, vagina, face, behind the ear, buccally as well as sublingually. Likewise, the subject crosslinked copolymers may also be used to coat (as one or more layers) an implant, such as an osteograft or devices (stents, drug delivery devices) which may be implanted at the sites of administration noted above. As such, aspects according to certain embodiments include one or more bioactive agents adsorbed or absorbed within a crosslinked copolymer or within a crosslinkable copolymer precursor which are configured to deliver the bioactive agent to the subject. In other embodiments, the subject crosslinked copolymers and copolymer precursors may be employed as a membrane repair structure, such as a bone hemostat.

As discussed above, suitable bioactive agents according to certain embodiments include, but are not limited to, interferon, integrin binding sequences, interleukin, erythropoietin, granulocyte-colony stimulating factor (GCSF), stem cell factor (SCI:), leptin (OB protein), interferon (alpha, beta, gamma), antibiotics such as ciprofloxacin, amoxycillin, lactobacillus, cefotaxime, levofloxacin, cefepime, mebendazole, ampicillin, lactobacillus, cloxacillin, norfloxacin, tinidazole, cefpodoxime, proxctil, azithromycin, gatifloxacin, roxithromycin, cephalosporin, anti-thrombogenics, aspirin, ticlopidine, sulfinpyrazone, heparin, warfarin, growth factors, differentiation factors, hepatocyte stimulating factor, plasmacytoma growth factor, glial derived neurotrophic factor (GDNF), neurotrophic factor 3 (NT3), fibroblast growth factor (FGF), transforming growth factor (TGF), platelet transforming growth factor, milk growth factor, endothelial growth factors, endothelial cell-derived growth factors (ECDGF), alpha-endothelial growth factors, beta-endothelial growth factor, neurotrophic growth factor, nerve growth factor (NGF), vascular endothelial growth factor (VEGF), 4-1 BB receptor (4-IBBR), TRAIL (TNF-related apoptosis inducing ligand), artemin (GFRalpha3-RET ligand), BCA-I (B cell-attracting chemokinel), B lymphocyte chemoattractant (BLC), B cell maturation protein (BCMA), brain-derived neurotrophic factor (BDNF), bone growth factor such as osteoprotegerin (OPG), bone-derived growth factor, thrombopoietin, megakaryocyte derived growth factor (MDGF), keratinocyte growth factor (KGF), platelet-derived growth factor (PDGF), ciliary neurotrophic factor (CNTF), neurotrophin 4 (NT4), granulocyte colony-stimulating factor (GCSF), macrophage colony-stimulating factor (mCSF), bone morphogenetic protein 2 (BMP2), BRAK, C-IO, Cardiotrophin 1 (CT1), CCR8, anti-inflammatory: paracetamol, salsalate, diflunisal, mefenamic acid, diclofenac, piroxicam, ketoprofen, dipyrone, acetylsalicylic acid, anti-cancer drugs such as aliteretinoin, altertamine, anastrozole, azathioprine, bicalutarnide, busulfan, capecitabine, carboplatin, cisplatin, cyclophosphamide, cytarabine, doxorubicin, epirubicin, etoposide, exemestane, vincristine, vinorelbine, hormones, thyroid stimulating hormone (TSH), sex hormone binding globulin (SHBG), prolactin, luteotropic hormone (LTH), lactogenic hormone, parathyroid hormone (PTH), melanin concentrating hormone (MCH), luteinizing hormone (LHb), growth hormone (HGH), follicle stimulating hormone (FSHb), haloperidol, indomethacin, doxorubicin, epirubicin, amphotericin B, Taxol, cyclophosphamide, cisplatin, methotrexate, pyrene, amphotericin B, anti-dyskinesia agents, Alzheimer vaccine, antiparkinson agents, ions, edetic acid, nutrients, glucocorticoids, heparin, anticoagulation agents, antivirus agents, anti-HIV agents, polyamine, histamine and derivatives thereof, cystineamine and derivatives thereof, diphenhydramine and derivatives, orphenadrine and derivatives, muscarinic antagonist, phenoxybenzamine and derivatives thereof, protein A, streptavidin, amino acid, beta-galactosidase, methylene blue, protein kinases, beta-amyloid, lipopolysaccharides, eukaryotic initiation factor-4G, tumor necrosis factor (TNF), tumor necrosis factor-binding protein (TNF-bp), interleukin-1 (to 18) receptor antagonist (IL-Ira), granulocyte macrophage colony stimulating factor (GM-CSF), novel erythropoiesis stimulating protein (NESP), thrombopoietin, tissue plasminogen activator (TPA), urokinase, streptokinase, kallikrein, insulin, steroid, acetaminophen, analgesics, antitumor preparations, anti-cancer preparations, anti-proliferative preparations or pro-apoptotic preparations, among other types of bioactive agents.

In some embodiments, bioactive agents include small molecule active agents. For example, suitable small molecule active agents include, but are not limited to, antipyretics, analgesics, antiseptics, anti-depressants, mood stabilizers, hormone replacements, stimulants, tranquilizers, psychedelics, hypnotics, anaesthetics, antipsychotics, antidepressants (including tricyclic antidepressants, monoamine oxidase inhibitors, lithium salts, and selective serotonin reuptake inhibitors (SSRIs)), antiemetics, anticonvulsants/antiepileptics, anxiolytics, barbiturates, movement disorder (e.g., Parkinson's disease) drugs, hemostatics, stimulants (including amphetamines), benzodiazepines, cyclopyrrolones, dopamine antagonists, antihistamines, cholinergics, anticholinergics, emetics, cannabinoids, and 5-HT (serotonin) antagonists, or any combination, pharmaceutically acceptable salt or prodrug thereof.

In certain embodiments, the one or more absorbed bioactive agents is a compound selected from the group consisting of chemotactic agents, cell attachment mediators, integrin binding sequences, epidermal growth factor (EGF), hepatocyte growth factor (HGF), vascular endothelial growth factors (VEGF), fibroblast growth factors, platelet derived growth factors (PDGF), insulin-like growth factor, transforming growth factors (TGF), human amniotic mesenchymal stem cells (hAMSCs), parathyroid hormone, parathyroid hormone related peptide, bone morphogenetic proteins (BMP), BMP-2, BMP-4, BMP-6, BMP-7, BMP-12, BMP-13, BMP-14, transcription factors, growth differentiation factor (GDF), GDF5, GDF6, GDF8, recombinant human growth factors, cartilage-derived morphogenetic proteins (CDMP), CDMP-1, CDMP-2 and CDMP-3.

In certain embodiments, bioactive agents include cell-containing bioactive agents, such as human or non-human endothelial cells, nerve cells, mesenchymal stem cells, pluripotent stem cells, embryonic stem cells, induced pluripotent stem cells, and other tissue cells such as bone, muscle, tendon, heart, liver, kidney, among other human and non-human tissues. In some embodiments, the bioactive agent includes human umbilical vein endothelial cells (HUVEC). In other embodiments, bioactive agents include cell-containing bioactive agents such as mesenchymal stem cells (MSC), such as human bone marrow mesenchymal stem cells (hMSC). The amount of bioactive agent delivered to the subject will depend on the duration of delivery, site of application as well as the composition of the crosslinked copolymer (e.g., crosslink density, depsipeptide to second monomer (e.g., ε-caprolactone, polyethylene glycol macromer) ratio). In some embodiments, the amount of bioactive agent delivered by the crosslinked copolymer is 0.0001 μg or greater, such as 0.001 μg or greater, such as 0.01 μg or greater, such as 0.1 μg or greater, such as 1 μg or greater, such as 10 μg or greater, such as 25 μg or greater, such as 50 μg or greater, such as 100 μg or greater such as 500 μg or greater, such as 1000 μg or greater such as 5000 μg or greater and including 10,000 μg or greater.

In describing methods of the present disclosure, the term “subject” is meant the person or organism to which the crosslinked copolymers are applied and maintained in contact. As such, subjects of the invention may include but are not limited to mammals, e.g., humans and other primates, such as chimpanzees and other apes and monkey species; and the like, where in certain embodiments the subject are humans.

In practicing methods according to certain embodiments, one or more of the subject crosslinked copolymers (as described in detail above) having one or more bioactive agents is placed (either by the subject itself or by a caregiver) at the target site and maintained in contact with the subject for an amount of time sufficient to deliver the bioactive agent to the subject.

As described above, depending on the structure of the specific crosslinked copolymer employed (e.g., depsipeptide to second monomer (e.g., ε-caprolactone, polyethylene glycol macromer) ratio, crosslink density, etc.), release of the bioactive agents may vary. For example, crosslinked copolymers may be configured for sustained release of one or more bioactive agent, so as to provide for constant and continuous delivery over the entire time the subject crosslinked copolymers are maintained in contact with the subject, such as over the course of 1 day or longer, such as 2 days or longer, such as 5 days or longer, such as 10 days or longer, such as 15 days or longer, such as 30 days or longer and including 100 days or longer. In other instances crosslinked copolymers may be configured for pulsatile release of one or more bioactive agent, so as to provide for incremental administration, such as every 1 hour, such as every 2 hours, such as every 5 hours, such as every 12 hours, such as every 24 hours, such as every 36 hours, such as every 48 hours, such as every 72 hours, such as every 96 hours, such as every 120 hours, such as every 144 hours and including every 168 hours. In other instances, the subject crosslinked copolymers are configured to deliver one or more bioactive agents after a certain percentage of the subject copolymer has degraded. For example, an amount of the bioactive agent may be delivered after every 10% of the crosslinks have degraded, such as after every 15% of the crosslinks of have degraded, such as after every 20% of the crosslinks have degraded, such as after every 25% of the crosslinks of have degraded, such as after every 30% of the crosslinks have degraded and including after every 33% of the crosslinks have degraded. In yet other instances, crosslinked copolymers of interest may be configured to release a large amount of one or more bioactive agents immediately upon contact with the site of administration (such as to provide an acute reduction in pain), such as for example 50% or more, such as 60% or more, such as 70% or more and including 90% or more of the bioactive agent is released immediately upon contact with the site of administration.

In yet other instances, crosslinked copolymers of the present disclosure may be configured to release one or more bioactive agents at a predetermined rate, such as at a substantially zero-order release rate, such as at a substantially first-order release rate or at a substantially second-order release rate.

In certain embodiments, methods include providing a release profile of one or more bioactive agents having:

a first period where the bioactive agent is released from the crosslinked copolymer at a first predetermined rate; and

a second period where the bioactive agent is released from the crosslinked copolymer at a second predetermined rate.

For example, in these embodiments, the first period may be a duration ranging from 0.5 hours to 72 hours from initiation of administration of the crosslinked copolymer, such as from 1 hour to 60 hours, such as from 2 hours to 48 hours, such as from 3 hours to 36 hours, such as from 4 hours to 30 hours and including from 5 hours to 24 hours from the initiation of administration. The second period may be a duration ranging from 0.5 hours to 336 hours from the administration time of the crosslinked copolymer, such as from 1 hour to 312 hours, such as from 2 hours to 288 hours, such as from 3 hours to 264 hours, such as from 4 hours to 240 hours, such as from 5 hours to 216 hours and including from 6 hours to 192 hours from the initiation of administration.

As discussed above, the rate of release during each respective period may vary depending on the structure of the crosslinked copolymers. In some embodiments, the first predetermined rate may be a substantially zero-order release rate. In other embodiments the first predetermined rate may be a substantially first-order release rate. In yet other embodiments the first predetermined rate may be a second-order release rate. Similarly, the second predetermined rate may be a substantially zero-order release rate, a substantially first-order release rate or a substantially second-order release rate.

In certain embodiments, methods include delivering bioactive agent from crosslinked copolymers at a substantially first order release rate during a first predetermined duration followed by delivering bioactive agent from crosslinked copolymers at a substantially zero order release rate during a second predetermined duration. In other embodiments, the release profile includes a first period having a substantially second order release rate followed by a second period having a substantially first order release rate. In yet other embodiments, the release profile includes a first period having a substantially second order release rate followed by a second period having a substantially zero order release rate.

In these embodiments, the amount of bioactive agent released during each respective period may vary. In some instances, the subject crosslinked copolymers are configured to release between 10% and 75% of the total amount of bioactive agent during the first period, such as between 15% and 70% of the total amount of bioactive agent, such as between 20% and 60% of the total amount of bioactive agent, such as between 25% and 50% of the total amount of bioactive agent and including between 30% and 35% of the total bioactive agent during the first period. In these instances, the subject crosslinked copolymers may be configured to release between 10% and 75% of the total amount of bioactive agent during the second period, such as between 15% and 70% of the total amount of bioactive agent, such as between 20% and 60% of the total amount of bioactive agent, such as between 25% and 50% of the total amount of bioactive agent and including between 30% and 35% of the total bioactive agent during the second period.

In some embodiments, administration of crosslinked copolymers having one or more bioactive agents includes one or more dosage intervals. By “dosage interval” is meant the duration of a single administration of applying and maintaining one or more of the subject crosslinked copolymers with bioactive agent in contact with the subject. In other words, a dosage interval begins with applying a crosslinked copolymer to the target location of the subject and ends with the removal of the crosslinked copolymer from contact with the subject, either by actively removing the crosslinked copolymer or by the complete degradation of the crosslinked copolymer at the target site. As such, a dosage interval is the time that one or more bioactive agents is being delivered to the subject and may last about 0.5 hours or longer, such as about 1 hour or longer, such as about 2 hours or longer, such as about 4 hours or longer, such as about 12 hours or longer, such as about 24 hours or longer, such as about 2 days or longer, such as about 7 days or longer, such as 14 days or longer, such as 28 days or longer, such as 70 days or longer and including 100 days or longer. Treatment regimens may include one or more dosage intervals, as desired, such as two or more dosage intervals, such as five or more dosage intervals, including ten or more dosage interval.

In certain embodiments, methods of the invention also include monitoring the delivery of the bioactive agent to the subject. In some embodiments, delivery of the bioactive agent may be monitored throughout the entire time the crosslinked copolymer is maintained in contact with the subject, such by real-time data collection. In other instances, the delivery of the bioactive agent is monitored while maintaining the crosslinked copolymer in contact with the subject by collecting data at regular intervals, e.g., collecting data every 0.25 hours, every 0.5 hours, every 1 hour, every 2 hours, every 4 hours, every 12 hours, every 24 hours, including every 72 hours, or some other interval. In yet other instances, delivery of the bioactive agent is monitored by collecting data according to a particular time schedule after administering the crosslinked copolymer to the subject. For instance, delivery of the bioactive agent may be monitored 6 hours after administering the bioactive agent-containing crosslinked copolymers to the subject, such as 12 hours, such as 24 hours, such as 3, such as 7 days, such as 14 days and including monitoring delivery of the bioactive agent 30 days after administering the bioactive agent-containing crosslinked copolymer to the subject.

As discussed above, aspects of the invention also include methods for treating a subject by applying one or more of crosslinked copolymers described above to the subject. In some embodiments, methods include applying a crosslinked copolymer to the subject and maintaining the crosslinked copolymer in contact with the subject in a manner sufficient to treat the subject. As discussed above, crosslinked copolymers of interest may be applied to any suitable application site in need of treatment, including by not limited to the bones, heart, liver, kidneys, bladder, in the mouth such as buccally and sublingually and within the nose, throat and ears.

In certain embodiments, methods include applying one or more bioactive-containing crosslinked copolymers and maintaining the crosslinked copolymer in contact with the subject in a manner sufficient to deliver a predetermined dosage of bioactive agent to the application site. For example, the crosslinked copolymer may be contacted and maintained in contact with an application site in a manner sufficient to deliver a predetermined bioactive agent dosage of 5 μg/hr or greater, such as 10 μg/hr or greater, such as 20 μg/hr or greater, such as 25 μg/hr or greater, such as 30 μg/hr or greater, such as 35 μg/hr or greater, such as 45 μg/hr or greater, such as 50 μg/hr or greater and including 60 μg/hr or greater. In certain embodiments, the crosslinked copolymer may be contacted and maintained in contact with an application in a manner sufficient to deliver a predetermined bioactive agent dosage ranging from 1 to 75 μg/hr, such as 2 to 70 μg/hr, such as 5 to 65 μg/hr, such as 10 to 60 μg/hr, such as 15 to 55 μg/hr, such as 20 to 50 ng/hr and including 25 to 45 μg/hr.

In other embodiments, methods include applying one or more of the bioactive agent-containing crosslinked copolymers and maintaining the crosslinked copolymers in contact with the subject in a manner sufficient to deliver bioactive agent to the application site of the subject at a rate of 0.5 ng/cm²/hr or greater, such as 0.6 ng/cm²/hr or greater, such as 0.65 ng/cm²/hr or greater, such as 0.75 ng/cm²/hr, such as 0.9 ng/cm²/hr, such as 1.0 ng/cm²/hr or greater, such as 1.5 ng/cm²/hr or greater, such as 1.75 ng/cm²/hr or greater and including 2.0 ng/cm²/hr or greater.

Methods may also include applying one or more bioactive agent-containing crosslinked copolymers and maintaining the crosslinked copolymer in contact with the subject in a manner sufficient to deliver an average cumulative amount of bioactive agent of 5 ng/cm² or greater over an extended period of time. In these embodiments, crosslinked copolymers of interest may be configured to deliver an average cumulative amount of bioactive agent may be 25 ng/cm² or greater, such as 50 ng/cm² or greater, such as 75 ng/cm² or greater over a 4 week delivery interval, such as 100 ng/cm² or greater, such as 125 ng/cm² or greater, such as 150 ng/cm² or greater and including 200 ng/cm² over a predetermined delivery interval.

In yet other embodiments, methods may include applying one or more bioactive agent-containing crosslinked copolymers and maintaining the crosslinked copolymers in contact with the subject in a manner sufficient to deliver a target dosage of bioactive agent, such as for example as characterized by total bioactive agent exposure or by average daily bioactive agent exposure. For example, the target dosage of bioactive agent delivered by subject methods may be 0.01 mg/day or greater, such as 0.04 mg/day or greater, such as 0.5 mg/day or greater over a 4 week dosage interval, such as 1.0 mg/day or greater, such as 2 mg/day or greater, such as 5 mg/day or greater and including 10 mg/day over a 4 week dosage interval.

### Kits

Also provided are kits, where kits at least include one or more, e.g., a plurality of, the subject crosslinked copolymers, as described above. In certain embodiments, compositions having an amount of one or more bioactive agents in combination with the subject crosslinked copolymers may be provided as packaged kit.

Kits may further include other components for practicing the subject methods, such as administration devices (e.g., syringes) or fluids to rinse the administration site before applying the subject crosslinked copolymer hydrogels. Kits may also include gauze pads or other devices for cleaning the target site, etc. which may find use in practicing the subject methods.

In addition, kits may also include instructions for how to use the subject crosslinked copolymers, where the instructions may include information about to how administer the crosslinked copolymers, dosing schedules, and record keeping devices for executing a treatment regimen. The instructions are recorded on a suitable recording medium. For example, the instructions may be printed on a substrate, such as paper or plastic, etc. As such, the instructions may be present in the kits as a package insert, in the labeling of the container of the kit or components thereof (i.e. associated with the packaging or subpackaging) etc. In other embodiments, the instructions are present as an electronic storage data file present on a suitable computer readable storage medium, e.g. CD-ROM, diskette, etc. In yet other embodiments, the actual instructions are not present in the kit, but means for obtaining the instructions from a remote source, e.g. via the internet, are provided. An example of this embodiment is a kit that includes a web address where the instructions can be viewed and/or from which the instructions can be downloaded. As with the instructions, the protocol for obtaining the instructions may be recorded on a suitable substrate.

### Utility

Crosslinked copolymers and methods for using the subject crosslinked copolymer find use in delivering an active agent or to repair a physiological structure in a subject (e.g., bone, muscle, ligament, cartilage) using a biocompatible, innocuous and biodegradable composition. In addition, crosslinked copolymers of interest also find use in applications for delivering a bioactive agent through a tunable biodegradable delivery vehicle providing site specific delivery of the bioactive agent.

In certain examples, crosslinked copolymers are used to deliver growth factors to bone, cartilage, muscle tissue such as to treat ailment where site-specific delivery can be made more effective by a cytocompatible, non-toxic and non-irritable delivery vehicle. The term “treatment” is used herein in it conventional sense to mean at least an amelioration of the symptoms associated with the condition afflicting the subject, where amelioration is used in a broad sense to refer to at least a reduction in the magnitude of a parameter, e.g., symptom, associated with the condition being treated. Treatment also includes situations where the pathological condition, or at least symptoms associated therewith, are completely inhibited, e.g., prevented from happening, or stopped, e.g., terminated, such that the subject no longer suffers from the condition, or at least the symptoms that characterize the condition.

### EXPERIMENTAL

### Example 1

### Crosslinked Poly(Depsipeptide-ε-Caprolactone) Copolymers

Photocrosslinkable copolymers of a poly(ester amide) based on ε-caprolactone, amino acids and methacrylic anhydride were synthesized and their chemical, thermal, and degradation properties as well as in vitro cytocompatibility was examined. The resulting photocrosslinkable copolymers were used to fabricate mathematically designed tissue engineering scaffolds by 3-D printing, and the mechanical properties of scaffolds were characterized.

### Materials and Methods

Materials

The ε-caprolactone monomer (CL) (Solvay Chemicals) was distilled under reduced pressure before polymerization. L-alanine (ICN Biomedicals), chloroacetyl chloride (Fluka), tin(II) 2-ethylhexanoate (Sn(Oct)₂), trimethylolpropane, methacrylic anhydride, and triethylamine (Sigma-Aldrich) were used as received. DL-camphorquinone (CQ, Acros Organics) and ethyl-4-dimethylaminobenzoate (EDMAB, TCI) were used as received. Lucirin® TPO-L and Orasol® Orange G were obtained from BASF. Phosphate buffered saline (PBS) was from Life Technologies. Mouse pluripotent mesenchymal cells C3H10T1/2, Clone 826 were obtained from ATCC (ATCC® CCL-226™), and immortalized human-umbilical-vein endothelial cells (HUVECs) were a generous gift from the late Dr. J. Folkman, Children's Hospital, Boston. Dulbecco's modified Eagle's medium (DMEM), fetal bovine serum (FBS), antibiotic solution, and trypsin-EDTA solution were purchased from Invitrogen Co. EBM™ endothelial basal medium containing a EGM™ Single Quots™ kit were purchased from Lonza Inc. 3-(4,5-dimethyl-2-thiazolyl)-2,5-diphenyl-2H-tetrazolium bromide (MTT), p-nitrophenyl phosphate liquid substrate system, and Triton™ X-100 were purchased from Sigma-Aldrich, and Pico Green® dsDNA assay kit was from Invitrogen Co.

### Synthesis of a 3-Methyl-Morpholine-2,5-Dione Monomer

Cyclic 3-methyl-morpholine-2,5-dione (MMD) monomers were synthesized in a two-step reaction, starting with the reaction of an α-amino acid with chloroacetyl chloride followed by cyclization of the resulting intermediate chloroacetyl amino acid. (Scheme 1A) First, L-alanine (17.5 g, 0.20 mol) was dissolved in diethyl ether/water (1:1 v/v) mixture (75 mL) in a salt/ice bath (−5° C.), and the solution was mixed with aqueous 4 M NaOH solution (50 mL). Chloroacetyl chloride (25 g, 0.22 mol) was dissolved in diethyl ether (25 mL) and added dropwise to the amino acid solution simultaneously with aqueous 4 M NaOH solution (75 mL) over a 20 min period under vigorous stirring. The pH of the mixture was held at 11 during the reaction. After the addition was complete, the aqueous layer was acidified to pH 1 with aqueous 4 M HCl and extracted three times with ethyl acetate. The combined organic layers were washed three times with saturated NaCl solution, dried with MgSO₄, and concentrated under vacuum. Yield 81%; mp 97° C.; ¹H NMR (D₂O) 6=1.33-1.34 (d, 3H, CH₃), 4.05 (s, 2H, CH₂), 4.28-4.30 (q, 1H, CH).

Before beginning the cyclization step, a carefully dried flask and dropping funnel were evacuated and flushed ten times with dry nitrogen. The white crystals of N-chloroacetyl-L-alanine (10 g, 0.06 mol) were dissolved in dry N,N-dimethylformamide (DMF, 50 mL) and added dropwise to a mixture of triethylamine (6.13 g, 0.06 mol) in DMF (200 mL) under vigorous stirring. The reaction was run at 90° C. for 8 h under a nitrogen atmosphere. After the reaction was complete, the solution was kept at room temperature overnight and the crystallized triethylamine-hydrochloride salt was filtered out of the solution. The solvent was removed at 30° C. under reduced pressure, and white MMD crystals were obtained after precipitation in chloroform and three recrystallizations in diethyl ether. Yield 52%; mp 151° C.; ¹H NMR (D₂O) δ=1.39-1.41 (d, 3H, CH₃), 4.30-4.34 (q, 1H, CH), 4.71-4.86 (2d, 2H, CH₂)

### Synthesis of Photocrosslinkable Macromers

Photocrosslinkable copolymers of MMD and CL were synthesized by a ring-opening polymerization reaction of the monomers and further methacrylation of the resulting hydroxyl-ended oligomers. Three different hydroxyl-ended oligomers with a targeted molecular weight of 750 g/mol were synthesized, including copolymers containing 5/95 mol % of MMD/CL (PDP5) and 10/90 mol % of MMD/CL (PDP10) and a PCL homopolymer (PCL) as a reference. Monomers (see Table 1) were added to the silanized and dried flask together with a trimethylolpropane initiator and 0.02 mol % of Sn(Oct)2 as a catalyst.

TABLE 1

| | MMD | | CL | | TMP | | Maah | |
|---|---|---|---|---|---|---|---|---|
| | m | n | m | n | m | n | m | n |
| | (g) | (mol) | (g) | (mol) | (g) | (mol) | (g) | (mol) |
| PCL | 0.00 | 0.0000 | 20.00 | 0.175 | 4.36 | 0.033 | 30.04 | 0.195 |
| PDP5 | 1.12 | 0.0087 | 18.88 | 0.165 | 4.36 | 0.033 | 30.04 | 0.195 |
| PDP10 | 2.23 | 0.0173 | 17.77 | 0.156 | 4.36 | 0.033 | 30.04 | 0.195 |

The flask was evacuated and flushed several times with dry nitrogen, and the reaction was run at 120° C. for 64 h. The resulting three-armed hydroxyl-ended oligomers were functionalized with a 100 mol % excess of methacrylic anhydride at 60° C. for 24 h. After methacrylation, the resulting macromers were precipitated several times in cold hexane and dried under reduced pressure. The yield of the macromere was 96%. (Scheme 1B)

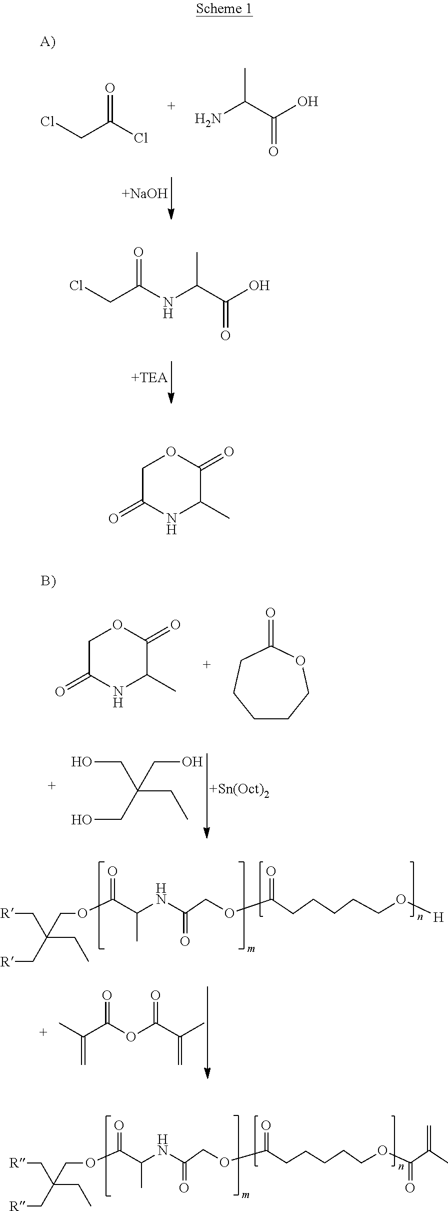

Photocrosslinking of Polymer Films

To study the photocrosslinking characteristics and in vitro degradation of the new polymers, macromers were photocrosslinked into polymer films. First, the macromers were mixed with a photoinitiator solution containing 0.5 wt % of CQ and 0.5 wt % of EDMAB in a small amount of acetone. Acetone was allowed to evaporate and the polymers were photocrosslinked with a visible light projector (Vivitek) for 2 min. Gel contents of the photocrosslinked polymers were measured by extracting the polymer samples in acetone for 24 h and drying overnight in vacuo. The gel content was obtained by dividing the dry weight of the samples after extraction by their dry weight before extraction.

Physiochemical Characterization

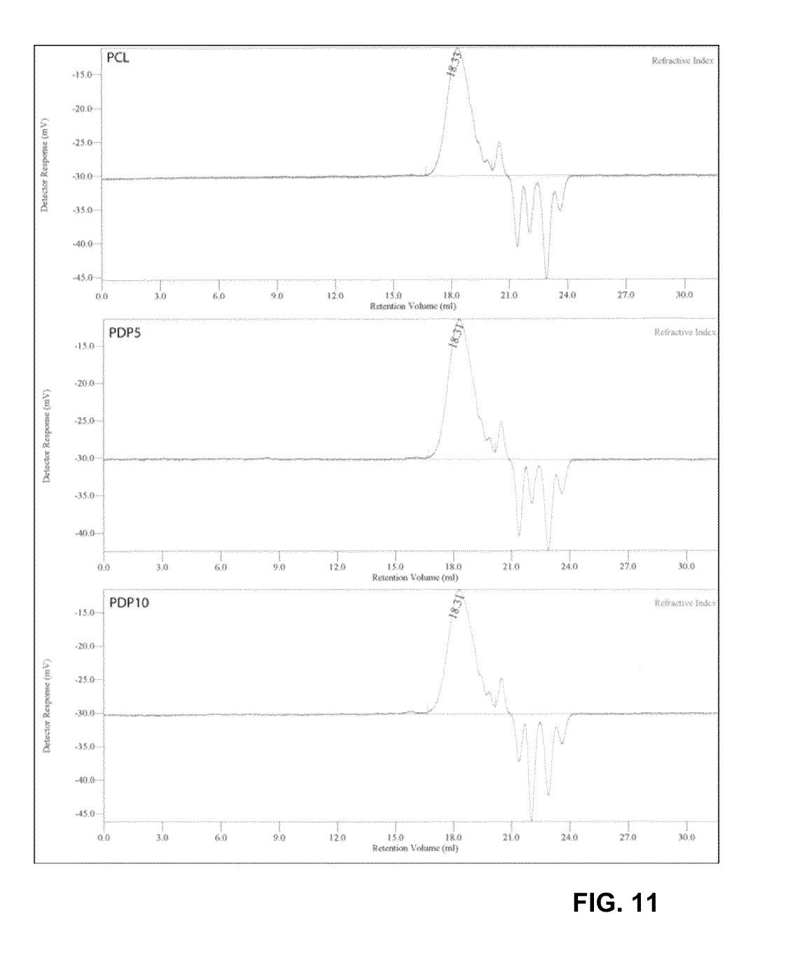

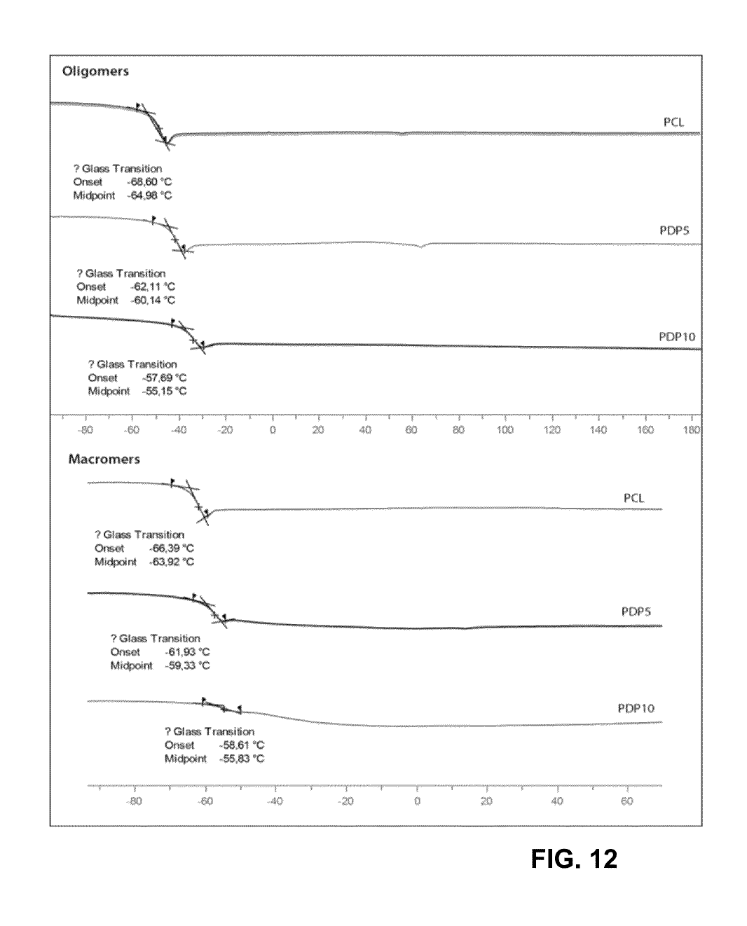

¹H NMR spectra were recorded on a Bruker Avance-III 400 MHz spectrometer. A sample was dissolved in deuterium oxide or deuterated chloroform and its spectrum was acquired in a 5-mm NMR tube at room temperature. Gel permeation chromatography (GPC) samples were dissolved in tetrahydrofuran (THF) (5 mg/mL) and the analysis was run in THF at a flow rate of 1 mL/min. The chromatograph (Vistotek) was equipped with 5 μm Waters columns (300 mm×7.7 mm) and a refractive index detector (Viscotek S3580), and the system was calibrated using monodisperse polystyrene standards (Polymer Laboratories). GPC curves of oligomers are shown in FIG. 11. Thermal properties of the oligomers were determined using a Mettler Toledo Stare DSC 821e differential scanning calorimeter (DSC). A sample was first heated from 25 to 100° C. at a rate of 20° C./min, after which the temperature was decreased to −100° C. at 10° C./min. After 2 minutes at −100° C., the sample was heated from −100 to 100° C. at a rate of 10° C./min. Melting points (Tₘ) and glass transition temperatures (Tg) of the synthesized molecules were determined from the second heating scan. The amount of peptide bonds and reacted double bonds of the macromers were determined using a Bruker Vertex 70 FTIR spectrometer with a diamond ATR. Hydrophilicity of the photocrosslinked films was characterized by contact angle measurements with deionized water. DSC curves for oligomers and macromers are shown in FIG. 12.

In Vitro Degradation

In vitro hydrolytic degradation of the photocrosslinked polymers was measured by following the mass loss of the unextracted photocrosslinked films (d=8 mm, h=0.3 mm, n=3) in an aqueous environment. The samples were put in PBS (pH 7.4), and after a predetermined time, they were removed from the media and subsequently washed with deionized water and dried for 48 h in vacuo. The media was changed every 72 h during the degradation study.

Cell Culture

C3H10T1/2 mouse mesenchymal cells on their tenth passage were cultured in basal medium consisting of DMEM with 10% FBS and 1% antibiotic solution. HUVECs were cultured in endothelial basal medium (EBM-2) with a Single Quots (EGM-2, excluding hydrocortisone) endothelial growth supplement, 10% FBS and 1% antibiotic solution. All cells were cultured under standard conditions (5% CO2, 37° C., 95% humidity). Cells were subcultured using a 0.25% trypsin-EDTA solution. Polymer samples were sterilized with three immersions in 70% ethanol and further washed three times with PBS and dried in a sterile hood.

Cytocompatibility with Human Umbilical Vein Endothelial Cells (HUVEC)

The cytotoxicity of the photocrosslinked polymers was tested by measuring the metabolic activity of HUVECs on polymer films. 76 μL of cell suspension containing 1×104 cells was added on the top of the photocrosslinked films (d=8 mm, h=0.3 mm, n=3) and on a 24-well tissue culture polystyrene (TCPS) plate as a control. After the cell seeding, the samples were incubated for 30 min, after which fresh medium was added up to 1 mL. At time points of 1, 4, and 7 days, the metabolic activity of HUVECs was measured using a colorimetric MTT assay. Polymer films without cells were used to subtract the effect of the polymer itself on the color change. At the given time points, medium was removed and 500 μL of fresh serum-free medium and 50 μL of 5 mg/mL MTT in PBS were added into the wells. After incubation for 3 h, the medium was removed and the samples were shaken in 400 μL of dimethyl sulfoxide (DMSO) for 30 min. The optical density of the dissolved formazan crystals in 100 μL of DMSO was read using a microplate reader (TECAN) at 490 nm.

Proliferation and Differentiation of Mouse Mesenchymal Cells

To study the suitability of the new polymers for bone tissue engineering, proliferation and osteogenic activity of pluripotent C3H10T1/2 cells were monitored by measuring the amount of double-stranded DNA (dsDNA) and alkaline phosphatase (ALP) specific activity of the cells on the photocrosslinked films. Cells were seeded onto the polymer films with a density of 1×104 cells in 36 μL of medium. After seeding the cells, the films were incubated for 30 min, after which medium was added up to 1 mL. After 3, 7, and 14 days of cell culturing, the films were washed twice with PBS and preserved at −80° C. After repeating a freeze/thaw cycle three consecutive times at −80° C./37° C., the samples were lysed in 500 μL of 0.2% Triton X-100 in PBS and homogenized by sonication for 30 s in an ice bath. The dsDNA content was measured using the Pico Green assay. 50 μL of the working reagent was mixed with 50 μL of the cell lysate, and after 5 min, the samples were read using a fluorescence/chemiluminescence spectrophotometer (Biotek, Flx800) at 485/528 nm excitation/emission. The obtained values were compared to the standard DNA curve. The ALP activities of the same samples were measured using a colorimetric p-nitrophenyl phosphate (p-NPP) method, which is based on the conversion of the p-NPP substrate into p-nitrophenol (p-NP) in the presence of ALP, where the conversion rate is proportional to the ALP activity. 28 50 μL of the working solution was incubated with 50 μL of the cell lysate for 45 min at 37° C., and the absorbance was read using a microplate reader (TECAN) at 405 nm. The results were compared to the standard p-NP curve.

3-D Printing of Porous Scaffolds and Characterization

Porous scaffolds were prepared using an EnvisionTEC Perfactory® Mini Multilens machine utilizing digital light processing technology. The gyroid pore architecture of the scaffolds was modeled using the free K3DSurf surface generator (k3dsurf.sourceforge.net). The stl-files were prepared using the Rhinoceros® software (McNeel). Scaffolds of 8.3 mm in diameter and 3 mm in height were built using a photocrosslinkable resin containing methacrylated macromer mixed with Lucirin® TPO-L photoinitiator (3 wt %) and Orasol Orange G dye (0.10 wt %). The layer thickness was 50 μm with an exposure time of 12 s and a light intensity of 1600 mW/dm2. A lens with a focal distance of 85 mm was used. After fabrication, any uncured macromer was removed from the scaffolds by extraction with a mixture (1:1 v/v) of acetone and isopropanol. The scaffolds were dried in vacuo until a constant weight was achieved. To visualize the scaffold surface, the samples were sputtered with a gold/palladium alloy and observed with a scanning electron microscope (SEM, FEI XL30 Sirion) at 5 kV. Mechanical properties of the photocrosslinked scaffolds were measured using an Instron 5944 mechanical tester with a 2 kN load cell. A scaffold was placed between two parallel plates and compressed with a rate of 1% strain/second using a 1 N preload.

Statistical Analysis

For a statistical analysis, samples were always used in triplicate, and the statistical significance was determined with the IBM SPSS Statistics software using a one-way ANOVA followed by Tukey's post hoc test (p<0.05).

### Results and Discussion

Synthesis of Monomers, Oligomers, and Methacrylated Macromers

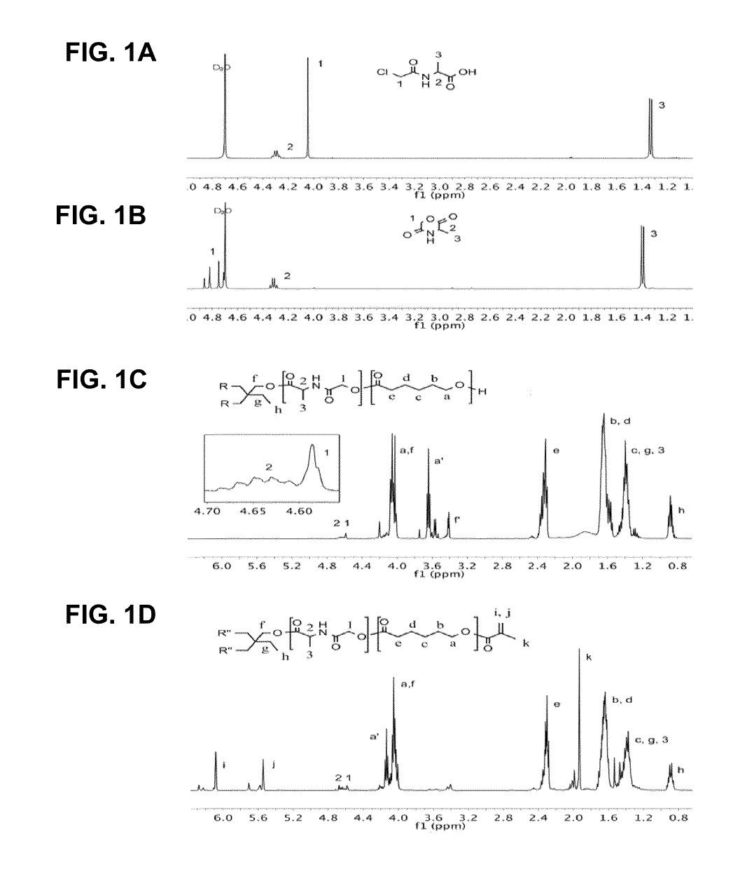

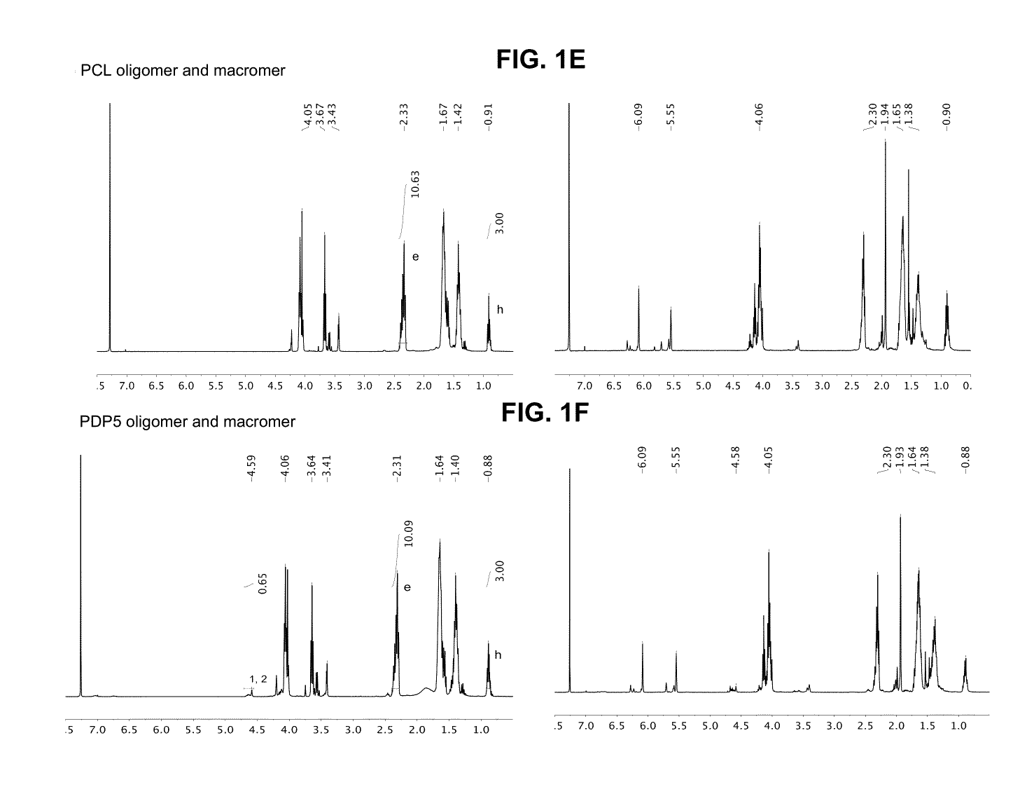

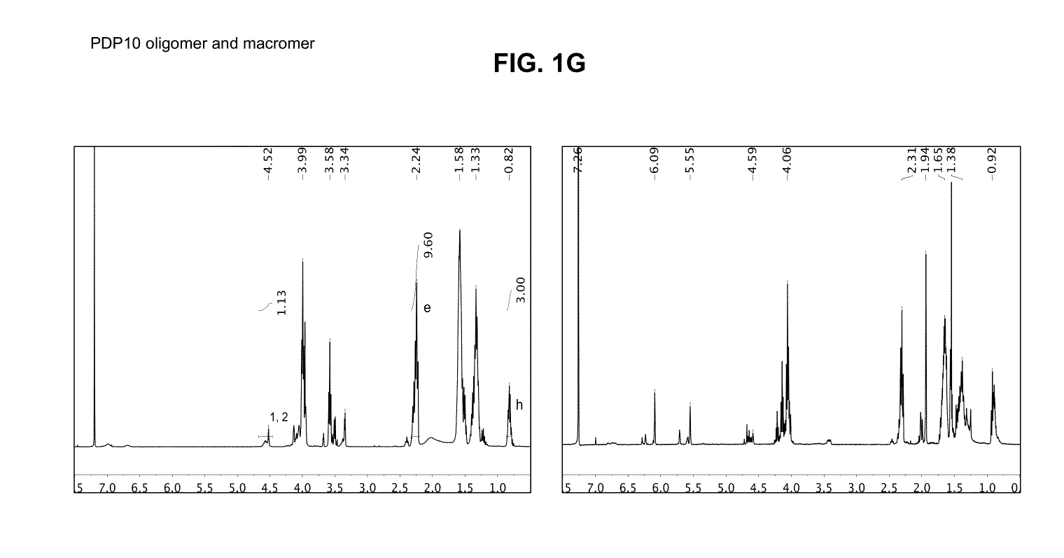

The cyclic MMD monomer was synthesized via a two-step reaction by first synthesizing chloroacetyl alanine and then cyclizing it into a MMD monomer. Tₘ of the resulting chloroacetyl alanine was 97° C. and Tₘ of MMD was 151° C. Melting points of the resulting chloroacetyl alanine and MMD were 97° C. and 151° C., respectively. These values are comparable to the values published previously, 93-96° C. for chloroacetyl alanine and 153.5-154.5° C. for MMD. The obtained MMD monomer was used to synthesize the star-shaped oligomers, which were further methacrylated to obtain photocrosslinkable macromers. The chemical structures of the synthesized materials were characterized with 1H NMR. Formation of the cyclic MMD monomer was verified when the singlet peak 1 at 4.05 ppm (FIG. 1A) disappeared and two doublet peaks 1 at 4.70-4.86 ppm appeared (FIG. 1B). The ROP of monomers resulted in peaks a-h and 1-3, which are attributed to protons of the star-shaped oligomer as assigned in FIG. 1C. No monomers were seen in the resulting ¹H NMR spectra, whereas a small peak f′ attributed to the unreacted arms of TMP initiator was detected. Further end-capping the oligomer with methacrylic anhydride resulted in the peaks i, j, and k which are attributed to the methacrylate end-groups of the resulting macromer and the peak a′ which is attributed to the protons a of the last CL unit preceding the methacrylate group (FIG. 1D). The methacrylation was continued until no peak a′ of the oligomer, attributed to the protons next to the hydroxyl end-groups, was seen in the ¹H NMR spectra, indicating the degree of methacrylation to be close to 100%. The purity of the resulting photocrosslinkable macromers was ensured by precipitating the macromers with hexane until the excess of methacrylic anhydride peaks at around 2.04, 5.85, and 6.26 ppm were removed. The integrals of the small peaks observed near the peaks i, j, and k in FIG. 1D were not decreased by purification and are attributed to the methacrylate end-groups of the previously unreacted initiator arms that are typical to low molecular weight star-shaped polymers. The molecular weights of the oligomers were calculated using the ¹H NMR integration. The average number of MMD and CL units per oligomer was determined by comparing the integral of the peak h attributed to the TMP initiator with the integrals of the peaks 1 and 2 attributed to the MMD units and the peak e attributed to the CL units. The increase in the amount of depsipeptide was seen as an increase in the integral of the peaks 1 and 2 and as a decrease in the integral of the peak e. Table 2 shows the calculated molecular weights of the PDP and PCL blocks of the oligomers and their percentages and the total molecular weights including the TMP initiator. The molecular weight of the oligomer slightly decreased when the amount of depsipeptide increased, suggesting that the MMD monomers had a slightly lower reactivity than the CL monomers. Table 2 shows also the molecular weights and polydispersion indexes (PDI) of the oligomers measured by GPC. Due to a relative nature of the GPC calibration, the values obtained from GPC were consistently higher than the ones calculated from ¹H NMR. The similarity of the molecular weights of all the oligomers and their narrow molecular weight distributions indicated the successful ROP of all the star-shaped oligomers regardless of the amount of MMD monomer in the synthesis.

TABLE 2

| | Mₙ^{a} | Mₙ^{a} | Mₙ^{a} ratio | Mₙ^{a} | | |
|---|---|---|---|---|---|---|
| Name | PDP | PCL | (%/%) | total | Mₙ^{b} | PDI^{b} |
| PCL | 0 | 607 | 0/100 | 741 | 1325 | 1.25 |
| PDP5 | 28 | 576 | 5/95 | 738 | 1310 | 1.29 |
| PDP10 | 49 | 548 | 8/92 | 731 | 1303 | 1.31 |

^{a}Calculated from ¹H NMR.
^{b}Measured by GPC.

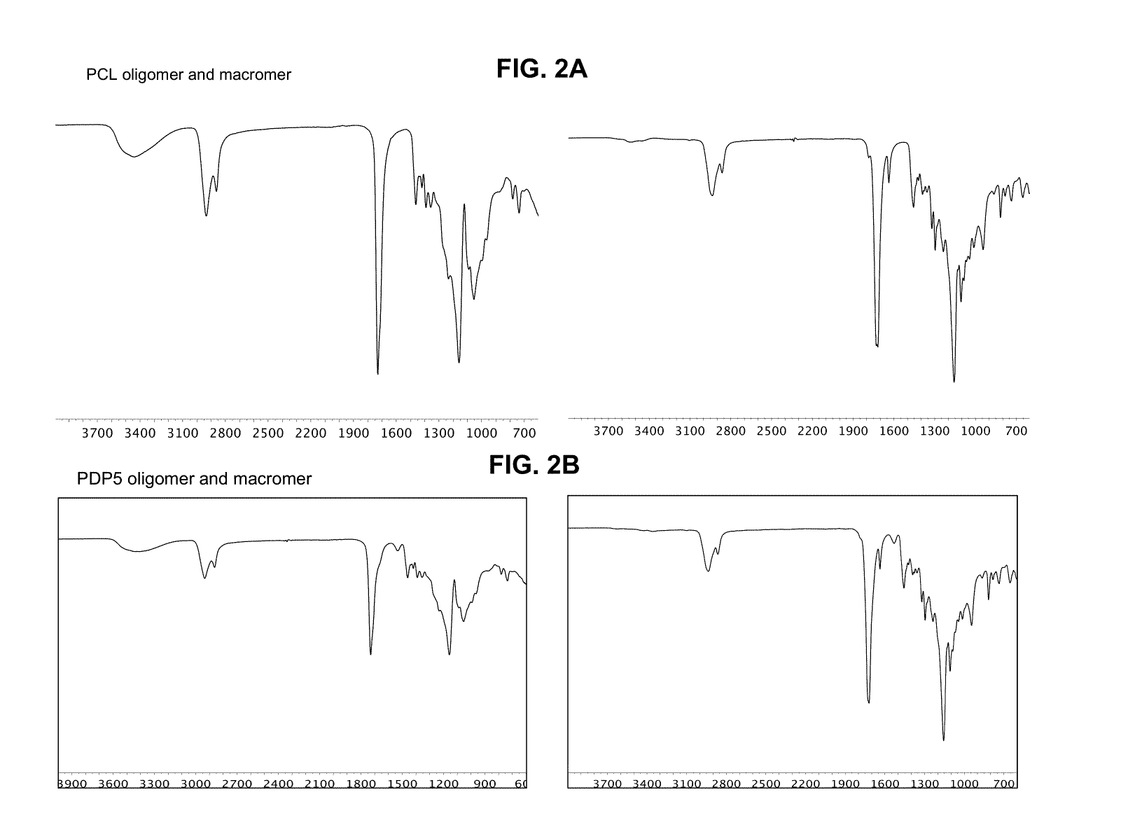

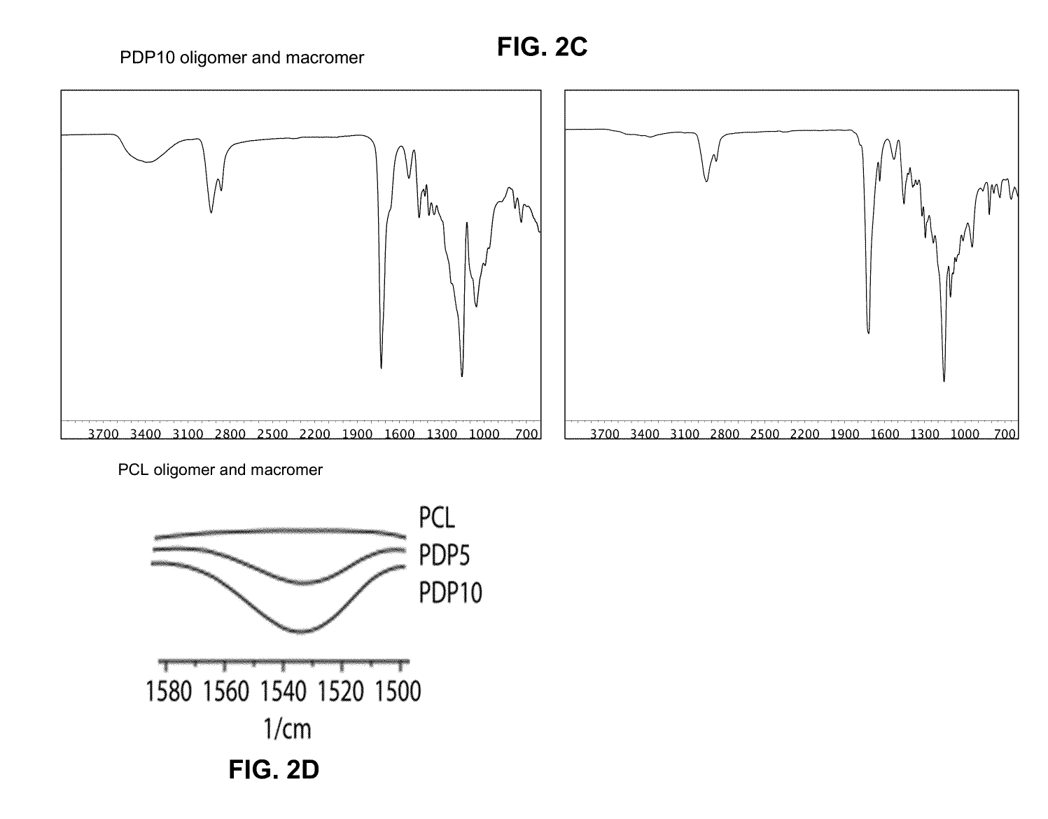

To support the ¹H NMR data, FTIR was used to characterize the relative amount of amide groups in the resulting photocrosslinkable macromers. FIGS. 2A-D shows a decrease in FTIR transmittance near 1540 l/cm when the amount of MMD monomer in the macromer increased. The decreased transmittance is attributed to the increased amount of peptide bonds in the macromer, thus revealing the successful introduction of MMD monomer into the copolymers. This FTIR data is consistent with the data derived from ¹H NMR integrals. FTIR data together with the ¹H NMR data thus confirmed that the designated photocrosslinkable copolymers were successfully synthesized.

Thermal Properties of Oligomers and Macromers

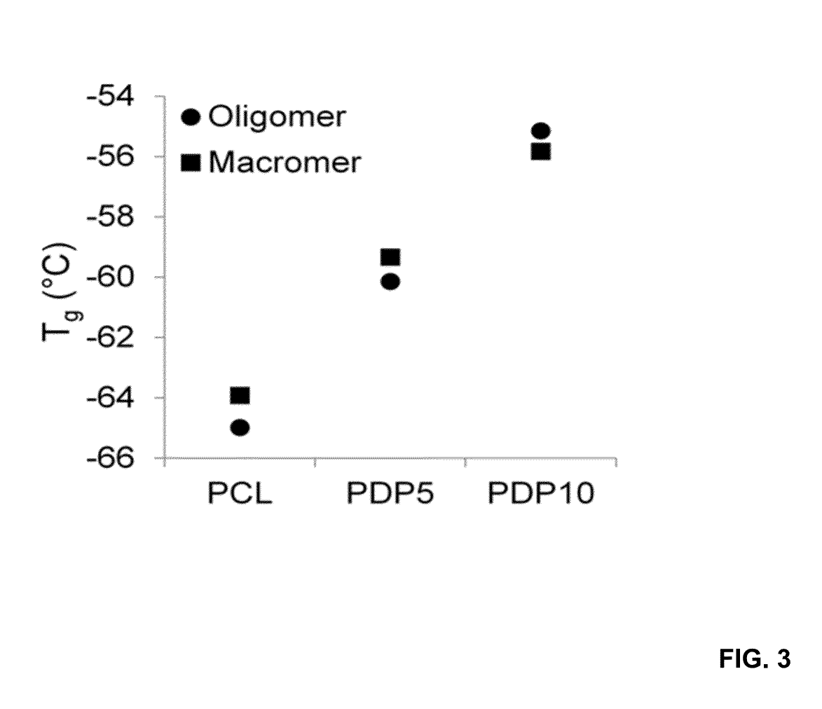

Thermal properties of the oligomers and macromers were characterized with DSC. No melting peaks were detected during the melting run, revealing that all of the oligomers and macromers were amorphous. FIG. 3 shows the glass transition temperatures (T_{g}) of the oligomers and macromers. It was observed that an increasing amount of MMD in the polymer linearly increased the T_{g} value, whereas methacrylation did not significantly change the T_{g} values of the oligomers compared to the macromers. The increase of T_{g} with the MMD content suggested that the depsipeptides rendered the structures of the copolymers more rigid when compared to the PCL homopolymer. The amorphous nature of the macromers was mainly due to their low molecular weight, which was necessary to ensure that the macromers had low viscosities. All of the methacrylated macromers, as well as the oligomers, were liquids at room temperature. The liquid state of the macromers was highly desired, as it allowed them later to be processed in 3-D printing without use of extra heat or solvents.

Double Bond Conversion of Macromers

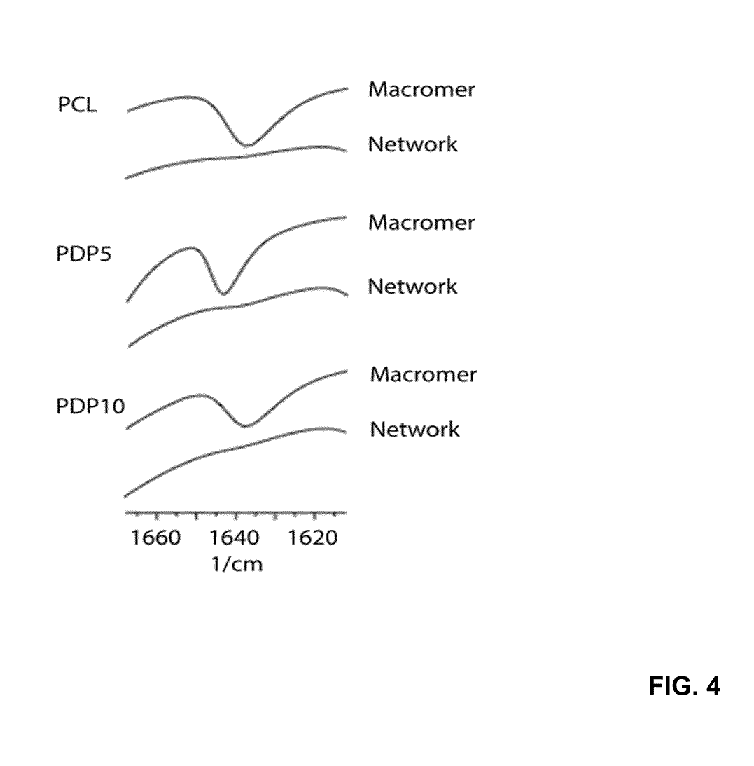

The double bond conversion of the macromers during photocrosslinking was evaluated with FTIR. FIG. 4 shows the transmittance of the methacrylate double bonds near 1640 l/cm. Before photocrosslinking, the decreased transmittance curves were observed due to the unreacted double bonds. After photocrosslinking, the peaks disappeared indicating that the double bonds were successfully reacted within 2 min of photocrosslinking. To support the FTIR data, gel contents of the photocrosslinked networks were measured, revealing them to be as high as 99.8±0.1%, 99.2±0.3%, and 98.3±0.3% for the PCL, PDP5, and PDP10 samples, respectively. The FTIR data and the high gel contents thus confirmed that the resulting polymer networks were highly crosslinked and the amount of unreacted double bonds of the polymers was very low.

In Vitro Biodegradation

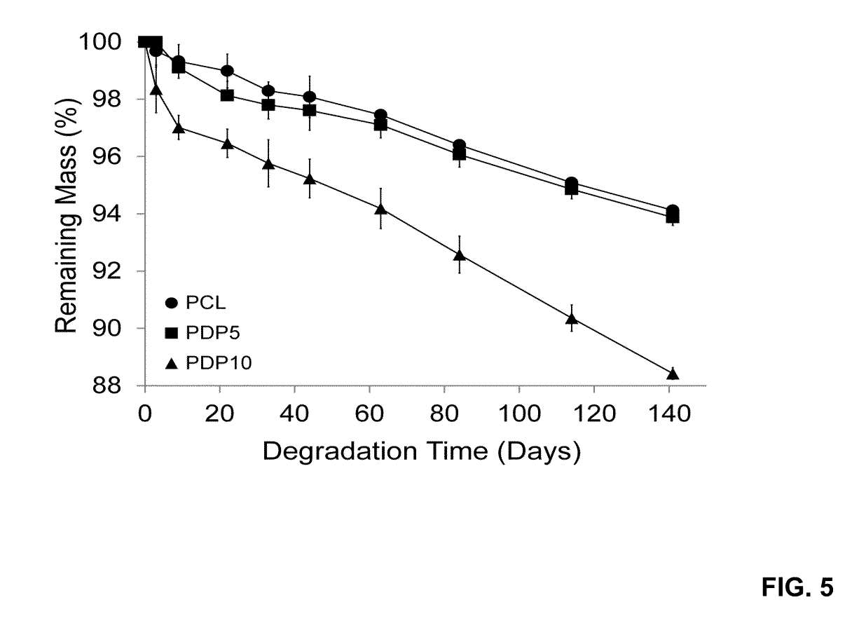

The in vitro hydrolytic degradation of the photocrosslinked polymers was measured by following the mass loss of the polymer films in PBS. Due to the hydrophobic nature of the photocrosslinked films, the swelling of the samples was minimal and the degradation was slow. FIG. 5 shows that within six months in PBS, the PCL and PDP5 samples lost approximately 8% of their initial mass, whereas the PDP10 samples lost almost 15%. To explain the difference in the mass loss, water contact angles of the polymer films were measured, revealing that the photocrosslinked PDP10 films were initially less hydrophobic (contact angle 75°±1°, n=3) compared to the PDP5 films (85°±1°, n=3) and PCL films (87°±1°, n=3). The more hydrophilic surface and the slightly lower gel content of the PDP10 samples thus contributed to their increased mass loss in an aqueous environment compared to the PCL and PDP5 samples. After the initial mass loss attributed to the release of uncured resin to the medium, the degradation rate of the polymer films was constant during the hydrolysis study. The linear mass loss and the intact shape of the films observed during the study indicated that the degradation occurred though surface erosion. This feature suggests that the polymers might later find use especially in zero order drug release applications.

Cytocompatibility of the Photocrosslinked Poly(Depsipeptide-Co-ε-Caprolactone) Copolymers

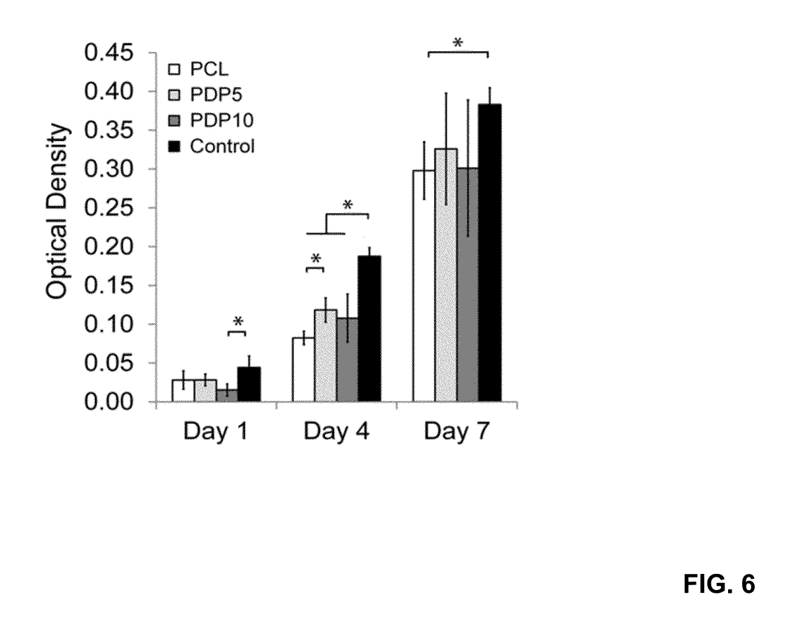

In vitro cytocompatibility of the photocrosslinked polymers was assessed by measuring the metabolic activity of HUVECs on the polymer films using the colorimetric MTT assay. FIG. 6 shows that the optical density, which is proportional to the metabolic activity and number of living cells, increased at every time point within 7 days of cell culturing. At day 7, the optical density was around tenfold compared to the value at day 1, indicating that the cells proliferated well on the polymer films. The increased metabolic activity of the cells thus showed great cytocompatibility of the photocrosslinked polymers in vitro.

Proliferation and Osteogenic Differentiation of C3H10T1/2 Cells on the Films

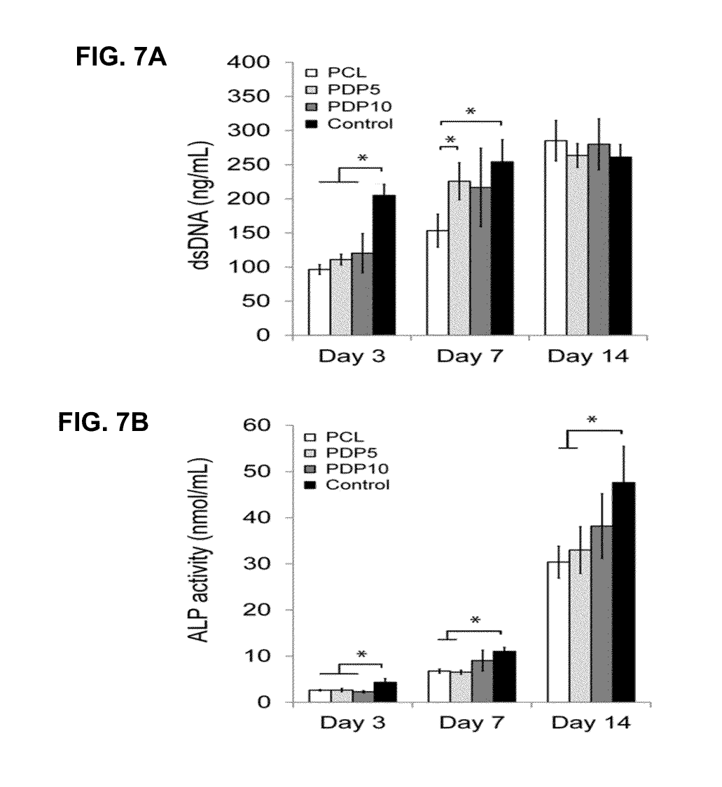

Mouse pluripotent C3H10T1/2 cells were cultured on the photocrosslinked films to further test the suitability of the polymers for bone tissue engineering. Proliferation of the cells was assessed by measuring the amount of dsDNA within 14 days of cell culturing. FIG. 7A shows that all of the samples showed greater than a twofold increase in the amount of dsDNA between day 3 and day 14. The increased amounts of dsDNA indicated that mouse C3H10T1/2 cells proliferated well on the photocrosslinked polymers during 14 days of culturing. The ALP specific activity of the C3H10T1/2 cells was used to indicate the early osteogenic differentiation of the cells. FIG. 7B shows that the ALP activity was low within 7 days of cell culturing until it increased remarkably before day 14. It has previously been shown that C3H10T1/2 cells have the potential to differentiate into osteoblastic cells. 29, 30 In our study, the increased ALP activity suggested that the cells differentiated into osteoblasts on the polymer films within 14 days, thus implying the suitability of these materials for bone applications. The fact that the ALP activity was relatively low at day 7, but higher at day 14, is consistent with the proliferation rate evidenced by the dsDNA concentrations at day 7 and 14, suggesting that the cells first reached confluence and then experienced improved osteogenic differentiation between day 7 and 14.

Preparation of Photocrosslinked Scaffolds by 3-D printing

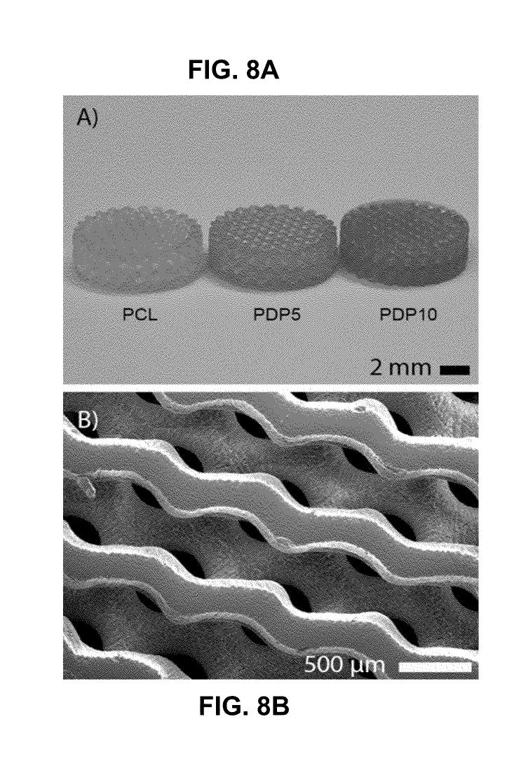

3-D printing was used for the preparation of 3D modeled tissue engineering scaffolds. The photocrosslinkable resin containing macromer and photoinitiator showed a desired viscosity at room temperature and no solvents or heating was required. Addition of a small amount of orange dye into the polymer resin was needed to prevent overcuring that otherwise would affect the pore size and geometry of the scaffold during the building process. The fabrication of the scaffolds proceeded well for all of the macromers, and no changes to the fabrication parameters were needed for different resins. No shrinkage of the photocrosslinked materials was observed after solvent extraction, and the final dimensions of the scaffolds were as designed. FIG. 8A shows that the color of the scaffolds varied from light yellow (PCL) to orange (PDP10), which is attributed to the increasing amount of depsipeptide in the polymer causing an increasingly yellow color. The SEM picture in FIG. 8B shows that the pore architecture of the scaffolds was in a repeated gyroid pattern as designed in our 3D model. The capability of fabricating a whole layer in a short time period (12 s) at room temperature demonstrated the benefits of 3-D printing as an effective and accurate method to prepare high-resolution tissue engineering scaffolds out of the newly synthesized photocrosslinkable polymer resins.

Mechanical Properties of Photocrosslinked Scaffolds Prepared by 3-D Printing

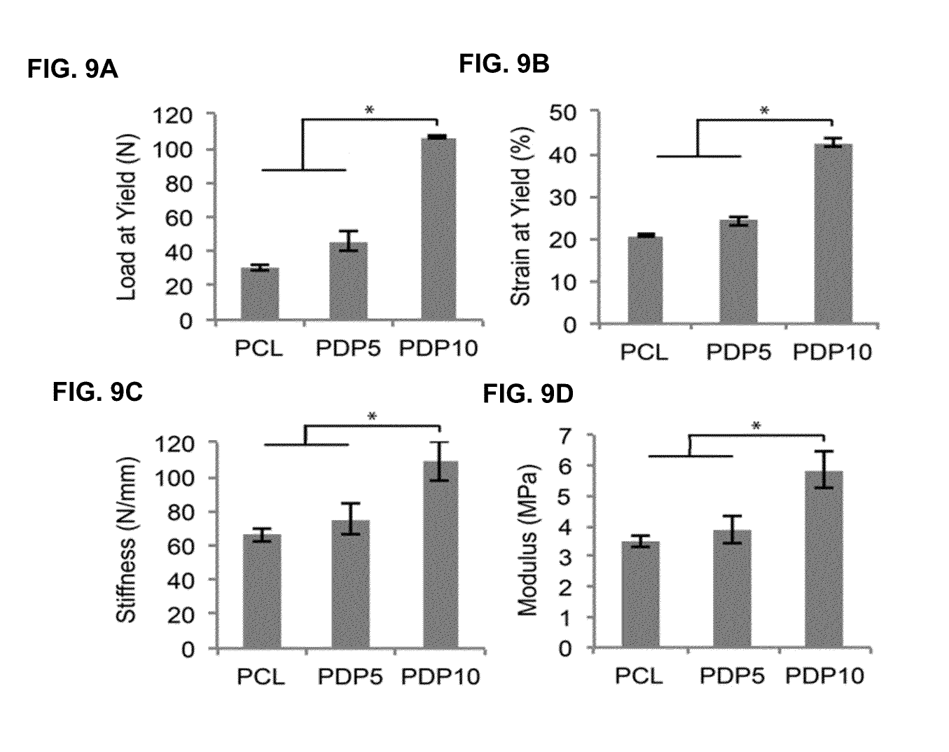

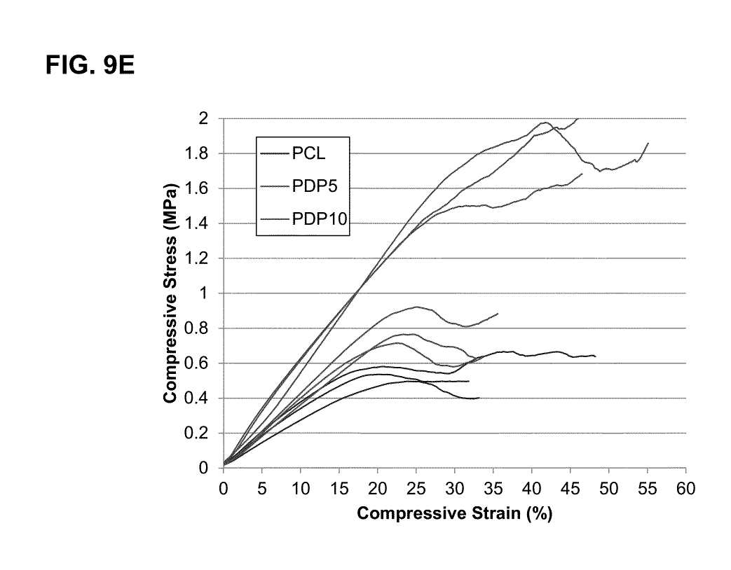

The effect of depsipeptide on the mechanical properties of the scaffolds was measured with compressive strength tests. All of the scaffolds showed a long linear stress-strain curve before yielding, thus indicating the elasticity of the materials. FIG. 9A-D shows the load and strain at the yield point, the stiffness, and the compression modulus of the scaffolds calculated using a strain range of 0-10%. No statistically significant difference was observed between the properties of the PCL and PDP5 scaffolds. However, 10 mol % of MMD, as in PDP10, was sufficient to increase the values significantly. The PDP10 scaffolds had a three-fold higher load and a two-fold higher strain at the yield point when compared to the PCL scaffolds. Additionally, the compression modulus was significantly higher for the PDP10 scaffolds than for the other scaffolds. The increased mechanical strength of the PDP10 scaffolds can be attribute to the fact that L-alanine molecules in the depsipeptides units can form strong intermolecular hydrogen-bond interactions between the amide groups, enhancing the mechanical strength of the resulting scaffolds. 5 mol % MMD was not sufficient to significantly change the mechanical properties of the PDP5 scaffolds when compared to the PCL scaffolds.

Cell Culture

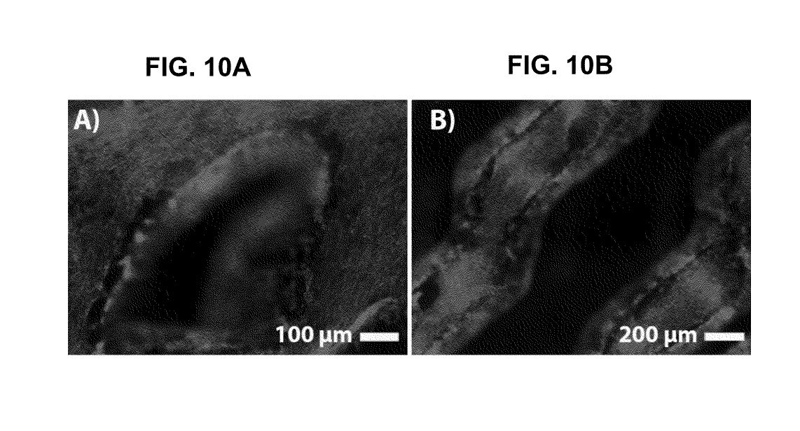

To preliminary study the cell attachment properties of the 3D scaffolds prepared by 3-D printing, HUVECs (5×10⁵ cells) were seeded on the scaffolds and were stained with rhodamine phalloidin and DAPI. FIG. 10 shows the cells on the top surface of the PDP10 scaffold A) on the edge of the scaffold and B) in the middle of the scaffold after 7 days of cell culturing. A dense cell layer was observed on the scaffold struts within 7 days, indicating excellent suitability of these scaffolds for tissue engineering. Further studies are needed to quantitatively measure the cell viability and proliferation on the 3D scaffolds.

### Discussion

Photocrosslinkable (depsipeptide-co-ε-caprolactone) copolymer precursors and crosslinked poly(depsipeptide-co-ε-caprolactone) copolymers were prepared by three-dimensional photofabrication. Star-shaped copolymers based on ε-caprolactone and L-alanine-derived depsipeptide were successfully synthesized, and the copolymers were processed into mathematically defined porous scaffolds by 3-D printing. Crosslinked poly(depsipeptide-co-ε-caprolactone) copolymers exhibited increased glass transition temperature, increased hydrophilicity and compression modulus as well as increased hydrolytic degradation as compared to ε-caprolactone. Photocrosslinked samples showed linear mass loss under hydrolytic conditions. Excellent in vitro cytocompatibility was demonstrated by cell studies with mouse mesenchymal cells and human vascular cells. The results in this study showed that the photocrosslinkable poly(depsipeptide-co-ε-caprolactone) copolymer precursors and crosslinked poly(depsipeptide-co-ε-caprolactone) copolymers can be tailored by changing the amino acid in the monomer and can be used as a material for photofabrication of high-resolution tissue engineering scaffolds.

### Example 2

### Crosslinked Poly(Ethylene Glycol-Co-Depsipeptide) Copolymers

Photocrosslinkable copolymers of a poly(ethylene glycol) macromer, amino acids and methacrylic anhydride were synthesized and their chemical, thermal, and degradation properties as well as in vitro cytocompatibility was examined. The resulting photocrosslinkable copolymers were used to fabricate mathematically designed tissue engineering scaffolds by 3-D printing, and the mechanical properties of crosslinked copolymer scaffolds were characterized.

### Materials and Methods

Materials

L-alanine and chloroacetyl chloride (Acros Organics), tin(II) 2-ethylhexanoate (Sn(Oct)₂), and methacrylic anhydride (Sigma-Aldrich) were used as received. Star-shaped four-arm PEG (10,000 g/mol, Creative PEGworks) was used after drying under vacuum at 100° C. for 3 h. Acryl-PEG-SVA (3,400 g/mol, Laysan Bio, Inc.) and RGDS peptide (Bachem) were used as received Immortalized HUVECs expressing green fluorescent protein (GFP) were a generous gift from the late Dr. J. Folkman, Children's Hospital, Boston. Fetal bovine serum (FBS), antibiotic solution, and trypsin-EDTA solution were purchased from Invitrogen Co. EBM™ endothelial basal medium containing an EGM™ Single Quots™ kit were purchased from Lonza, Inc. AlamarBlue® cell viability assay was from Bio-Rad Laboratories.

### Synthesis of a Lithium Phenyl-2,4,6-trimethylbenzoylphosphinate (LAP) Photoinitiator

Lithium phenyl-2,4,6-trimethylbenzoylphosphinate (LAP) photoinitiator was synthesized as described previously by Fairbanks et al (Biomaterials 2009; 30:6702-6707). Briefly, 2,4,6-trimethylbenzoyl chloride (Chem-Impex Int'l Inc.) was added dropwise to an equimolar amount of dimethyl phenylphosphonite (Alfa Aesar) at RT under nitrogen atmosphere. After mixing for 18 h, a four fold excess of lithium bromide (Strem Chemicals) dissolved in 2-butanone (Acros Organics) was added to the mixture and reaction was continued for 10 min at 50° C. After heating, the mixture was kept at RT for 4 h, and the resulting precipitate was filtered and washed with 2-butanone and diethyl ether and dried under vacuum.

Synthesis of Photocrosslinkable Macromers and Adhesion Peptides

The photocrosslinkable water-soluble PEG-co-PDP oligomer was synthesized by ring-opening polymerization (ROP) of L-alanine-derived depsipeptide using the 4-arm PEG as a macroinitiator as shown in Scheme 2A. Before ROP, the 3-methylmorpholine-2,5-dione (MMD) monomer was synthesized as described in Example 1. Briefly, dissolved L-alanine was reacted with an equimolar amount of chloroacetyl chloride in diethyl ether/water mixture at −5° C. by simultaneously adding 4 M NaOH solution into the flask to keep the pH at 11. After 1 hour, the aqueous layer was acidified to pH 1 with 4 M HCl and was extracted twice with ethyl acetate. The combined organic layers were washed twice with saturated NaCl solution and dried with MgSO₄ and concentrated under vacuum. The resulting chloroacetyl alanine was then dissolved in dry N,N-dimethylformamide (DMF) and slowly mixed dropwise with triethylamine After 7 h at 100° C. under nitrogen and overnight at room temperature, the reaction solution was filtered and the solvent was removed under reduced pressure. The resulting cyclic MMD in a small amount of DMF was precipitated in diethyl ether and washed with dichloromethane and dried under vacuum.

To polymerize the hydroxyl-ended PEG-co-PDP oligomer, the MMD monomer was added with dried PEG macroinitiator to the flask which was then heated to 130° C. Sn(Oct)₂ catalyst was added to the flask which was then evacuated and flushed several times with nitrogen. The ROP was continued for 6 days at 130° C., after which the resulting oligomer was purified by dialysis and freeze-drying. To obtain a photocrosslinkable macromer, the oligomer was further reacted with a 100 mol % excess of methacrylic anhydride at 60° C. for 24 h, after which it was precipitated in cold diethyl ether and dried under vacuum. The macromer was further purified by dialysis and freeze-drying. As a control polymer, PEG macromer was synthesized by methacrylating the hydroxyl-ended PEG with methacrylic anhydride at 60° C. for 24 h. In addition, the photocrosslinkable acryl-PEG-RGDS adhesion peptide shown in Scheme 2B was prepared by dissolving acryl-PEG-SVA and RGDS in 50 mM NaHCO₃ solution (pH 8.3) and mixing them for 4 h at RT. The resulting peptide was purified by dialysis and freeze-drying.

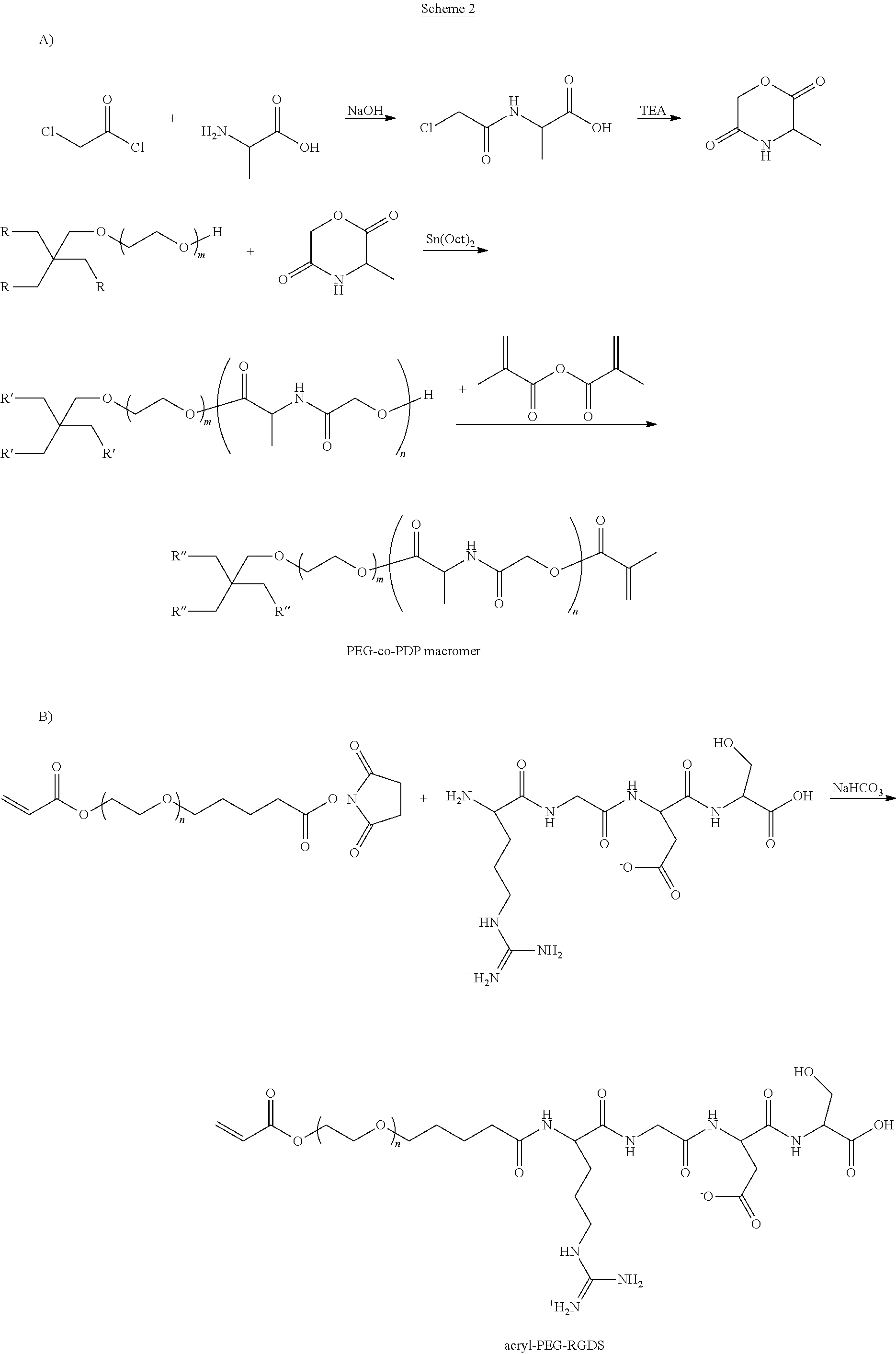

Three-Dimensional Fabrication of Hydrogels by Stereolithography

To prepare a photocrosslinkable hydrogel solution for SLA, 10% w/v of the photocrosslinkable macromer and 0.25% w/v of LAP photoinitiator were dissolved in EBM-2 medium. The viscosity of the solution was increased by adding 7% w/v of Percoll® medium to the polymer solution. For mass loss and mechanical studies, cell-free PEG-co-PDP hydrogels (d=8.5 mm, h=0.6 mm) were first fabricated using an in-house built SLA module of hybrid bioprinter (Hybprinter) in a layer-by-layer manner with a layer thickness of 200 μm and a layer exposure time of 100 s, 120 s, and 160 s. A visible light projector (Vivitek, Lumen 3200) was used as a light source with an intensity of 2,100 mW/dm². Before 3D fabrication, the digital 3D model was designed with the SolidWorks CAD software and was converted into printing instructions with the free Slic3r software (Slic3r.org). The light exposure time was controlled using the free Pronterface software (pronterface.com). For cytotoxicity studies, three different solutions consisting of PEG macromer, PEG-co-PDP macromer, or PEG-co-PDP macromer with 2 mM acryl-PEG-RGDS were photocrosslinked using a longer light exposure time (10 min/layer) to ensure the high crosslinking degree of the polymer.

Physiochemical Characterization

¹H NMR spectra were recorded on a Varian Inova 300 MHz NMR spectrometer. Samples were dissolved in deuterated chloroform, and the spectrum was acquired in a 5-mm NMR tube at room temperature. Thermal properties of the oligomers were determined using a Q2000 (TA Instruments) differential scanning calorimeter (DSC). A sample was first heated from 25° C. to 100° C. at a rate of 20° C./min, after which the temperature was decreased to −100° C. at 10° C./min. After 2 min at −100° C., the sample was heated from −100° C. to 100° C. at a rate of 10° C./min. Melting point (Tₘ) was determined from the second heating scan. The relative amount of peptide bonds in the PEG-co-PDP copolymer was determined using a Bruker Vertex 70 FTIR spectrometer with a diamond ATR.

Gel content of the 3D fabricated hydrogels was measured by extracting the hydrogels in distilled water for 10 h and subsequently drying the gels to get their dry weight. The gel content (G) was obtained by dividing the dry weight of the samples after extraction (m_{d}) by their dry weight before extraction (m₀) according to Equation (1):

G=m_{d}/m₀×100% (1)

To measure the initial swelling degree of the 3D fabricated hydrogels, the samples were immersed in distilled water for 24 h to reach the swelling equilibrium, after which the samples were dried. By using the wet weight (m_{sw}) and dry weigh (m_{d}) of the samples, and the density values of 1.0 g/ml for water (ρₛ) and 1.2 g/ml for the photocrosslinked PEG-based polymer (ρₚ), the degree of swelling (Q) was calculated from Equation (2):

Q=1+ρₚ/ρₛ×(m_{sw}/m_{d}−1) (2)

In vitro mass loss of the hydrogels was determined by measuring the dry weight of the samples immersed in PBS (pH 7.4, 0.02% sodium azide) at 37° C. At day 7, 14, and 24, triplicate samples were removed from the media, weighted, and dried first in air for 2 d and then in a freeze-dryer for 3 d. The remaining mass was divided by the initial mass to get the remaining weight percentage. The swelling degree during the degradation study was measured using Equation (2). The viscoelastic behavior of the hydrogels was measured with an Ares G2 rheometer (TA Instruments) with an 8-mm parallel plate geometry. The viscoelastic regime was first determined with an amplitude sweep from 0.1 to 50% strain, after which the angular frequency sweep was run from 0.1 to 10 rad/s at 0.5% strain at 25° C. AFM force-distance measurements were done with Agilent 5500 AFM in a liquid cell with PBS as the liquid phase. Tip sensitivity calibration was performed on glass surface after the end of each set of experiments with the respective tip. The tip used for the experiments (NanoAndMore, k=0.08 N/m, R=950 nm) had a SiO₂ sphere on its apex. The stiffness of tips from this batch was confirmed by Sader method and was found to be <20% different from the nominal reported value. FDS curve data analysis was done using commercially available SPIP software from Image Metrology A/S. The baseline correction from the laser reflection and the determination of Young's modulus using Hertz sphere approximation was performed in batch processing regime, with the results checked visually for mistakes.

Cell Culture and 3D Fabrication of Cell-Laden Hydrogels

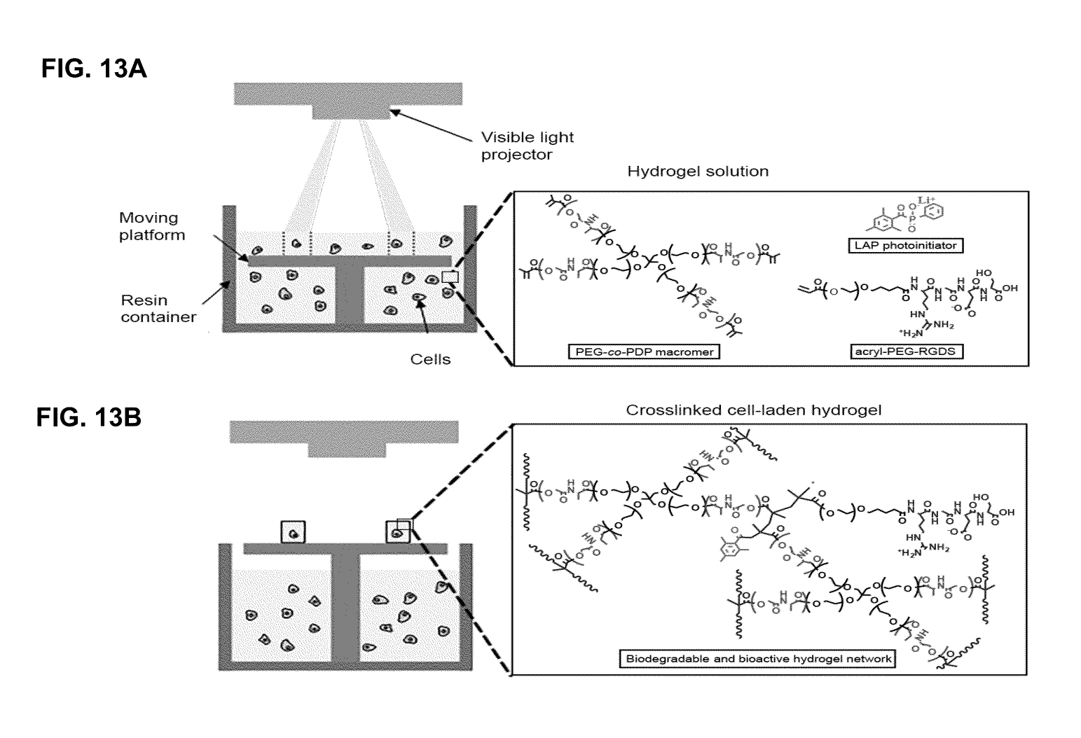

HUVECs were cultured in endothelial basal medium (EBM-2) with a Single Quots (EGM-2, excluding hydrocortisone) endothelial growth supplement, 10% FBS, and 1% antibiotic solution. All cells were cultured under standard conditions (5% CO₂, 37° C., 95% humidity) and sub-cultured using a 0.25% trypsin-EDTA solution. For material cytotoxicity studies, HUVECS (1×10³ cells) were seeded on the top of the prefabricated hydrogels. For cell encapsulation studies, HUVECs (5×10⁶ cells/ml) were mixed with the filtered hydrogel solution with the 2 mM acryl-PEG-RGDS adhesion peptide, and the cell-laden hydrogel discs were prepared by SLA (FIGS. 13A and B) as described for the hydrogels without cells. The air in the SLA system was continuously filtered with a HEPA filter, and the resin container was sterilized with 70% ethanol followed by thorough rinsing with PBS before hydrogel fabrication. In addition to the disc hydrogels, cell-laden hydrogel rings with the outer diameter or 10 mm and a wall thickness 2 mm were 3D fabricated by SLA as described for the disc samples, now using 120 s as a layer crosslinking time. To further demonstrate the use of the new polymer and SLA for vascular tissue engineering grafts, bifurcate hydrogel vessels were designed and 3D fabricated using the same material and fabrication conditions.

Cell Proliferation

The metabolic activity of the cells seeded on the hydrogels in 2D and the cells encapsulated in 3D matrices was measured with colorometric AlamarBlue® cell viability assay. At predetermined time points, the hydrogels were transferred to a new well-plate, and 500 μL of fresh medium and 50 μL AlamarBlue® solution was added into the wells. After incubation for 4 h, the medium was aliquoted to the three 100 μL samples, and the optical density was read using a SpectraMax® M2e microplate reader (Molecular Devices) at 555 nm/585 nm excision/emission.

Statistical Analysis

For the statistical analysis, samples were always used in triplicate, and the statistical significance was determined with the IBM SPSS Statistics software using a one-way ANOVA followed by Tukey's post hoc test (p<0.05).

### Results and Discussion

Synthesis of Monomers, Oligomers, and Methacrylated Macromers

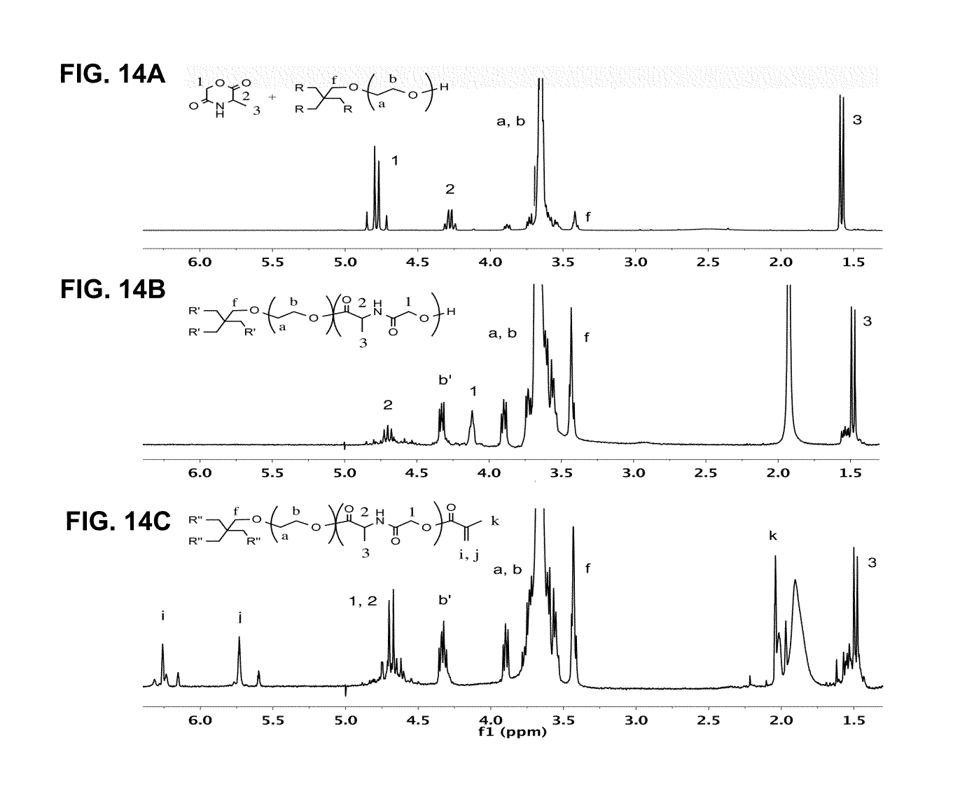

The water-soluble photocrosslinkable PEG-co-PDP polymer for use in 3D fabrication of cell-laden hydrogels was synthesized by ROP of L-alanine-derived depsipeptide and a 4-arm PEG macroinitiator. Before ROP, the cyclic MMD monomer was synthesized from L-alanine and chloroacetyl chloride, giving the ¹H NMR peaks 1-3 in FIG. 14A. The resulting MMD was then copolymerized with PEG yielding in a water-soluble, hydroxyl-terminated oligomer. In the ¹H NMR spectrum in FIG. 14B, the monomer peaks transferred to the corresponding oligomer peaks 1-3, while the new peak b′ was attributed to the last CH₂ protons of the PEG arms before PDP units. 2D COSY ¹H NMR revealed a strong coupling between the peaks 2 and 3 of the oligomer. As calculated from the ¹H NMR, the polymerization degree of the MMD monomer was 85%, and the molecular weight of the oligomer was around 10,850 g/mol. To get a photocrosslinkable macromer, the oligomer was further functionalized with methacrylate end-groups. The successful methacrylation was observed as a disappearance of the peak 1 in FIG. 14B attributed to the last CH₂ protons before the hydroxyl groups and appearance of the peaks i, j, k in FIG. 14C attributed to the methacrylate groups of the macromer. No trace of the oligomeric peak 1 was left in the macromer, showing its complete methacrylation. The purified macromer was a lightly brown powder showing a great water-solubility at room temperature. The broad peak near 2 ppm in the macromer spectrum was attributed to the residual water still remained in the polymer after dialysis and freeze-drying.

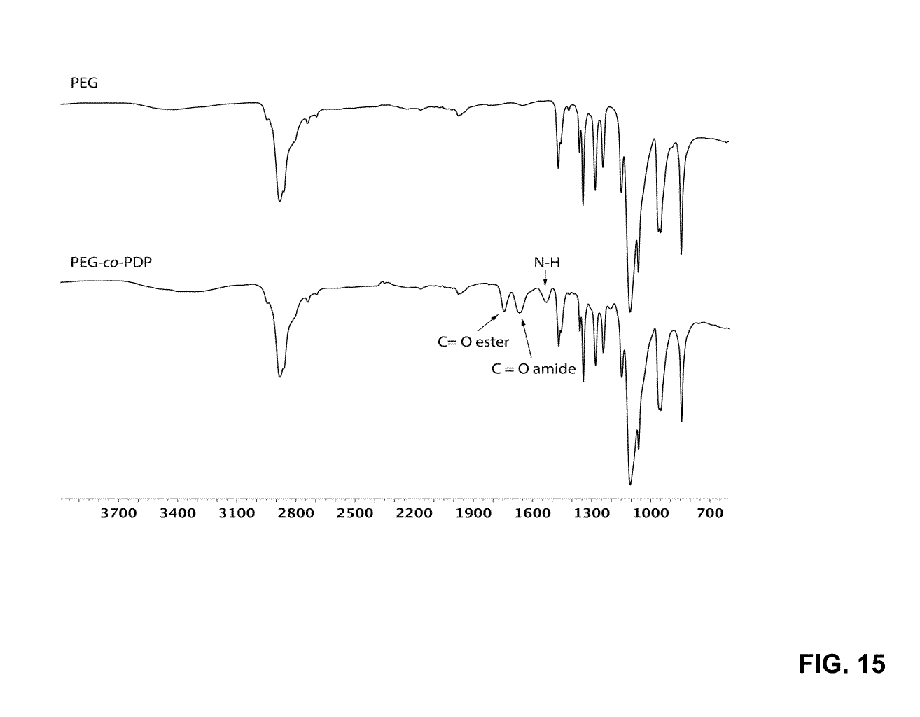

The copolymerization of PDP units into the PEG was also monitored by FTIR. FIG. 15 shows the spectra of the PEG macroinitiator and PEG-co-PDP oligomer. The FTIR analysis revealed that the ROP of PEG and MMD resulted in new peaks at 1750 cm⁻¹ and 1670 cm⁻¹ attributed to the C═O ester and C═O amide stretches, respectively, and a peak at 1540 cm⁻¹ attributed to the N—H bend in the PDP unit. The FTIR data together with the ¹H NMR data confirmed that the designated poly(ether ester amide) was successfully synthesized.

The DSC analysis of the synthesized oligomers and macromers showed a clear melting peak for all the samples. Table 3 shows that the copolymerization of PDP into the PEG decreased the melting point (Tₘ) with around 10° C. and the enthalpy of melting (4H) to the half compared with the values of the PEG homopolymer alone. In addition, the methacrylation decreased the Tₘ and ΔH values both for the PEG homopolymer and for the PEG-co-PDP copolymer.

TABLE 3

| | Oligomer | | Macromer | |
|---|---|---|---|---|
| Sample | Tₘ (° C.) | ΔH (J/g) | Tₘ (° C.) | ΔH (J/g) |
| PEG | 55.82 | 160.3 | 43.98 | 100.9 |
| PEG-co-PDP | 45.43 | 81.38 | 42.59 | 76.60 |

Cytocompatibility of the Photocrosslinked Materials

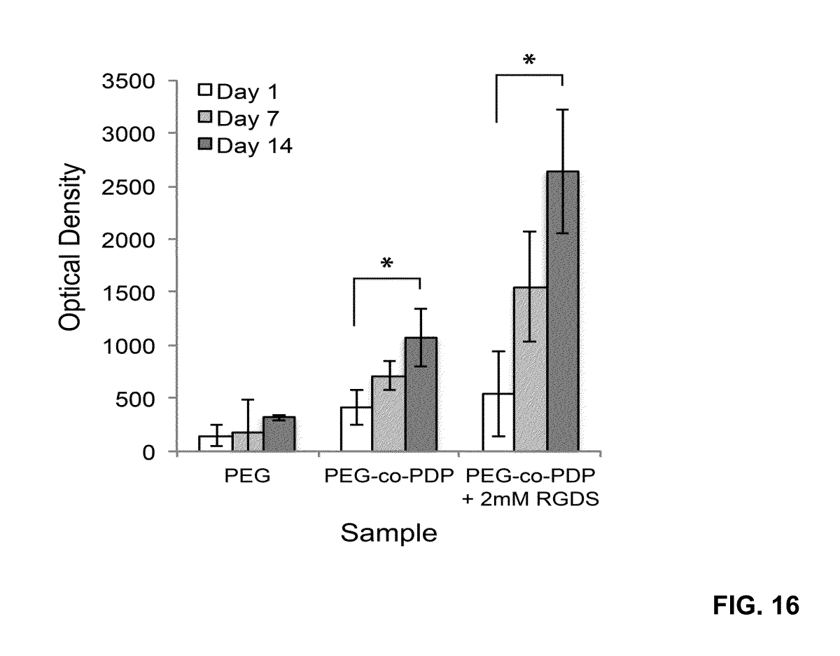

In vitro cytocompatibility of the new material was evaluated by seeding HUVECs on the photocrosslinked PEG, PEG-co-PDP, and PEG-co-PDP/RGDS hydrogels and monitoring their metabolic activity by a colorimetric AlamarBlue® assay. FIG. 16 shows the metabolic activity of the cells within 2 weeks of cell culturing. At day 1, no significant difference was seen between the sample groups. After day 1, the metabolic activity, which is related to the number of living cells, increased on the PEG-co-PDP and PEG-co-PDP/RGDS samples while no significant increase was seen on the PEG samples. At day 7 and 14, the cell activity was significantly higher on the PEG-co-PDP/RGDS samples than on the neat PEG-co-PDP samples, and both groups showed increased cell activity compared to the PEG samples.

Fabrication of the Hydrogels with Adjusted Light Exposure Times

The PEG-co-PDP hydrogels were 3D fabricated using the visible light projection SLA in a layer-by-layer manner at room temperature. To study the effect of crosslinking time on the mass loss, mechanical properties, and cell encapsulation capacity of the gels, three different light exposure times, 100 s, 120 s, and 160 s/layer, were used. Table 4 shows the gel content and the swelling degree of the hydrogels fabricated by the SLA in absence of cells. The gel content increased from 85% to 88% with the increased crosslinking time, while the swelling degree decreased 24% from 21 to 16. For comparison, the hydrogels crosslinked for extended time (10 min/layer) had a gel content of 89.4±0.3% and a swelling degree of 15.2±0.3.

TABLE 4

| Crosslinking | | |
|---|---|---|
| time/layer (s) | Gel content (%) | Swelling degree |
| 100 | 85 ± 2 | 21 ± 1 |
| 120 | 86 ± 1 | 18 ± 1 |
| 160 | 88 ± 1 | 16 ± 1 |

In Vitro Mass Loss and Swelling of the 3D Hydrogels Fabricated by SLA

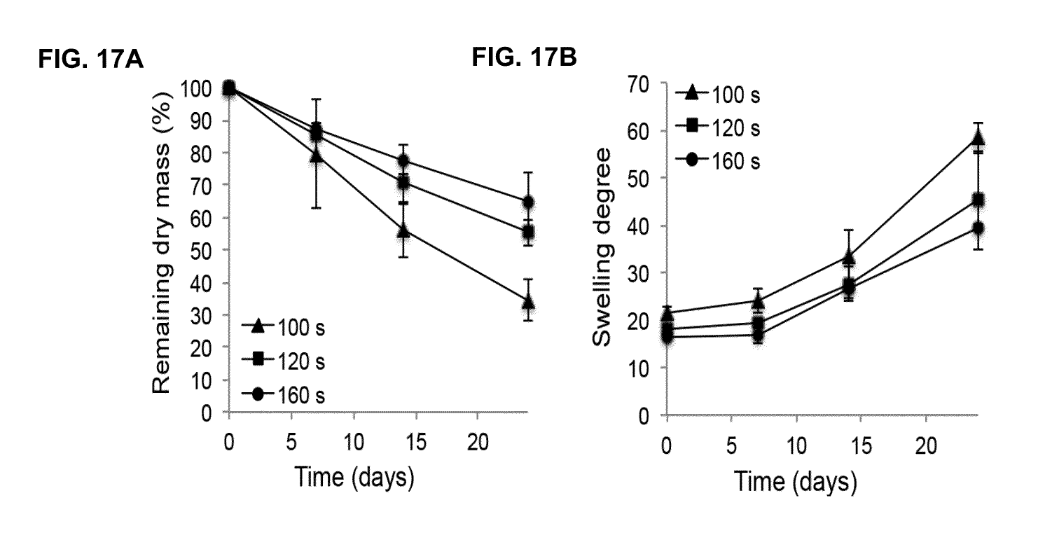

In vitro hydrolytic mass loss of the photocrosslinked PEG-co-PDP hydrogels was monitored by measuring the weight of the cell-free hydrogels after predetermined times in PBS. FIG. 17A shows that the total mass loss of the hydrogels decreased with the increasing crosslinking time. During 24 d in PBS, the 100 s samples lost 66% of their initial dry mass, while the 120 s samples lost 45% and the 160 s samples 35% of their initial mass. The 120 s and 160 s samples retained their mechanical integrity within the 24-day immersion in PBS, while the 100 s samples broke into two pieces before the 24 d time point. The swelling degree of the samples (FIG. 17B) increased in 24 d from 21 to 58 for 100 s samples, from 18 to 45 for 120 s samples, and from 16 to 40 for 160 s samples.

Mechanical and Viscoelastic Properties of the 3D Hydrogels Fabricated by SLA

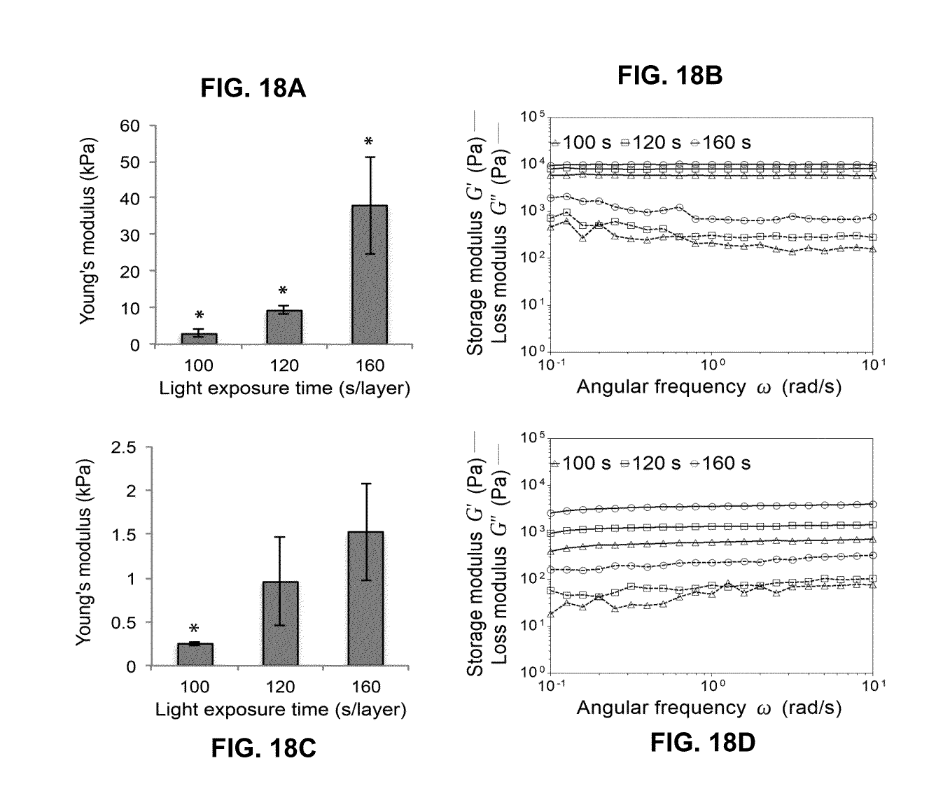

To evaluate the effect of the light exposure time and the degradation on the local mechanical stiffness of the hydrogels, AFM was used to measure the Young's modulus of the wet samples right after SLA-fabrication and after 7 d in PBS. FIG. 18A shows that the stiffness increased with the crosslinking time, and the initial average Young's modulus was 3.0±1.0 kPa, 9.4±1.2 kPa, and 37.9±13.3 kPa for the 100 s, 120 s, and 160 s samples, respectively. Within 7 d in PBS (FIG. 18C), Young's modulus decreased to 0.24±0.02 kPa, 0.96±0.50 kPa, and 1.52±0.55 kPa, respectively. The rheometric analysis of the viscoelastic behavior of the 3D fabricated gels revealed that the initial storage modulus increased with the crosslinking time, being in the range of 10³-10⁴ Pa (FIG. 18B), while within 7 d in PBS (FIG. 18D), the storage modulus decreased to 10²-10³ Pa. Therefore, the decrease at one-order magnitude was consistent both in the AFM and the rheometric analysis.

Proliferation of the Encapsulated HUVECs in the Cell-Laden Hydrogels

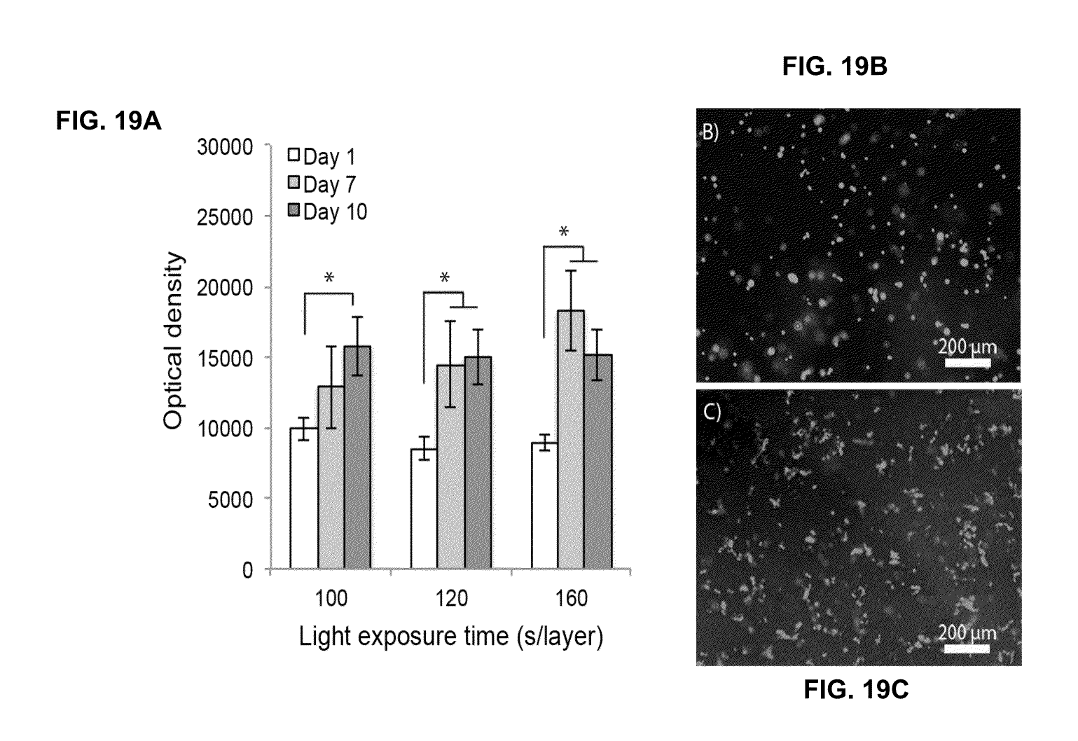

Cell-laden hydrogels were fabricated by mixing the filtered PEG-co-PDP/RGDS hydrogel solution with the HUVEC suspension and by photocrosslinking the samples with SLA. The effect of crosslinking time on cell viability was tested by fabricating cell-laden hydrogel constructs using the light exposure times of 100 s, 120 s, and 160 s/layer and monitoring the metabolic activity of the encapsulated cells with the colorimetric cell viability assay. FIG. 19A shows that the cells significantly increased their metabolic activities in all the samples from day 1 to day 10. At each designated time point, there was no significant difference in cell activity among the sample groups regardless of the light exposure time. The representative fluorescence images of the 160 s samples in FIG. 19B-C reveal that the cells were distributed homogenously in the gels and cell spreading was observed after 7 d of cell culturing.

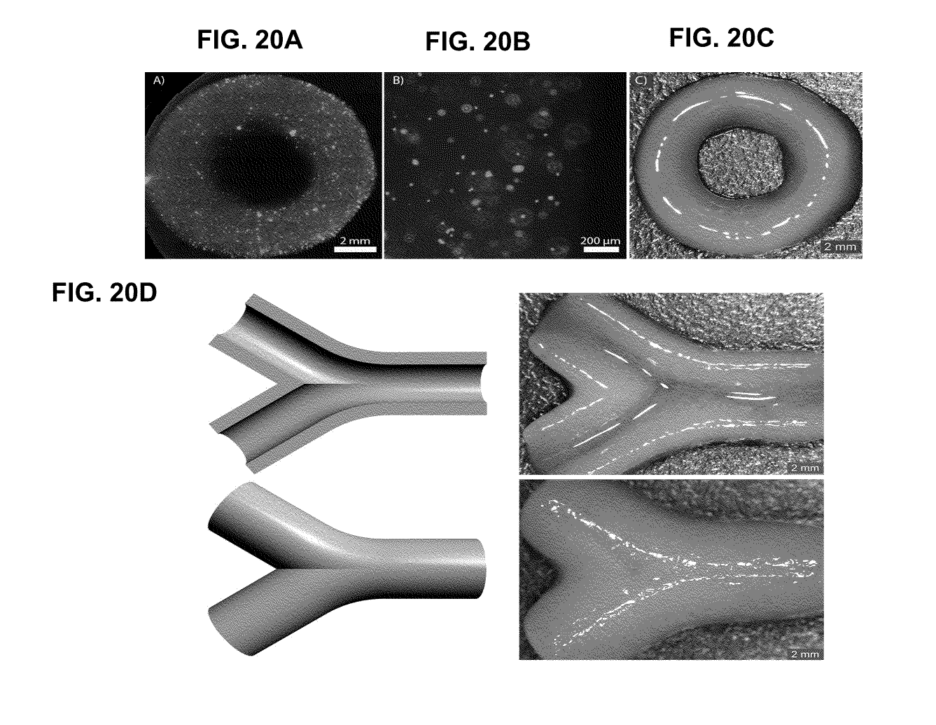

To demonstrate the use of the new PEG-co-PDP macromer for SLA-based fabrication of tubular hydrogel constructs, ring-like cell-laden hydrogels were prepared using the exposure time of 120 s/layer. The fluorescence images in FIG. 20A-B reveal the homogenous distribution of the cells in the cell-laden hydrogel ring. The photograph in FIG. 20C shows the uniform and round shape of the 3D fabricated ring-like hydrogel construct. To further study the capacity of new macromer and SLA in vascular tissue engineering, the bifurcate vascular tubes were modeled and fabricated by SLA. FIG. 20D shows the CAD models and the resulting tubular hydrogels, revealing that the 3D fabricated hydrogel constructs resembled closely their digital models and had a uniform and smooth wall structure required for the functional vascular grafts.

### Discussion

Photocrosslinkable poly(ethylene glycol-co-depsipeptide) copolymer precursors and crosslinked poly(ethylene glycol-co-depsipeptide) copolymers were prepared by three-dimensional photofabrication. The prepared PEG-co-PDP macromer that combines both naturally derived and synthetic building blocks demonstrates the biocompatible and degradable properties of polypeptides and polyesters and the great controllability of the physical and mechanical properties of PEG. By adjusting the light exposure time, the mechanical stiffness and swelling capacity was controlled as well as the mass loss of the SLA-fabricated crosslinked copolymers.

The photocrosslinkable poly(ethylene glycol-co-depsipeptide) copolymer precursors were functionalized with methacrylate end groups. The ¹H NMR and FTIR analysis confirmed that the depsipeptide units introduced biodegradable ester and peptide bonds to the PEG chains and that the methacrylate groups were successfully attached to the end of the copolymer chains. Thermal characterization revealed that the copolymerization of PEG with depsipeptide decreased its melting temperature and enthalpy, indicating that the depsipeptide units interfered with the highly crystalline structure of the PEG and therefore decreased the amount of energy needed to melt the polymer. For the SLA-based hydrogel fabrication, a visible light sensitive photoinitiator, LAP, was synthesized, and a low concentration of LAP (0.25% w/v) was mixed with the 10% w/v PEG-co-PDP solution to generate a readily photocrosslinkable hydrogel solution. Digital light projecting SLA was used for fabrication due to reduced production times compared with the traditional laser-based SLA techniques and the use of visible light instead of UV light, reducing the potential risk of harming the DNA of encapsulated cells. 3D modeled hydrogels were successfully photocrosslinked in a layer-by-layer manner leading to homogenously crosslinked samples for the later characterization of the physical and mechanical properties of these hydrogels.

The crosslinked poly(ethylene glycol-co-depsipeptide) copolymers were cytocompatible and support cell proliferation. Cytocompatibility was studied by seeding HUVECS on the prefabricated hydrogels as a 2D cell culture. The copolymerization of PEG with depsipeptide units was found to improve the proliferation of HUVECs on the crosslinked copolymer surface. Because non-patterned PEG surface suppresses the non-specific protein adsorption and is anti-adhesive due to its lack of functional groups, the improved cell proliferation on the hydrogel surface was a result of the new functional groups introduced by the depsipeptide units to the hydrogel polymer. The cell proliferation was further improved by addition of the RGDS adhesion peptides, which provided more integrin-specific attachment sites on the hydrogel surface. To make the immobilized peptide free of steric hindrance and maintain its bioactivity, acrylated PEG with a molecular weight of 3,400 g/mol was used as a spacer between the hydrogel matrix and the RGDS peptide.

In addition to the biochemical cues, the microenvironment of the cells encapsulated in 3D hydrogels includes biophysical and biomechanical cues, such as swelling capacity, mechanical stiffness, and material mass loss of the hydrogels. When the light exposure time in SLA was increased from 100 s to 160 s per layer, the gel content of the hydrogels increased from 85% to 88%, while the maximum gel content of the hydrogels crosslinked with the extended light exposure time (10 min/layer) was 89%. The swelling degree decreased from 21 to 16 with the increasing crosslinking time. As more double bonds reacted with the continued light exposure time, the crosslinking density and the gel content of the hydrogels increased, resulting in the decreased mesh size and more restricted water penetration to the hydrogel network.

Hydrogel mass loss and the changes in the swelling degree and in the mechanical stiffness was evaluated as a measure of polymer degradation behavior. For the 3D fabricated PEG-co-PDP crosslinked copolymers, mass loss followed a zero order curve within the 24-day incubation in PBS. The total mass loss in 24 days in PBS ranged from 66% for 100 s samples to 35% for 160 s samples. Generally, the hydrolysis of the degradable bonds in the PEG-co-PDP chains resulted in the broken crosslinks, weakening the hydrogel structural integrity, and when all the crosslinks of the multi-arm copolymer were broken, the copolymer unit was free to diffuse out of the hydrogel network, leading to the hydrogel mass loss.

In certain examples, when the longer light exposure time increased the crosslinking degree, more polymer arms were covalently bound to the hydrogel network, making the release of the polymer chains more difficult and therefore slowing down the mass loss. The degradation of the polymer networks was also evidenced as an increase in the swelling degrees of the hydrogels during the incubation in PBS. Furthermore, the increase in the swelling degree was slow at the early stage of the degradation, but accelerated at the later stage, indicating that the decrease in the crosslinking density was in a non-linear fashion.

In addition to the swelling capacity and the mass loss, the control over the mechanical properties of the cell-laden hydrogels was studied. Oscillatory rheometry was used to measure the viscoelastic properties of the bulk hydrogels and AFM to study the local mechanical stiffness of the 3D fabricated hydrogels both right after SLA-fabrication and after 7-day incubation in PBS. The storage modulus describing the elastic properties of the hydrogels increased with the light exposure time and with the increased crosslinking density, being initially in the range of 10³-10⁴ Pa. The Young's modulus of the hydrogels ranged initially from 3 kPa to 38 kPa, being in the stiffness range of natural soft tissues regardless of the crosslinking time.

Within 7 d in PBS, the storage modulus of the gels decreased to the range of 10²-10³ Pa and the Young's modulus decreased to the range of 0.2 kPa to 1.5 kPa. Thus, the decrease at one-order magnitude was consistent both in the bulk storage modulus and the local stiffness of the hydrogels. As the mechanical elasticity and strength of the photocrosslinked hydrogel are caused by the retractive forces of the crosslinked polymer chains, the cleavage of the biodegradable PEG-co-PDP chains decreased the total forces, and together with the reduced polymer mass and the increased swelling of the gels, resulted in the decreased mechanical stiffness of the degraded hydrogels.

Cell-laden hydrogels were fabricated by SLA using the same light exposure times as for the cell-free hydrogels. The cell activity study revealed that the initially non-porous PEG-co-PDP/RGDS hydrogels supported well the proliferation of encapsulated HUVECs within the 10-day cell culturing regardless of the crosslinking time. Non-degradable, non-porous PEG hydrogels prepared by SLA showed no cell proliferation within 7-day cell culturing. Successful cell proliferation may be attributed to the polymer degradation and to the subsequent mass loss and the decreased mechanical stiffness of the hydrogel matrix.

Although the foregoing invention has been described in some detail by way of illustration and example for purposes of clarity of understanding, it is readily apparent to those of ordinary skill in the art in light of the teachings of this invention that certain changes and modifications may be made thereto without departing from the spirit or scope of the appended claims.

Accordingly, the preceding merely illustrates the principles of the invention. It will be appreciated that those skilled in the art will be able to devise various arrangements which, although not explicitly described or shown herein, embody the principles of the invention and are included within its spirit and scope. Furthermore, all examples and conditional language recited herein are principally intended to aid the reader in understanding the principles of the invention and the concepts contributed by the inventors to furthering the art, and are to be construed as being without limitation to such specifically recited examples and conditions. Moreover, all statements herein reciting principles, aspects, and embodiments of the invention as well as specific examples thereof, are intended to encompass both structural and functional equivalents thereof. Additionally, it is intended that such equivalents include both currently known equivalents and equivalents developed in the future, i.e., any elements developed that perform the same function, regardless of structure. The scope of the present invention, therefore, is not intended to be limited to the exemplary embodiments shown and described herein. Rather, the scope and spirit of present invention is embodied by the appended claims.

1. A method of making a crosslinked copolymer, the method comprising:
contacting a composition comprising a first monomer with a composition comprising a second monomer to produce a copolymer;
contacting the copolymer with a composition comprising one or more crosslinkers to produce a crosslinkable copolymer precursor; and
crosslinking the crosslinkable copolymer precursor by 3-D printing to produce a crosslinked copolymer.

2. (canceled)

3. The method according to claim 1, wherein the morpholine-2,5-dione monomer is a compound of formula: 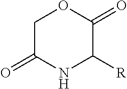
wherein R is selected from hydrogen, alkyl, substituted alkyl, aryl, substituted aryl, arylalkyl, substituted arylalkyl, heteroalkyl, substituted heteroalkyl, heteroaryl, substituted heteroaryl, heteroarylalkyl, and substituted heteroarylalkyl.

4-5. (canceled)

6. The method of claim 1, wherein the second monomer comprises polyethylene glycol or an ester.

7-8. (canceled)

9. The method of claim 6, wherein the second monomer is a four-arm polyethylene glycol macromer is a compound of formula: 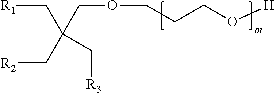
wherein R₁, R₂ and R₃ are each independently selected from hydrogen, alkyl, substituted alkyl, heteroalkyl and substituted heteroalkyl; and
m is a positive integer from 1 to 1000.

10. (canceled)

11. The method of claim 9, wherein m is 57.

12. The method of claim 9, wherein R₁, R₂ and R₃ are each independently polyethylene glycol having a molecular weight of from 1 kDa to 50,000 kDa.

13-15. (canceled)

16. The method of claim 1, wherein the second monomer comprises ε-caprolactone.

17-18. (canceled)

19. The method of claim 1, wherein the crosslinker comprises a hydrolysable acrylate crosslinker.

20-34. (canceled)

35. The method of claim 1, wherein crosslinking comprises forming a covalent bond between the crosslinkable copolymer precursor and an adhesion peptide.

36-40. (canceled)

41. The method of claim 35, wherein the adhesion peptide comprises a compound of the formula:

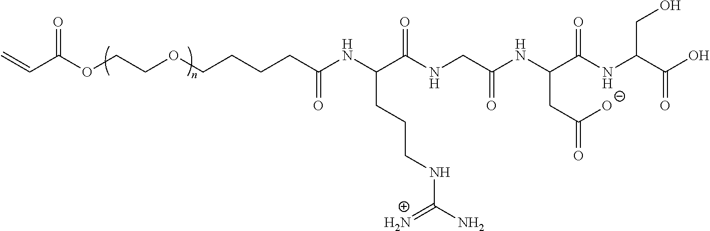

42. The method of claim 1, wherein the crosslinkable copolymer precursor comprises a compound of the formula: 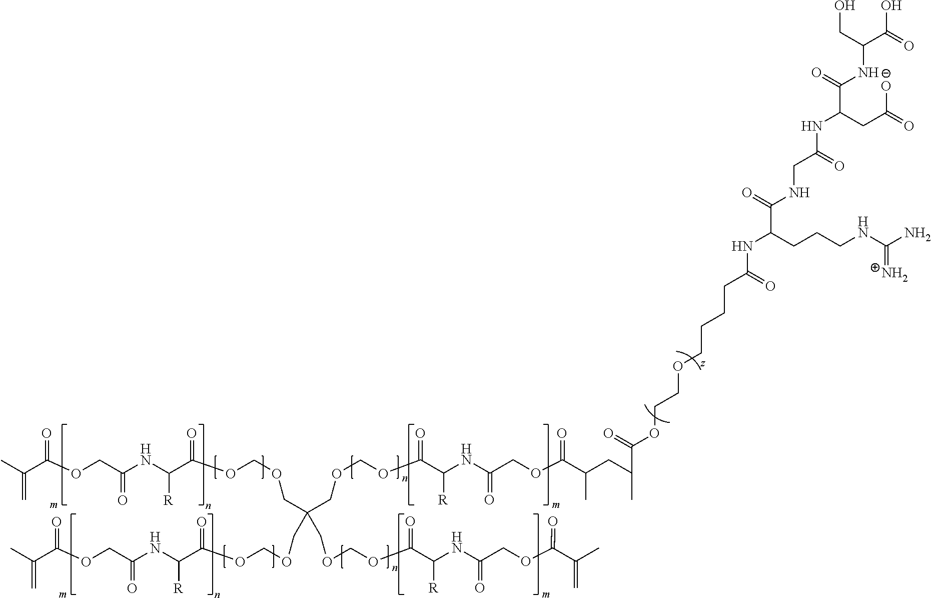
wherein R is selected from hydrogen, alkyl, substituted alkyl, aryl, substituted aryl, arylalkyl, substituted arylalkyl, heteroalkyl, substituted heteroalkyl, heteroaryl, substituted heteroaryl, heteroarylalkyl, and substituted heteroarylalkyl;
m is an integer from 1 to 1000;
n is an integer from 1 to 1000; and
z is an integer from 1 to 1000.

43-58. (canceled)

59. The method according to claim 1, wherein the method further comprises:
contacting the crosslinkable copolymer precursor with a bioactive agent to produce a crosslinkable copolymer-bioactive agent precursor composition; and
crosslinking the crosslinkable copolymer-bioactive agent precursor by 3-D printing to produce a crosslinked copolymer-bioactive agent copolymer.

60. The method of claim 59, wherein the one or more bioactive agents is a compound selected from the group consisting of epidermal growth factor (EGF), hepatocyte growth factor (HGF), vascular endothelial growth factors (VEGF), fibroblast growth factors, platelet derived growth factors (PDGF), insulin-like growth factor, transforming growth factors (TGF), parathyroid hormone, parathyroid hormone related peptide, bone morphogenetic proteins (BMP), transcription factors, growth differentiation factor, recombinant human growth factors, cell attachment mediators, integrin binding sequences, cartilage-derived morphogenetic proteins, and small molecule active agents.

61-140. (canceled)

141. A crosslinkable poly(ethylene glycol-co-depsipeptide) copolymer precursor comprising:
a poly(ethylene glycol-co-depsipeptide) copolymer; and
a crosslinker covalently bonded to the depsipeptide component of the poly(ethylene glycol-co-depsipeptide) copolymer.

142. The crosslinkable copolymer precursor of claim 141, wherein the poly(ethylene glycol-co-depsipeptide) copolymer is a compound of formula: 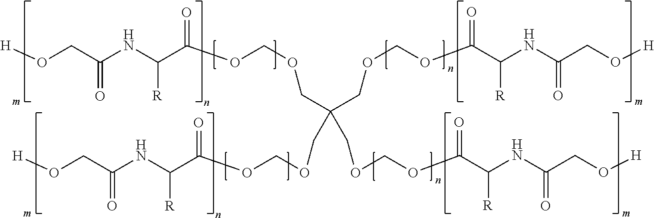
wherein each R is independently selected from hydrogen, alkyl, substituted alkyl, aryl, substituted aryl, arylalkyl, substituted arylalkyl, heteroalkyl, substituted heteroalkyl, heteroaryl, substituted heteroaryl, heteroarylalkyl, and substituted heteroarylalkyl;
m is an integer from 1 to 1000; and
n is an integer from 1 to 1000.

143-155. (canceled)

156. The crosslinkable copolymer precursor of claim 141, wherein the crosslinkable copolymer precursor comprises a compound of the formula: 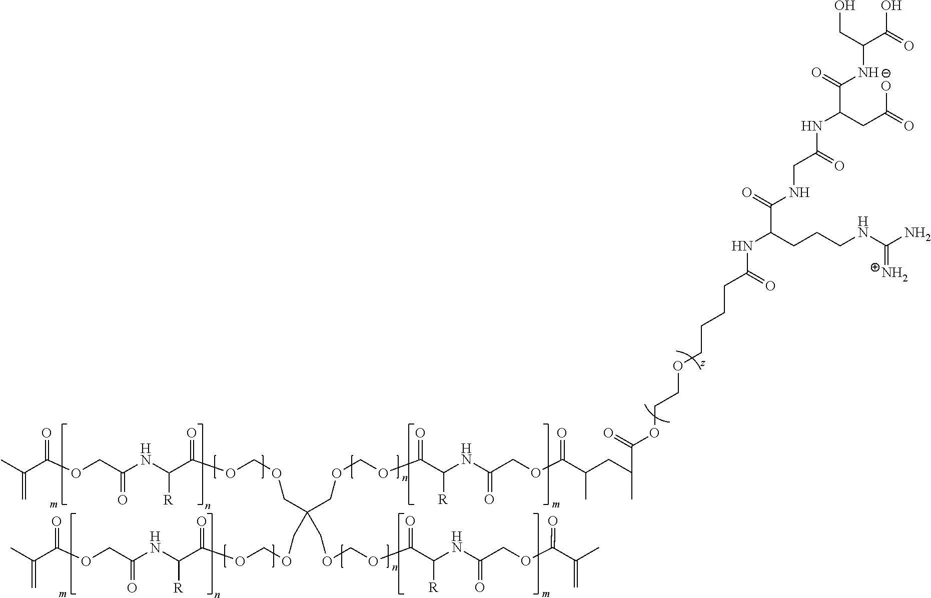
wherein R is selected from hydrogen, alkyl, substituted alkyl, aryl, substituted aryl, arylalkyl, substituted arylalkyl, heteroalkyl, substituted heteroalkyl, heteroaryl, substituted heteroaryl, heteroarylalkyl, and substituted heteroarylalkyl;
m is an integer from 1 to 1000;
n is an integer from 1 to 1000; and
z is an integer from 1 to 1000.

157-160. (canceled)

161. The crosslinkable copolymer precursor of claim 141, further comprising one or more bioactive agents selected from the group consisting of epidermal growth factor (EGF), hepatocyte growth factor (HGF), vascular endothelial growth factors (VEGF), fibroblast growth factors, platelet derived growth factors (PDGF), insulin-like growth factor, transforming growth factors (TGF), parathyroid hormone, parathyroid hormone related peptide, bone morphogenetic proteins, transcription factors, growth differentiation factor, recombinant human growth factors, cell attachment mediators, integrin binding sequences and cartilage-derived morphogenetic proteins.

162. A crosslinkable poly(depsipeptide-co-ε-caprolactone) copolymer precursor comprising:
a poly(depsipeptide-co-ε-caprolactone) copolymer; and
a crosslinker covalently bonded to the ε-caprolactone component of the poly(depsipeptide-co-ε-caprolactone) copolymer.

163. The crosslinkable copolymer precursor of claim 162, wherein the poly(depsipeptide-co-ε-caprolactone) copolymer is a compound of formula: 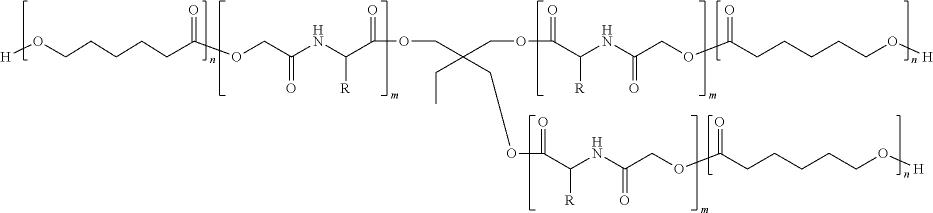
wherein each R is independently selected from hydrogen, alkyl, substituted alkyl, aryl, substituted aryl, arylalkyl, substituted arylalkyl, heteroalkyl, substituted heteroalkyl, heteroaryl, substituted heteroaryl, heteroarylalkyl, and substituted heteroarylalkyl;
m is an integer from 1 to 1000; and
n is an integer from 1 to 1000.

164-176. (canceled)

177. The crosslinkable copolymer precursor of claim 162, further comprising one or more bioactive agents selected from the group consisting of epidermal growth factor (EGF), hepatocyte growth factor (HGF), vascular endothelial growth factors (VEGF), fibroblast growth factors, platelet derived growth factors (PDGF), insulin-like growth factor, transforming growth factors (TGF), parathyroid hormone, parathyroid hormone related peptide, bone morphogenetic proteins, transcription factors, growth differentiation factor, recombinant human growth factors, cell attachment mediators, integrin binding sequences and cartilage-derived morphogenetic proteins.

178-237. (canceled)
